(19) United States
(12) Patent Application Publication
(10) Pub. No.: US 2026/0180474 A1
(43) Pub. Date: Jun. 25, 2026

(54) Vibration harvesting component, vibration harvesting device, and vibration power generator

(71) Applicant: Yu Lei, Guiyang (CN)

(72) Inventor: Yu Lei, Guiyang (CN)

(21) Appl. No.: 19/376,964

(22) Filed: Nov. 2, 2025

(30) Foreign Application Priority Data
Dec. 22, 2024 (CN) 202411895943.5

(51) Int. Cl. H02N 2/18; H02N 1/04

(52) U.S. Cl. CPC H02N 2/186; H02N 1/04

(57) ABSTRACT

The invention belongs to the field of vibration power generation. The vibration harvesting component for vibration power generator comprises a rectangular-shaped frame, a pillar. It expands the frequency band and harvests low vibration energy. It involves a vibration harvesting device used in electromagnetic vibration power generator and a vibration harvesting device used in composite vibration power generator, both of which comprises a vibration harvesting component and a gimbal. Both devices make the vibration harvesting components to capture omnidirectional external excitation, the latter also generates multiple types of feedback actions for various power generation units to utilize. It involves an electromagnetic vibration power generator and a composite vibration power generator. The former comprises a vibration harvesting device used in electromagnetic vibration power generator, the latter comprises a vibration harvesting device used in composite vibration power generator. Both improve the energy generation efficiency.

### CROSS-REFERENCE

This application claims priority to Chinese Patent Application No. 202411895943.5, filed Dec. 22, 2024, the entirety of which is incorporated herein by reference.

### TECHNICAL FIELD

The invention belongs to the field of vibration power generation, particularly relating to a vibration harvesting component for vibration power generator, a vibration harvesting device that incorporates this component, and a vibration power generator that incorporates this device. The vibration harvesting device including a vibration harvesting device used in electromagnetic vibration power generator, as well as a vibration harvesting device used in composite vibration power generator. The vibration power generator including an electromagnetic vibration power generator and a composite vibration power generator.

### BACKGROUND OF THE INVENTION

Harvesting vibration energy from the environment and converting it into electrical energy will find widespread applications in fields such as the Internet of Things (IoT) and marine energy and the like. The vibrations present in the environment have the following characteristics: First, the omnidirectionality of external excitation. This is manifested in the fact that the direction of excitation can come from any direction in the three-dimensional coordinate system along the X, Y, and Z axes. Second, the periodicity or randomness of the excitation. Under periodic or random external excitation, objects can exhibit periodic motion or chaotic motion. Third, the randomness of excitation acceleration and relative displacement. Different external excitations in various environmental conditions result in different accelerations and relative displacements produced by the objects. Fourth, the vibration frequency tends to be low-frequency and random. For example, vibrations caused by waves can be below 1 Hz; vibrations caused by human walking typically do not exceed 5 steps/s, with a slow pace of 0.5 steps/s, resulting in a typical frequency range of 0.5 Hz to 5 Hz; vibrations caused by vehicles can be as slow as below 1 Hz or exceed several Hz. Overall, the characteristics of vibrations tend to be low-frequency, with the frequency varying randomly depending on the nature of the external excitation.

Humans have invented various types of vibration power generators, including electromagnetic, piezoelectric, triboelectric, and composite types, to harvest vibration energy from the environment.

In the case of electromagnetic vibration power generators, as described in Chinese Patent Publication No. CN103607092, this generator is classified as a linear vibration power generator. It utilizes a spring to capture external excitation in a single direction. The spring, along with the vibration shaft, undergoes expansion and contraction, resulting in relative motion between the magnet mounted on the vibration shaft and the coil. This relative motion causes a change in the magnetic flux within the coil, thereby generating an induced current.

In the case of piezoelectric vibration power generators, as described in Chinese Patent Publication No. CN107332471, this generator is classified as a cantilever beam type piezoelectric vibration power generator. It employs a cantilever beam made of elastic material and a mass block attached to the beam to capture external excitation in a single direction. Under the influence of the inertial force of the mass block, the cantilever beam deforms, leading to deformation in the piezoelectric material connected to the cantilever beam. This deformation results in the piezoelectric effect, converting mechanical energy into electrical energy.

In the case of triboelectric nanogenerators, as described in Chinese Patent Publication No. CN110995051, this generator utilizes a spring to capture external excitation in a single direction. Both ends of the spring are connected to mass blocks coated with triboelectric nanomaterial. When the spring is subjected to external excitation in the direction of its expansion and contraction, the two mass blocks, along with the spring, move and come into contact with the inner wall of a hollow buoy coated with another type of triboelectric nanomaterial. This contact generates a triboelectric effect, converting mechanical energy into electrical energy.

In the case of composite vibration power generators, as described in Chinese Patent Publication No. CN202111635, this generator is classified as a piezoelectric-electromagnetic composite vibration power generator. It employs a cantilever beam made of elastic material and a magnet attached to the beam as a mass block to capture external excitation in a single direction. This results in relative motion between the magnet and the coil, generating an induced current. During this process, the deformation of the cantilever beam also leads to deformation in the piezoelectric material, resulting in the piezoelectric effect, which converts mechanical energy into electrical energy. The combination of these two generation methods enhances the overall energy conversion efficiency.

1. The vibration harvesting components mentioned in the above four references, namely springs or cantilever beams, convert external excitation into elastic potential energy through material deformation. These types of vibration harvesting components face the following technical problems:

First, they have difficulty in harvesting low-frequency external excitation, particularly vibrations below 1 Hz.

Second, the vibration harvesting components struggle to respond to random excitations with varying acceleration and relative displacement, especially when faced with very small excitation accelerations and short relative displacements, such as those generated by minor waves, slow walking, or the acceleration and relative displacement caused by the upper body swaying freely when a person sits down.

Third, regardless of whether it is a spring or a cantilever beam made of elastic material, the material of the vibration harvesting components experiences fatigue damage due to prolonged high-frequency use, which ultimately leads to a shortened lifespan of the vibration power generator.

Fourth, there is insufficient utilization of the energy from external excitation. For instance, in linear vibration power generators where compression springs are used as vibration harvesting components, after receiving a single, unidirectional excitation, the compression spring undergoes a relatively large compression and rebound, followed by smaller amplitude contractions and rebounds, eventually coming to rest. In the case of a tensile spring, it experiences a relatively large stretch and rebound, followed by smaller amplitude stretches and rebounds, ultimately also coming to rest. Similarly, in cantilever beam piezoelectric vibration power generators, after receiving a single, unidirectional excitation, the cantilever beam made of elastic material undergoes significant deformation and rebound, followed by smaller deformations and rebounds, completing the release of elastic potential energy. From this analysis that both springs and cantilever beams exhibit the characteristic of rapid energy release after deformation, while also having the drawback of excessive energy being dissipated as heat during the material deformation process.

2. The electromagnetic vibration power generator mentioned in the above references, such as the vibration harvesting device loaded in patent CN103607092, mainly including a compression spring as the vibration harvesting component, a base plate, a hub, a flange bearing, a vibration shaft. The vibration harvesting device used in this electromagnetic vibration power generator not only has the problems arising from the aforementioned vibration harvesting components but also presents the following technical problems:

First, the vibration harvesting device captures external excitation in a single direction, whereas in reality, external excitation can come from all directions. The vibration harvesting device has a specific harvesting angle, and when the direction of external excitation changes and exceeds this specific harvesting angle, it is unable to harvest energy.

Second, the operating conditions for the vibration harvesting device are stringent. In terms of operational requirements, the base must be positioned in the direction of the incoming vibration. If the base is misaligned or if the vibration power generator is inverted, it will exceed the effective harvesting angle of the harvesting device and will be unable to harvest energy.

3. The composite vibration power generator mentioned in the above references, such as the vibration harvesting device loaded in patent CN202111635, mainly including a vibration harvesting component in the form of a cantilever beam, a housing, a magnet that serves as a counterweight, dispersed mass blocks. The vibration harvesting device used in this composite vibration power generator not only has the problems arising from the aforementioned harvesting components but also presents the following technical problems:

First, the vibration harvesting device captures external excitation in a single direction, whereas in reality, external excitation can come from all directions. The vibration harvesting device has a specific harvesting angle, and when the direction of external excitation changes and exceeds this specific harvesting angle, it is unable to harvest energy.

Second, the operating conditions for the harvesting device are stringent. In terms of operational requirements, the base must be positioned in the direction of the incoming vibration. If the base is misaligned or if the vibration power generator is inverted, it will exceed the effective harvesting angle of the vibration harvesting device and will be unable to harvest energy.

Third, after the vibration harvesting device captures external excitation, the type of feedback action converted to the power generation unit for energy generation is single. For example, in a cantilever beam type vibration power generator, after the harvesting device is subjected to external excitation from the effective angle, the cantilever beam undergoes deformation and a reciprocating action of rebound, resulting in a single feedback action. Similarly, in some typical linear vibration power generators, when the vibration harvesting device is subjected to external excitation from the effective angle, the spring within the vibration harvesting device generates a reciprocating action along the direction of the spring's extension and contraction, leading to a single feedback action.

4. The electromagnetic vibration power generator mentioned in the above references, in addition to the problems arising from the vibration harvesting device used in electromagnetic vibration power generator, also presents the following technical problems:

First, the vibration harvesting components have difficulty capturing low-frequency external excitation, particularly vibrations below 1 Hz. They also struggle to respond to random excitations with varying acceleration and relative displacement, especially when faced with very small excitation accelerations, such as those generated by gentle waves, slow walking, or the acceleration produced by the upper body swaying when a person sits down. This results in a technical problem where the vibration power generator has weak energy generation capability when confronted with low-frequency vibrations, small excitation accelerations, and short relative displacements.

Second, there is a technical problem in that the generator cannot harvest excitation from all directions for energy generation, and when the vibration power generator is inverted beyond the effective harvesting angle, it is unable to generate power.

5. The composite vibration power generator mentioned in the above references, in addition to the problems arising from the vibration harvesting device used in the composite vibration power generator, also presents the following technical problems:

First, the vibration harvesting components have difficulty capturing low-frequency external excitation, particularly vibrations below 1 Hz. They also struggle to respond to random excitations with varying acceleration and relative displacement, especially when faced with very small excitation accelerations, such as those generated by gentle waves, slow walking, or the acceleration produced by the upper body swaying when a person sits down. This results in a technical problem where the vibration power generator has weak energy generation capability when confronted with low-frequency vibrations, small excitation accelerations, and short relative displacements.

Second, there is a technical problem in that the generator cannot harvest excitation from all directions for energy generation, and when the vibration power generator is inverted beyond the effective harvesting angle, it is unable to generate power.

Third, the vibration harvesting device loaded in the vibration power generator exhibits a single type of feedback action after capturing external excitation, this results in a limited variety of power generation unit types that can utilize this feedback action for energy generation, consequently leading to a technical problem of low energy generation efficiency in the vibration power generator.

### BACKGROUND ART DOCUMENT

Patent Document 1: CN103607092
Patent Document 2: CN107332471
Patent Document 3: CN110995051
Patent Document 4: CN202111635

### SUMMARY OF THE INVENTION

### I. Vibration Harvesting Component for Vibration Power Generator

### 1. Technical Problems to be Solved by the Vibration Harvesting Component for Vibration Power Generator:

Firstly, to address the technical problem that the above-mentioned vibration harvesting components, spring or cantilever beam have difficulty in harvesting low frequency external excitations, especially in terms of harvesting vibrations below 1 Hz.

Secondly, to address the technical problem that the above-mentioned vibration harvesting component is unable to respond to random excitations with varying excitation accelerations and relative displacement, particularly when dealing with very small excitation accelerations and short relative displacements, such as those caused by tiny waves, slow human walking, or the oscillation of the upper body when a person sits down, which generates acceleration and short relative displacement.

Thirdly, to address the technical problem that spring or cantilever beam which used in the vibration harvesting component undergoing vibration for a long time, the material damaged by fatigue failure, that shorten the lifespan.

Fourthly, to address the technical problem of insufficient energy utilization from external excitation by the aforementioned vibration harvesting components. Specifically, that too much of the energy harvested by the spring or cantilever beam is dissipated as heat due to material deformation, leading to inefficient use of the energy from external excitation.

### 2. An Embodiment of Vibration Harvesting Component for Vibration Power Generator.

The vibration harvesting component for vibration power generator 1 (hereinafter referred to as ‘vibration harvesting component 1’) comprising a rectangular-shaped frame 2, a pillar 3, an oscillator swinging around a point above the center of gravity 4, and an anti-shedding component 5,
the tail end of the pillar 3 is inserted into a round hole 207 of the rectangular-shaped frame 2 and bonded, the lower hollow cone 4063 of the oscillator swinging around a point above the center of gravity 4 is placed at the top end of the pillar 3, the system's center of gravity positioned below the top end of pillar 3, and when harvesting vibration energy, the oscillator swinging around a point above the center of gravity 4 swings or rotates, the movable column 502 of the anti-shedding component 5 is inserted into the round hole 208 and the circular ring 209 of the rectangular-shaped frame 2 and bonded, the bottom of the hollow cone 501 of the anti-shedding component 5 is positioned above the upper hollow cone 4062 of the anti-shedding component 406, the interaction between the anti-shedding component 406 of the oscillator swinging around a point above the center of gravity 4, and the anti-shedding component 5, and the pillar 3 prevents that when swinging or rotating, the oscillator swinging around a point above the center of gravity 4 is prevented disengaging from the pillar 3.

### 3. The Technical Effect Achieved by the Vibration Harvesting Component for Vibration Power Generator.

Firstly, the vibration harvesting component can harvesting external excitations below 1 Hz, especially capable of harvesting low-frequency vibrations at a frequency of 0.5 Hz when the walking step frequency is at 0.5 steps/s, achieving the technical effect of extending the bandwidth.

Secondly, the vibration harvesting component can respond to random excitations with different acceleration and relative displacement, especially to very small excitation accelerations and shorter relative displacements, such as minor waves, people walking slowly, or the acceleration and shorter relative displacements produced by the upper body freely swaying when sitting down, achieving the technical effect of harvesting low vibration energy in the environment.

Thirdly, by not using elastic springs or cantilever beams as vibration harvesting components, fatigue failure in material caused by deformation during the vibration harvesting process is avoided, achieving the technical effect of increasing the lifespan.

Fourthly, the vibration harvesting component do not use spring or cantilever beam made of elastic materials, nor do they employ the technical principle of converting vibration energy into elastic potential energy for energy release. In the technical scheme, a rigid structure consisting essentially of rods and other components is used, and the technical effect of reducing energy consumption to generate heat in material deformation is achieved by utilizing the mechanical principle.

### II. Vibration Harvesting Device Used in Electromagnetic Vibration Power Generator

### 1. Technical Problems Solved

In addition to addressing the technical problems of the vibration harvesting components mentioned above, the following technical problems associated with the vibration harvesting device used in electromagnetic vibration power generators also need to be resolved:

Firstly, the problem that the aforementioned vibration harvesting device can only harvesting excitations from a single direction and is unable to capture omnidirectional external excitations needs to be solved.

Secondly, due to the unidirectionality of the harvesting direction in the aforementioned vibration harvesting device, it is required that the base must be positioned in the direction from which the vibration originates. If the base is offset or even if the vibration power generator is inverted, and exceeds the effective harvesting angle of the vibration harvesting device, it becomes unable to perform vibration harvesting. This presents a technical problem with stringent operational requirements.

2. An Embodiment of Vibration Harvesting Device used in Electromagnetic Vibration Power Generator.

The vibration harvesting device used in electromagnetic vibration power generator 12 comprising a vibration harvesting component 1 and a gimbal 13,
the vibration harvesting component 1 is located inside the frame 1301 of the gimbal 13, with the groove 203 beneath the base plate 201 of the vibration harvesting component 1 embedded and aligned in the track 13011 of the frame 1301 that belongs the gimbal 13, and bonded at the seam,
the frame 1301 having the vibration harvesting component 1 mounted therein is located inside the frame 1302 of the gimbal 13, with the slots of the frame 1301 and the slots of the frame 1302 vertically staggered at 90°to each other, the upper part of one end of the embedded frame 1301 abuts against the inner side of the plate 13028 of the frame 1302, after the frames are embedded and aligned, the seam is temporarily not bonded for assembly, waiting for the subsequent process to complete the installation of the electromagnetic power generation unit components is fixed,
insert the T-shaped tenon of [symbol] -shaped part 1305A of the gimbal 13 into the T-shaped groove at the lower end of the T-shaped beam 1304A and move it left and right, concurrently, insert the T-shaped tenon of [symbol] -shaped part 1305B of the gimbal 13 into the T-shaped groove at the lower end of the T-shaped beam 1304B and move it left and right, thereby achieving adjustment of the system's center of gravity along the X-axis for the vibration harvesting component 1, the movable parts used for adjustment are not yet bonded and fixed, and will be secured after the installation of the electromagnetic power generation unit components in the subsequent process,
the T-shaped tenon at the left end of the T-shaped beam 1304A of the gimbal 13 is inserted into the T-shaped groove 1303A, the T-shaped tenon at the right end of the T-shaped beam 1304A is inserted into the T-shaped groove 1303B to move inwards and outwards, meanwhile, the T-shaped tenon at the left end of the T-shaped beam 1304B of the gimbal 13 is inserted into the T-shaped groove 1303C, and the T-shaped tenon at the right end of the T-shaped beam 1304B is inserted into the T-shaped groove 1303D to move inwards and outwards, so that the system's center of gravity of the vibration harvesting component 1 on the Y-axis is adjusted, the movable parts used for adjustment are not yet bonded and fixed, and will be secured after the installation of the electromagnetic power generation unit components in the subsequent process,

the system's center of gravity of the vibration harvesting component 1 is located below the line connecting multi-diameter shaft 1306A and multi-diameter shaft 1306B of the gimbal 13, so that the rigid body can be automatically adjusted no matter how the rigid body rotates, the system's center of gravity on the Z-axis can be adjusted,
during harvesting, regardless of rotation, the framework device formed by the inner ring 1311A and outer ring 1312A of the gimbal 13 adjusts mutually, allowing the vibration harvesting component 1 to harvest omnidirectional external excitation.

Wherein, the vibration harvesting component 1 is a vibration harvesting component for vibration power generator.

### 3. The Technical Effects Achieved by the Vibration Harvesting Device Used in Electromagnetic Vibration Power Generator

In addition to the technical effects of the aforementioned vibration harvesting component, the vibration harvesting device used in electromagnetic vibration power generator also achieves the following technical effects:

Firstly, in the design, the vibration harvesting component is combined with the gimbal, enabling the vibration harvesting device to achieve the technical effect of harvesting omnidirectional external excitations.

Secondly, in a gravitational environment, when the base of the vibration power generator is offset or inverted at any angle, the loaded vibration harvesting device can still capture external excitations from different directions, achieving the technical effect of vibration harvesting under the complex and variable operating conditions.

### III. Vibration Harvesting Device Used in Composite Vibration Power Generator

### 1. Technical Problems Solved

In addition to solving the technical problems associated with the aforementioned vibration harvesting components, the vibration harvesting device used in composite vibration power generator also addresses these following technical problems:

Firstly, it resolves the problem where the aforementioned vibration harvesting device can only harvesting external excitations from a single direction and is unable to harvest omnidirectional external excitations.

Secondly, it addresses the problem with the aforementioned vibration harvesting device, where due to the singularity of the vibration harvesting direction, the base must be positioned in the direction from which the vibration originates. When the base is offset, or even when the vibration power generator is inverted, surpassing the effective vibration harvesting angle of the device makes vibration harvesting impossible, presenting a technical problem with stringent operational requirements.

Thirdly, it solves the technical problem associated with the aforementioned vibration harvesting device, where the type of feedback action for converting the harvesting external excitations into electrical generation by the generation unit is singular.

2. An Embodiment of Vibration Harvesting Device used in Composite Vibration Power Generator.

The vibration harvesting device used in composite vibration power generator comprising a vibration harvesting component 1 and a gimbal 19,
the vibration harvesting component 1 is located inside the frame 1301B of the gimbal 19, with the groove 203 beneath the base plate 201 of the vibration harvesting component 1 embedded and aligned in the track 13011B of the frame 1301B that belongs the gimbal 19, and bonded at the seam,
the frame 1301B having the vibration harvesting component 1 mounted therein is located inside the frame 1302B of the gimbal 19, with the slots of the frame 1301B and the slots of the frame 1302B vertically staggered at 90° to each other, the upper part of one end of the embedded frame 1301B abuts against the inner side of the plate 13028B of the frame 1302B, after the frames are embedded and aligned, the seam is temporarily not bonded for assembly, waiting for the subsequent process to complete the installation of the electromagnetic power generation unit components is fixed,
the vertical inner side of the [symbol] -shaped plate 190112 of the piezoelectric and friction power generation subassembly 1901 is fitted to the bonding area of the square-shaped thin plate 13021B of the frame 1302B, but bonding is temporarily not performed, the vertical inner side of the [symbol] -shaped plate 190113 is fitted to the bonding area of the square-shaped thin plate 13024B of the frame 1302B, but bonding is temporarily not performed, waiting for the installation of the piezoelectric ceramic power generation unit and the triboelectric nano power generation unit to be completed before bonding,
the piezoelectric and friction power generation subassembly 1901 is used to capture the impact actions generated between objects and the friction between objects,
the hose 1902A is sleeved on the shaft journal of the multi-diameter shaft 1306I of the gimbal 19, with the joint bonded for transmission,
the hose 1902B is sleeved on the shaft journal of the multi-diameter shaft 1306J of the gimbal 19, with the joint bonded for transmission,
the hose 1902C is sleeved on the shaft journal of the multi-diameter shaft 1306K of the gimbal 19, with the joint bonded for transmission,
the hose 1902D is sleeved on the shaft journal of the multi-diameter shaft 1306L of the gimbal 19, with the joint bonded for transmission,
insert the T-shaped tenon of [symbol] -shaped part 1305C of the gimbal 19 into the T-shaped groove at the lower end of the T-shaped beam 1304C and move it left and right, concurrently, insert the T-shaped tenon of [symbol] -shaped part 1305D of the gimbal 19 into the T-shaped groove at the lower end of the T-shaped beam 1304D and move it left and right, thereby achieving adjustment of the system's center of gravity along the X-axis for the vibration harvesting component 1, the movable parts used for adjustment are not yet bonded and fixed, and will be secured after the installation of the electromagnetic power generation unit components in the subsequent process,
the T-shaped tenon at the left end of the T-shaped beam 1304C of the gimbal 19 is inserted into the T-shaped groove 1303E, the T-shaped tenon at the right end of the T-shaped beam 1304C is inserted into the T-shaped groove 1303F to move inwards and outwards, meanwhile, the T-shaped tenon at the left end of the T-shaped beam 1304D of the gimbal 19 is inserted into the T-shaped groove 1303G, and the T-shaped tenon at the right end of the T-shaped beam 1304D is inserted into the T-shaped groove 1303H to move inwards and outwards, so that the system's center of gravity of the vibration harvesting component 1 on the Y-axis is adjusted, the movable parts used for adjustment are not yet bonded and fixed, and will be secured after the installation of the electromagnetic power generation unit components in the subsequent process,
the system's center of gravity of the vibration harvesting component 1 is located below the line connecting multi-diameter shaft 1306I and multi-diameter shaft 1306J of the gimbal 19, so that the rigid body can be automatically adjusted no matter how the rigid body rotates, the system's center of gravity on the Z-axis can be adjusted,
during harvesting, regardless of rotation, the framework device formed by the inner ring 1903A and outer ring 1312C of the gimbal 19 adjusts mutually, allowing the vibration harvesting component 1 to harvest omnidirectional external excitation.

Wherein, the vibration harvesting component 1 is a vibration harvesting component for vibration power generator.

### 3. The Technical Effects Achieved by the Vibration Harvesting Device Used in Composite Vibration Power Generator

In addition to the technical effects of the aforementioned vibration harvesting component, the vibration harvesting device used in composite vibration power generator also achieves the following technical effects:

Firstly, in the design, the vibration harvesting component is combined with the gimbal, enabling the vibration harvesting device to achieve the technical effect of harvesting omnidirectional external excitations.

Secondly, in a gravitational environment, when the base of the vibration power generator is offset or inverted at any angle, the loaded vibration harvesting device can still capture external excitations from different directions, achieving the technical effect of vibration harvesting under the complex and variable operating conditions.

Thirdly, after the vibration harvesting device harvesting external excitation, achieving the technical effect of delivers diverse feedback actions to the power generation units for energy conversion.

### IV. Electromagnetic Vibration Power Generator

### 1. Technical Problems Solved

In addition to addressing the technical problems of the vibration harvesting device used in electromagnetic vibration power generator mentioned above, the following technical problems associated with the electromagnetic vibration power generator also need to be resolved:

Firstly, addressing the technical problem of the aforementioned vibration power generator being weak in generating electricity when facing low Hertz vibrations, such as vibrations lower than 1 Hz, as well as random excitations with different acceleration and relative displacement, especially when a person is walking slowly or when the upper body is freely swaying after sitting down.

Secondly, solving the technical problem of the aforementioned vibration power generators being unable to harvest excitations omnidirectionally for electricity generation, and the inability to generate electricity when the vibration power generator is inverted beyond the effective vibration harvesting angle.

### 2. An Embodiment of Electromagnetic Vibration Power Generator

The electromagnetic vibration power generator 24 comprising a vibration harvesting device used in electromagnetic vibration power generator 12, windings 25, windings 26, insulated wire 27, an upper hemispherical shell 28, a lower hemispherical shell 29, bolt 30, and nut 31,
the enameled wire is wound clockwise in three slots of the frame 1301 to form three coils, which are connected in series to form the windings 25,
the vibration harvesting component 1 of the vibration harvesting device used in electromagnetic power generator 12 is located inside the frame 1301 of the gimbal 13, and the groove 203 below the base plate 201 of the vibration harvesting component 1 is embedded and aligned with the track 13011 of the frame 1301 and then bonded,
the enameled wire is wound clockwise in three slots on the frame 1302 to form three coils, which are connected in series to form the windings 26,
the frame 1301 with the vibration harvesting component 1 is embedded inside the frame 1302, with the slots of the frame 1301 and the slots of the frame 1302 arranged in a 90° staggered manner, the upper part of the end embedded in the frame 1301 abuts against the inner side of the plate 13028 of the frame 1302, and is bonded after alignment,
the windings 25 and windings 26 are connected in series, leaving enameled wire end 32A and enameled wire end 32B,
the enameled wire end 32A is soldered to the surface of the hexagonal thin nut 1308A, and the enameled wire end 32B is soldered to the surface of the hexagonal thin nut 1308B,
the insulated wire 27 further including: insulated wires 27A, 27B, 27C, 27D, 27E, and 27F,
one end of the insulated wire 27A is soldered to the flange surface of the flange bearing 1309A, and the wire body of the insulated wire 27A is bonded in the left upper wire groove 13113A to reach the upper end through hole of the inner ring 1311A, the other end of the insulated wire 27A is soldered to the surface of the circlip for shaft 1310C,
one end of the insulated wire 27B is soldered to the flange surface of the flange bearing 1309B, and the wire body of the insulated wire 27B is bonded in the right lower wire groove 13113A to reach the lower end through hole of the inner ring 1311A, the other end of the insulated wire 27B is soldered to the surface of the circlip for shaft 1310D,
one end of the insulated wire 27C is soldered to the surface of the hexagonal thin nut 1308C, and the wire body of the insulated wire 27C is bonded in the left upper wire groove 13121A to reach the left end through hole of the outer ring 1312A, the other end of the insulated wire 27C is soldered to the surface of the hexagonal thin nut 1308E,
one end of the insulated wire 27D is soldered to the surface of the hexagonal thin nut 1308D, and the wire body of the insulated wire 27D is bonded in the right lower wire groove 13121A to reach the right end through hole of the outer ring 1312A, the other end of the insulated wire 27D is soldered to the surface of the hexagonal thin nut 1308F,
one end of the insulated wire 27E is soldered to the flange surface of the flange bearing 1309E, and one end of the insulated wire 27F is soldered to the flange surface of the flange bearing 1309F,
after harvesting, the current flows from the enameled wire end 32A of the windings through conductive components to the insulated wire 27E, and the other end flows from the enameled wire end 32B of the windings through conductive components to the insulated wire 27F,
inserted the T-shaped tenon of [symbol] -shaped part 1305A of the gimbal 13 into the T-shaped groove at the lower end of the T-shaped beam 1304A and move it left and right, concurrently, insert the T-shaped tenon of [symbol] -shaped part 1305B of the gimbal 13 into the T-shaped groove at the lower end of the T-shaped beam 1304B and move it left and right, thereby achieving adjustment of the system's center of gravity along the X-axis for the vibration harvesting component 1, after which the movable components are bonded and fixed,
the T-shaped tenon at the left end of the T-shaped beam 1304A of the gimbal 13 is inserted into the T-shaped groove 1303A, the T-shaped tenon at the right end of the T-shaped beam 1304A is inserted into the T-shaped groove 1303B to move inwards and outwards, meanwhile, the T-shaped tenon at the left end of the T-shaped beam 1304B of the gimbal 13 is inserted into the T-shaped groove 1303C, and the T-shaped tenon at the right end of the T-shaped beam 1304B is inserted into the T-shaped groove 1303D to move inwards and outwards, so that the system's center of gravity of the vibration harvesting component 1 on the Y-axis is adjusted, after which the movable components are bonded and fixed,
the system's center of gravity of the vibration harvesting component 1 is located below the line connecting multi-diameter shaft 1306A and multi-diameter shaft 1306B of the gimbal 13, so that the rigid body can be automatically adjusted no matter how the rigid body rotates, the system's center of gravity on the Z-axis can be adjusted,
during harvesting, regardless of the direction of rotation, the frame device formed by the inner ring 1311A and the outer ring 1312A of the gimbal 13 adjusts relative to each other, allowing the vibration harvesting component 1 to capture omnidirectional external excitation, resulting in electromagnetic induction in the windings 25 and windings 26,
the diamond-shaped base 1315A is placed on the plate 2901 and plate 2902 of the lower hemispherical shell 29, and is fastened with bolt 30A, nut 31A, bolt 30B, and nut 31B; the diamond-shaped base 1315B is placed on the plate 2903 and plate 2904 of the lower hemispherical shell 29, and is fastened with bolt 30C, nut 31C, bolt 30D, and nut 31D;
the upper hemispherical shell 28 covers the lower hemispherical shell 29, aligning the through holes with the through holes, and is fastened with bolt 30E, nut 31E, bolt 30F, nut 31F, bolt 30G, nut 31G, bolt 30H, and nut 31H,
the insulated wire 27E passes through the through hole 2801, with the wire body remaining outside the upper hemispherical shell 28 for connection to an external load, and the gap left by the insulated wire 27E passing through the through hole 2801 is sealed with industrial adhesive; the insulated wire 27F passes through the through hole 2802, with the wire body remaining outside the upper hemispherical shell 28 for connection to the external load, and the gap left by the insulated wire 27F passing through the through hole 2802 is sealed with industrial adhesive.

Wherein, the vibration harvesting device used in electromagnetic vibration power generator 12 is a vibration harvesting device used in electromagnetic vibration power generator.

Wherein, the vibration harvesting component 1 is a vibration harvesting component for vibration power generator.

### 3. The Technical Effects Achieved by the Electromagnetic Vibration Power Generator

In addition to the technical effects of the aforementioned vibration harvesting device, the electromagnetic vibration power generator also achieves the following technical effects:

Firstly, the vibration harvesting component has the capability to harvest vibrations at low frequencies, such as below 1 Hz, and also for random excitations with varying acceleration and relative displacement, especially when a person walks slowly or when the upper body swaying freely after sitting down. This enhances the technical effect of the vibration power generator in generating electricity under conditions of low-frequency vibrations, small excitation accelerations, and short relative displacements.

Secondly, in the continuous adjustment of the gimbal of the vibration harvesting device, the vibration harvesting component always maintains an effective harvesting angle. This allows the vibration power generator to harvest omnidirectional excitations for power generation, and it can also generate power when flipped upside down.

### V. An Embodiment of Composite Vibration Power Generator

### 1. Technical Problems Solved

In addition to addressing the technical problems of the vibration harvesting device used in composite vibration power generator mentioned above, the following technical problems associated with the composite vibration power generator also need to be resolved:

Firstly, addressing the technical problem of the aforementioned vibration power generators being weak in generating electricity when facing low Hertz vibrations, such as vibrations lower than 1 Hz, as well as random excitations with different acceleration and relative displacement, especially when a person is walking slowly or when the upper body is freely swaying after sitting down.

Secondly, solving the technical problem of the aforementioned vibration power generators being unable to harvest excitations omnidirectionally for electricity generation, and the inability to generate electricity when the vibration power generator is inverted beyond the effective vibration harvesting angle.

Thirdly, it solves the technical problem associated with the aforementioned composite vibration power generators, where the type of feedback action for converting the harvesting external excitations into electrical generation by the power generation unit is singular. This results in a single type of power generation unit within the vibration power generator that can utilize this feedback action for power generation, which in turn leads to a lower energy generation efficiency of the vibration power generator.

### 2. An Embodiment of Composite Vibration Power Generator

The composite vibration power generator 37 comprising a vibration harvesting device used in composite vibration power generator 18, windings 38, windings 39, a piezoelectric and triboelectric power generation unit 40, a disc-type triboelectric nano power generation unit 41A, a disc-type triboelectric nano power generation unit 41B, a disc-type triboelectric nano power generation unit 41C, a disc-type triboelectric nano power generation unit 41D, insulated wire 42, an upper hemispherical shell 28C, a lower hemispherical shell 29C, bolt 30, and nut 31,
the enameled wire is wound clockwise in three slots of the frame 1301B to form three coils, which are connected in series to form the windings 38,
the vibration harvesting component 1 of the vibration harvesting device used in composite vibration power generator 18 is located inside the frame 1301B of the gimbal 19, and the groove 203 beneath the base plate 201 of the vibration harvesting component 1 is embedded and aligned in the track 13011B of the frame 1301B of the gimbal 19 and then bonded,
the enameled wire is wound clockwise in three slots on the frame 1302B to form three coils, which are connected in series to form the windings 39,
the frame 1301B with the vibration harvesting component 1 is embedded inside the frame 1302B, with the slots of the frame 1301B and the slots of the frame 1302B arranged in a 90° staggered manner, the upper part of the end embedded in the frame 1301B abuts against the inner side of the plate 13028B of the frame 1302B, and is bonded after alignment,
the windings 38 are connected in series with the windings 39, leaving enameled wire end 43A and enameled wire end 43B,
the enameled wire end 43A is soldered to the surface of the hexagonal thin nut 1308M, and the enameled wire end 43B is soldered to the surface of the hexagonal thin nut 1308N,
the insulated wire 42 further including: insulated wires 42A, 42B, 42C, 42D, 42E, and 42F,
the end of the insulated wire 42A is soldered to the surface of the flange of the flange bearing 1309M, and the body of the insulated wire 42A is bonded in the wire groove 190311A on the upper left side, reaching the upper end through hole of the inner ring 1903A, the other end of the insulated wire 42A is soldered to the surface of the circlip for shaft 1310P,
the end of the insulated wire 42B is soldered to the surface of the flange of the flange bearing 1309N, and the body of the insulated wire 42B is bonded in the wire groove 190311A on the lower right side, reaching the lower end through hole of the inner ring 1903A, the other end of the insulated wire 42B is soldered to the surface of the circlip for shaft 1310Q,
the end of the insulated wire 42C is soldered to the surface of the hexagonal thin nut 1308P, and the body of the insulated wire 42C is bonded in the wire groove 13121C on the upper left side, reaching the left end through hole of the outer ring 1312C, the other end of the insulated wire 42C is soldered to the surface of the hexagonal thin nut 1308R,
the end of the insulated wire 42D is soldered to the surface of the hexagonal thin nut 1308Q, and the body of the insulated wire 42D is bonded in the wire groove 13121C on the lower right side, reaching the right end through hole of the outer ring 1312C, the other end of the insulated wire 42D is soldered to the surface of the hexagonal thin nut 1308S,
the end of the insulated wire 42E is soldered to the surface of the flange of the flange bearing 1309R, and the end of the insulated wire 42F is soldered to the surface of the flange of the flange bearing 1309S,
after harvesting, the current flows from the enameled wire end 43A of the windings through the conductive components to the insulated wire 42E, while the other end flows from the enameled wire end 43B of the windings through the conductive components to the insulated wire 42F,
the inner vertical side of the [symbol] -shaped plate 190112 of the frame 19011 of the piezoelectric and triboelectric power generation unit 40 is bonded to the bonding area of the square-shaped thin plate 13021B of the frame 1302B, and the inner vertical side of the [symbol] -shaped plate 190113 is bonded to the bonding area of the square-shaped thin plate 13024B of the frame 1302B, the insulated wire 4003A is soldered to the surface of the hexagonal thin nut 1308M, and the insulated wire 4003B is soldered to the surface of the hexagonal thin nut 1308N,
the surfaces of the plate 41022A and the plate 41023A of the disc-type triboelectric nano power generation unit 41A is bonded to the surfaces of the plate 19033A and plate 19034A of the inner ring 1903A, the hose 1902A is fitted onto the spindle nose of the multi-diameter shaft 4103A, with the contact portion bonded, one end of the insulated wire 4108AA is soldered to the surface of the circlip for shaft 1310M, and the body of the insulated wire 4108BA is bonded in the wire groove 190311A on the lower left side, reaching the lower end through hole of the inner ring 1903A, the other end of the insulated wire 4108BA is soldered to the surface of the circlip for shaft 1310Q,
the surfaces of the plate 41022B and the plate 41023B of the disc-type triboelectric nano power generation unit 41B is bonded to the surfaces of the plate 19035A and plate 19036A of the inner ring 1903A, the hose 1902B is fitted onto the spindle nose of the multi-diameter shaft 4103B, with the contact portion bonded, one end of the insulated wire 4108AB is soldered to the surface of the circlip for shaft 1310N, and the body of the insulated wire 4108BB is bonded in the wire groove 190311A on the upper right side, reaching the upper end through hole of the inner ring 1903A, the other end of the insulated wire 4108BB is soldered to the surface of the circlip for shaft 1310P,
the surfaces of the plate 41022C and the plate 41023C of the disc-type triboelectric nano power generation unit 41C is bonded to the surfaces of the plate 19037A and plate 19038A of the inner ring 1903A, the hose 1902C is fitted onto the spindle nose of the multi-diameter shaft 4103C, with the contact portion bonded, one end of the insulated wire 4108AC is soldered to the surface of the circlip for shaft 1310P, and the body of the insulated wire 4108BC is bonded in the wire groove 190311A on the right side, reaching the lower end through hole of the inner ring 1903A, the other end of the insulated wire 4108BC is soldered to the surface of the circlip for shaft 1310Q,
the surfaces of the plate 41022D and the plate 41023D of the disc-type triboelectric nano power generation unit 41D is bonded to the surfaces of the plate 19039A and plate 190310A of the inner ring 1903A, the hose 1902D is fitted onto the spindle nose of the multi-diameter shaft 4103D, with the contact portion bonded, one end of the insulated wire 4108AD is soldered to the surface of the circlip for shaft 1310Q, and the body of the insulated wire 4108BD is bonded in the wire groove 190311A on the left side, reaching the upper end through hole of the inner ring 1903A, the other end of the insulated wire 4108BD is soldered to the surface of the circlip for shaft 1310P,
insert the T-shaped tenon of [symbol] -shaped part 1305C of the gimbal 19 into the T-shaped groove at the lower end of the T-shaped beam 1304C and move it left and right, concurrently, insert the T-shaped tenon of [symbol] -shaped part 1305D of the gimbal 19 into the T-shaped groove at the lower end of the T-shaped beam 1304D and move it left and right, thereby achieving adjustment of the system's center of gravity along the X-axis for the vibration harvesting component 1, after adjustment, the movable components are bonded and fixed,
the T-shaped tenon at the left end of the T-shaped beam 1304C of the gimbal 19 is inserted into the T-shaped groove 1303E, the T-shaped tenon at the right end of the T-shaped beam 1304C is inserted into the T-shaped groove 1303F to move inwards and outwards, meanwhile, the T-shaped tenon at the left end of the T-shaped beam 1304D of the gimbal 19 is inserted into the T-shaped groove 1303G, and the T-shaped tenon at the right end of the T-shaped beam 1304D is inserted into the T-shaped groove 1303H to move inwards and outwards, so that the system's center of gravity of the vibration harvesting component 1 on the Y-axis is adjusted, after adjustment, the movable components are bonded and fixed,
the system's center of gravity of the vibration harvesting component 1 is located below the line connecting multi-diameter shaft 1306I and multi-diameter shaft 1306J of the gimbal 19, so that the rigid body can be automatically adjusted no matter how the rigid body rotates, the system's center of gravity on the Z-axis can be adjusted,
during harvesting, regardless of the direction of rotation, the frame device formed by the inner ring 1903A and the outer ring 1312C of the gimbal 19 adjusts relative to each other, allowing the vibration harvesting component 1 to capture omnidirectional external excitation, resulting in electromagnetic induction in the windings 38 and windings 39,
the diamond-shaped base 1315E is placed on the plate 2901C and plate 2902C of the lower hemispherical shell 29C, and is fastened using bolt 30R, nut 31R, bolt 30S, and nut 31S; the diamond-shaped base 1315F is placed on the plate 2903C and plate 2904C of the lower hemispherical shell 29C, and is fastened using bolt 30T, nut 31T, bolt 30U, and nut 31U,
the upper hemispherical shell 28C covers the lower hemispherical shell 29C, with the through holes aligned with each other, bolt 30V, nut 31V, bolt 30W, nut 31W, bolt 30X, nut 31X, bolt 30Y, and nut 31Y are used for fastening,
the insulated wire 42E passes through the through hole 2801C, with the wire body remaining outside the upper hemispherical shell 28C for connection to an external load, the insulated wire 42E is sealed with industrial adhesive at the gap left by the through hole 2801C; the insulated wire 42F passes through the through hole 2802C, with the wire body remaining outside the upper hemispherical shell 28C for connection to the external load, the insulated wire 42F is sealed with industrial adhesive at the gap left by the through hole 2802C.

Wherein, the vibration harvesting device used in composite vibration power generator 18 is a vibration harvesting device used in composite vibration power generator.

Wherein, the vibration harvesting component 1 is a vibration harvesting component for vibration power generator.

### 3. The Technical Effects Achieved by the Composite Vibration Power Generator.

In addition to the technical effects of the aforementioned vibration harvesting device used in composite vibration power generator, the composite vibration power generator also achieves the following technical effects:

Firstly, the vibration harvesting component has the capability to harvest vibrations at low frequencies, such as below 1 Hz, and also for random excitations with varying acceleration and relative displacement, especially when a person walks slowly or when the upper body swaying freely after sitting down. This enhances the technical effect of the vibration power generator in generating electricity under conditions of low-frequency vibrations, small excitation accelerations, and short relative displacements.

Secondly, in the continuous adjustment of the gimbal of the vibration harvesting device, the vibration harvesting component always maintains an effective harvesting angle. This allows the vibration power generator to harvest omnidirectional excitations for power generation, and it can also generate power when flipped upside down.

Thirdly, after receiving external excitations, the vibration harvesting device exhibits a variety of feedback actions. This diversity allows the vibration power generator to incorporate multiple types of power generation units that utilize different feedback actions for electricity generation, thereby achieving the technical effect of enhancing the energy generation efficiency of the vibration power generator.

### BRIEF DESCRIPTION OF THE DRAWINGS

FIG. 1 illustrates an oblique view of the vibration harvesting component 1.

FIG. 2 illustrates an oblique view of the rectangular-shaped frame 2.

FIG. 3 illustrates an oblique view of the rectangular-shaped frame 2.

FIG. 4 illustrates an oblique view of the oscillator swinging around a point above the center of gravity 4.

FIG. 5 illustrates a top view of the oscillator swinging around a point above the center of gravity 4.

FIG. 6 illustrates a top view of the rod member 401, the rod member 402, the ring member 403, the rod member 404, and the U-shaped rod member 405.

FIG. 7 illustrates a bottom view of the rod member 401, the rod member 402, the ring member 403, the rod member 404, and the U-shaped rod member 405.

FIG. 8 illustrates a right-side view of the rod member 401, the rod member 402, the ring member 403, the rod member 404, and the U-shaped rod member 405.

FIG. 9 illustrates a front view of the rod member 401, the rod member 402, the ring member 403, the rod member 404, and the U-shaped rod member 405.

FIG. 10 illustrates a front view of the anti-shedding component 406.

FIG. 11 illustrates an oblique view of the anti-shedding component 406.

FIG. 12 illustrates an exploded view of the oscillator swinging around a point above the center of gravity 4.

FIG. 13 illustrates an exploded view of the anti-shedding component 5.

FIG. 14 illustrates a diagram showing the positional relationship between the oscillator swinging around a point above the center of gravity 4 and the anti-shedding component 5.

FIG. 15 illustrates a front view of the vibration harvesting device used in electromagnetic vibration power generator 12.

FIG. 16 illustrates a left-side view of the vibration harvesting device used in electromagnetic vibration power generator 12.

FIG. 17 illustrates a top view of the vibration harvesting device used in the electromagnetic vibration power generator 12.

FIG. 18 illustrates an exploded view and parts composition view of the vibration harvesting device used in electromagnetic vibration power generator 12.

FIG. 19 illustrates an exploded view and parts composition view of the gimbal 13.

FIG. 20 illustrates an oblique view of the frame 1301.

FIG. 21 illustrates a view showing the assembly relationship between the frame 1301 and the vibration harvesting component 1.

FIG. 22 illustrates an oblique view of the frame 1302.

FIG. 23 illustrates a view showing the assembled relationship between the frame 1301 which equipped with the vibration harvesting component 1 and the frame 1302.

FIG. 24 illustrates an oblique view of the T-shaped groove 1303.

FIG. 25 illustrates an oblique view of the T-shaped beam 1304.

FIG. 26 illustrates an oblique view of the [symbol] -shaped part 1305.

FIG. 27 illustrates a front view of the multi-diameter shaft 1306.

FIG. 28 shows a view illustrates the assembly relationship between the frame 1302 and the T-shaped groove 1303A, the T-shaped groove 1303B, the T-shaped beam 1304A, the [symbol] -shaped part 1305A, the multi-diameter shaft 1306A, the shaft sleeve 1307A, the hexagonal thin nut 1308A; as well as the assembly relationship between the frame 1302 and the T-shaped groove 1303C, the T-shaped groove 1303D, the T-shaped beam 1304B, the [symbol] -shaped part 1305B, the multi-diameter shaft 1306B, the shaft sleeve 1307B, and the hexagonal thin nut 1308B.

FIG. 29 illustrates an oblique view of the inner ring 1311.

FIG. 30 illustrates an oblique view of the outer ring 1312.

FIG. 31 illustrates an oblique view of the diamond-shaped base 1315.

FIG. 32 illustrates a schematic view showing the vibration harvesting device used in electromagnetic vibration power generator 12 for adjusting the system's center of gravity in the X-axis direction by means of movable components.

FIG. 33 illustrates a schematic view showing the vibration harvesting device used in electromagnetic vibration power generator 12 adjusting the system's center of gravity in the Y-axis direction by means of movable components.

FIG. 34 illustrates a front view of the vibration harvesting device used in composite vibration power generator 18.

FIG. 35 illustrates a right-side view of the vibration harvesting device used in composite vibration power generator 18.

FIG. 36 illustrates a bottom view of the vibration harvesting device used in composite vibration power generator 18.

FIG. 37 illustrates an exploded view and parts composition view of the vibration harvesting device used in composite vibration power generator 18.

FIG. 38 illustrates an exploded view and parts composition view of the gimbal 19.

FIG. 39 illustrates an exploded view of the piezoelectric and friction power generation subassembly 1901.

FIG. 40 illustrates an oblique view of the frame 19011.

FIG. 41 illustrates a top view of the frame 19011.

FIG. 42 illustrates an oblique view of the inner ring 1903.

FIG. 43 illustrates an oblique view of the electromagnetic vibration power generator 24.

FIG. 44 illustrates an exploded view of the electromagnetic vibration power generator 24.

FIG. 45 illustrates a schematic view showing the relationship between the vibration harvesting component 1, the frame 1301, the windings 25, the frame 1302 and the windings 26.

FIG. 46 illustrates a diagram showing the relationship of the conductive parts of the electromagnetic vibration power generator 24.

FIG. 47 illustrates an oblique view of the upper hemispherical shell 28.

FIG. 48 illustrates an oblique view of the lower hemispherical shell 29.

FIG. 49 illustrates an exploded view of the composite vibration power generator 37.

FIG. 50 illustrates an exploded view and components view of the composite vibration power generator 37.

FIG. 51 illustrates a schematic view showing the relationship between the vibration harvesting component 1, the frame 1301B, the windings 38, the frame 1302B and the windings 39.

FIG. 52 illustrates a diagram showing the relationship of the conductive parts of the composite vibration power generator 37.

FIG. 53 illustrates an exploded view of the piezoelectric and triboelectric power generation unit 40.

FIG. 54 illustrates an exploded view of the freestanding triboelectric layer based nano generation unit 4002.

FIG. 55 illustrates an oblique view of the disc-type triboelectric nano power generation unit 41.

FIG. 56 illustrates an exploded view of the disc-type triboelectric nano power generation unit 41.

FIG. 57 illustrates another exploded view of the disc-type triboelectric nano power generation unit 41.

FIG. 58 illustrates an electrical connection diagram of the windings 38 and windings 39, the piezoelectric and triboelectric power generation unit 40, the disc-type triboelectric nano power generation unit 41A, the disc-type triboelectric nano power generation unit 41B, the disc-type triboelectric nano power generation unit 41C, and the disc-type triboelectric nano power generation unit 41D.

Among them:
vibration harvesting component 1; rectangular-shaped frame 2, base plate 201, perforated cylinder 202, groove 203, side plate 204, side plate 205, top plate 206, round hole 207, round hole 208, circular ring 209; pillar 3; oscillator swinging around a point above the center of gravity 4, rod member 401, rod member 402, ring member 403, rod member 404, U-shaped rod member 405, anti-shedding component 406, round wafer 4061, upper hollow cone 4062, lower hollow cone 4063, counterweight as part of the electromagnetic power generation unit 407; anti-shedding component 5, hollow cone 501, movable column 502, shallow round hole 5021;
vibration harvesting device used in electromagnetic vibration power generator 12; gimbal 13; frame 1301, track 13011, square-shaped thin plate 13012, square-shaped thin plate 13013, square-shaped thin plate 13014, square-shaped thin plate 13015; frame 1302, square-shaped thin plate 13021, square-shaped thin plate 13022, square-shaped thin plate 13023, square-shaped thin plate 13024, plate 13028, plate 130211, plate 130212, plate 130241, plate 130242; T-shaped groove 1303; T-shaped beam 1304; [symbol] -shaped part 1305; multi-diameter shaft 1306; shaft sleeve 1307; hexagonal thin nut 1308; flange bearing 1309; circlip for shaft 1310; inner ring 1311, reinforcing block 13111, reinforcing block 13112, wire groove 13113; outer ring 1312, wire groove 13121, wire groove 13122; shaft sleeve 1313; multi-diameter shaft 1314; diamond-shaped base 1315, foot 13151, foot 13152;
vibration harvesting device used in composite vibration power generator 18; gimbal 19; piezoelectric and friction power generation subassembly 1901, frame 19011, hull-shaped base 190111, [symbol] -shaped plate 190112, [symbol] -shaped plate 190113, ball 19012, top cover 19013; hose 1902; inner ring 1903, connecting frame 19031, connecting frame 19032, plate 19033, plate 19034, plate 19035, plate 19036, plate 19037, plate 19038, plate 19039, plate 190310, wire groove 190311;
electromagnetic vibration power generator 24; windings 25, windings 26, enameled wire end 32A, enameled wire end 32B; insulated wire 27; upper hemispherical shell 28, through hole 2801, through hole 2802; lower hemispherical shell 29, plate 2901, plate 2902, plate 2903, plate 2904, L-shaped foot 2905, L-shaped foot 2906, L-shaped foot 2907, L-shaped foot 2908; bolt 30; nut 31;
composite vibration power generator 37; windings 38, windings 39, enameled wire end 43A, enameled wire end 43B; piezoelectric and triboelectric power generation unit 40, piezoelectric ceramic sheet 4001, freestanding triboelectric layer based nano generation unit 4002, aluminum foil 40021, double-sided adhesive 40022, insulated wire 40023; insulated wire 4003; disc-type triboelectric nano power generation unit 41, upper outer shell 4101, through hole 41011, through hole 41012, through hole 41013, lower outer shell 4102, through hole 41021, plate 41022, plate 41023, multi-diameter shaft 4103, intermediate disc 4104, silver-plated electrically conductive fiber clusters 4105, polytetrafluoroethylene film 4106, double-sided adhesive copper foil 4107, insulated wire 4108; insulated wire 42.

### DESCRIPTION OF EMBODIMENTS

In order to enable those skilled in the art to implement the invention, the technical problems to be solved and the technical effects to be achieved by the present invention are explained in conjunction with the technical solutions.

### I. Vibration Harvesting Component for Vibration Power Generator

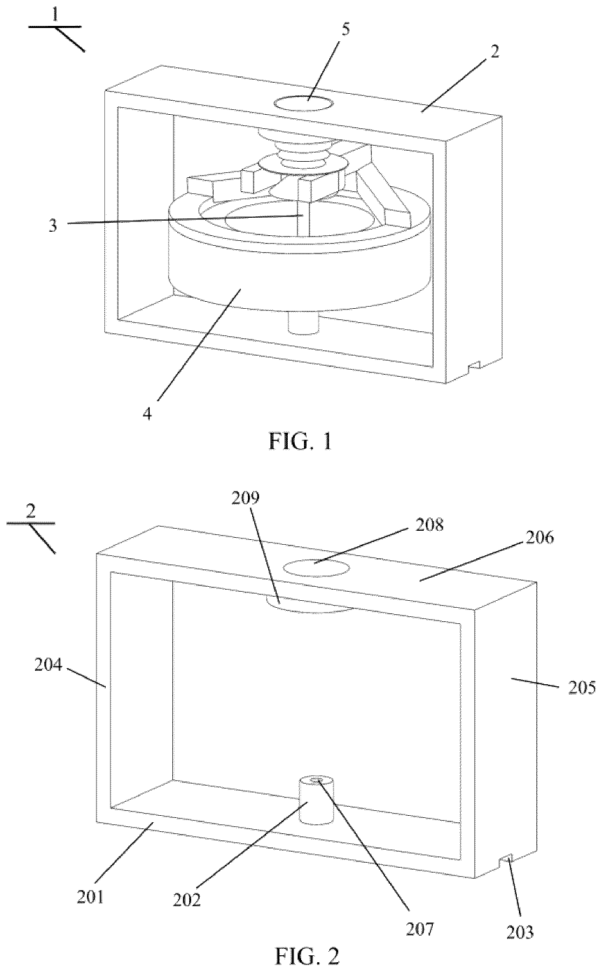

As shown in FIG. 1, the vibration harvesting component 1 comprising a rectangular-shaped frame 2, a pillar 3, an oscillator swinging around a point above the center of gravity 4, an anti-shedding component 5.

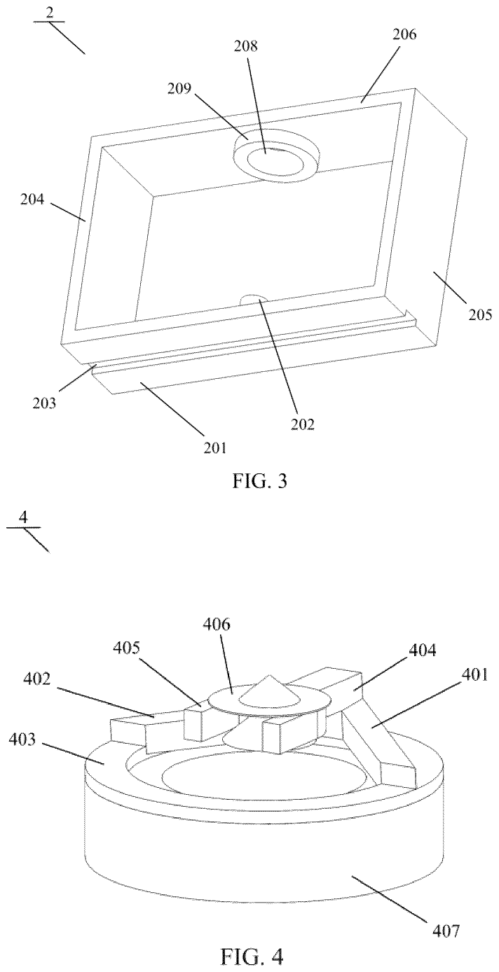

As shown in FIG. 2, the rectangular-shaped frame 2 consisting essentially of a base plate 201, a perforated cylinder 202, a groove 203, a side plate 204, a side plate 205, and a top plate 206, with the material being a plastic selected from diamagnetic materials. In the center of the base plate 201, there is a perforated cylinder 202, and the center of the upper surface of the perforated cylinder 202 has a round hole 207, as shown in FIG. 3, the round hole 207 does not penetrate through the base plate 201. Below the base plate 201, along the midline of the two short sides, there is a groove 203 with a rectangular cross-section. The purpose of this design is to facilitate the entry of the track 13011 of the frame 1301 into the groove 203 of the base plate 201. As shown in FIG. 2, the bottom surface of side plate 204 is connected at a 90° angle to one short side of the base plate 201, while the bottom surface of side plate 205 is connected at a 90° angle to the other short side of the base plate 201. The upper end of side plate 204 is connected to one short side of the top plate 206, and the upper end of side plate 205 is connected to the other short side of the top plate 206. In the center of the upper surface of the top plate 206, there is a round hole 208, through which the axis of the perforated cylinder 202 passes. The center of the lower surface of the top plate 206 is connected to the upper surface of a circular ring 209, with the axis of the perforated cylinder 202 also passing through the center of both the circular ring 209 and the round hole 208. The design of the circular ring 209 aims to increase the contact area with the movable column 502.

The pillar 3 is made of a copper rod. The top of the pillar 3 is rounded to form a dome shape. In selecting the length of the pillar 3, the designer must ensure that when the oscillator swinging around a point above the center of gravity 4 is placed on the pillar 3 to swing or rotate, the bottom surface of the counterweight as part of the electromagnetic power generation unit 407 does not touch the upper surface of the base plate 201. The tail end of the pillar 3 is inserted into the round hole 207, and the inserted portion is bonded using industrial adhesive.

The oscillator swinging around a point above the center of gravity is defined as follows: In a gravitational environment, a system with its center of gravity located below the pivot can maintain its balance autonomously. When subjected to external excitation, maintaining this balance becomes difficult, and the system will immediately generate a torque to restore balance. After multiple spontaneous corrections, the system will once again achieve balance and ultimately return to a state of rest.

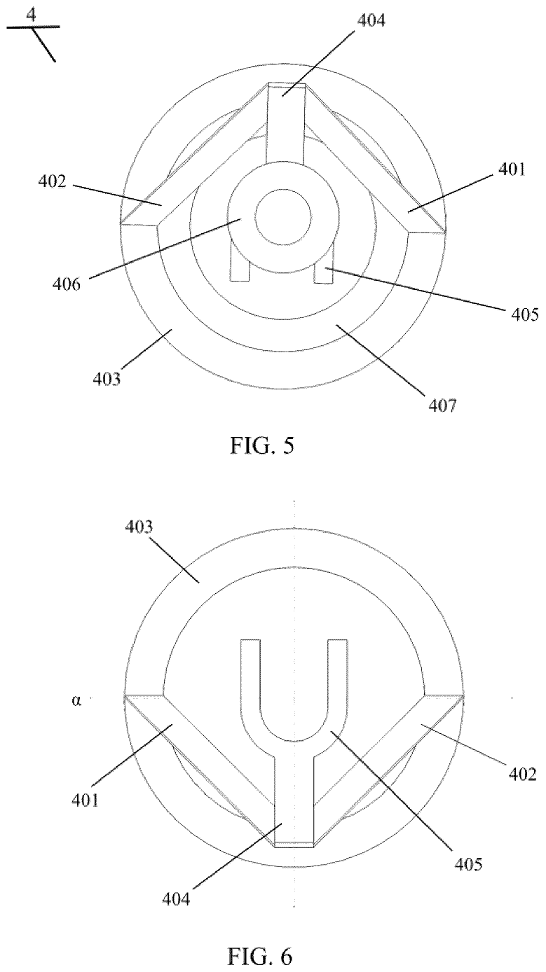

As shown in FIGS. 4 and 5, the oscillator swinging around a point above the center of gravity 4 consisting essentially of a rod member 401, a rod member 402, a ring member 403, a rod member 404, a U-shaped rod member 405, an anti-shedding component 406, and a counterweight as part of the electromagnetic power generation unit 407.

Designers in the field of vibration power generation can design the oscillator of a vibration power generator by simulating toy that swing around a point above the center of gravity in the field of toys.

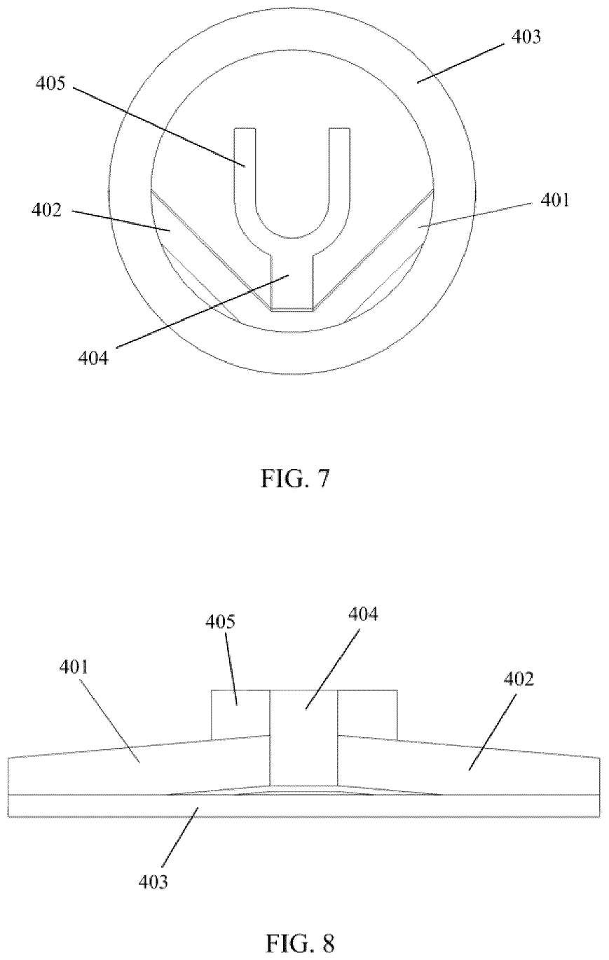

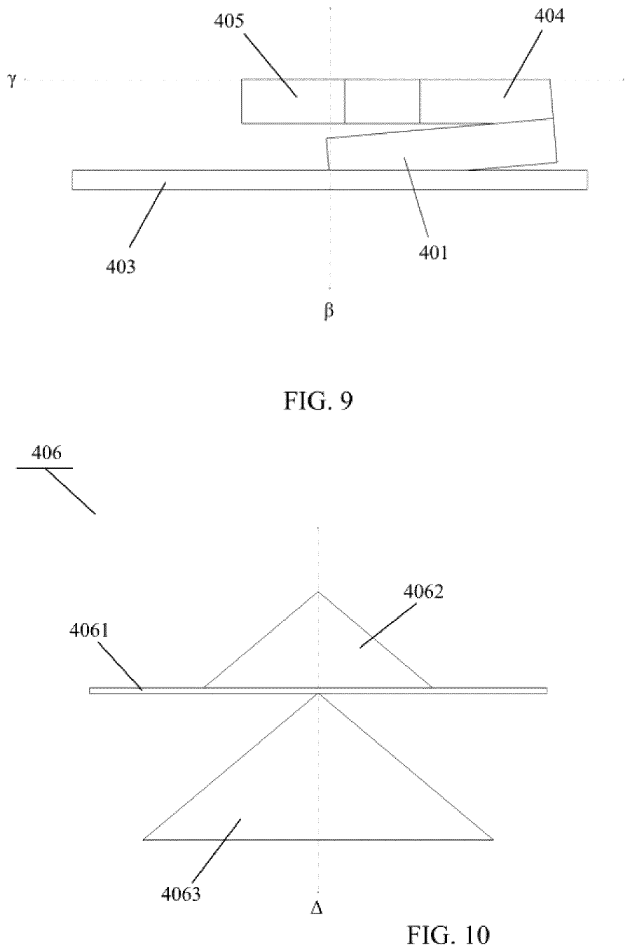

As shown in FIGS. 6, 7, 8, and 9, the bottom surface of rod member 401 is connected to the bottom surface of rod member 402, forming a V-shape. The upper surface of the connecting part of the two connected to the tail end of the lower surface of rod member 404. The bottom surface of the other end of rod member 404 is connected to the protruding bottom surface of the U-shaped rod member 405, ensuring that the upper surface of rod member 404 and the upper surface of U-shaped rod member 405 are in the same plane, with the two side surfaces of U-shaped rod member 405 being parallel to the axis of rod member 404. Taking the diameter line α of ring member 403, one side on the axis of rod member 401 is connected to the upper ring surface of ring member 403, connecting to one end of diameter line α, while the other side on the axis of rod member 402 is connected to the upper ring surface of ring member 403, connecting to the other end of diameter line α. As shown in FIGS. 9 and 8, preferably, the lower surface of rod member 401 forms an angle of 3° with the upper ring surface of ring member 403, and the lower surface of rod member 402 also forms an angle of 3° with the upper ring surface of ring member 403. The lower surface of rod member 404 forms an angle of 3° with the upper surface of rod member 401, and the lower surface of rod member 404 forms an angle of 3° with the upper surface of rod member 402, ensuring that the upper surface of rod member 404 is parallel to the upper ring surface of ring member 403. The vertical auxiliary line β drawn from the center of ring member 403 intersects the auxiliary line γ on the upper surface of U-shaped rod member 405 at a right angle of 90°. The rod member 401, rod member 402, ring member 403, rod member 404, and U-shaped rod member 405 is made of a plastic material selected from diamagnetic materials.

As shown in FIGS. 10 and 11, the anti-shedding component 406 consisting essentially of a round wafer 4061, an upper hollow cone 4062, and a lower hollow cone 4063, with the material made of copper sheet. The base of the upper hollow cone 4062 is welded to the upper surface of the round wafer 4061, and the axis of the upper hollow cone 4062 vertically passes through the center of the round wafer 4061. The apex of the lower hollow cone 4063 is welded to the center of the lower surface of the round wafer 4061, and the axis of the lower hollow cone 4063 also vertically passes through the center of the round wafer 4061, coinciding with the axis of the upper hollow cone 4062, thereby forming the axis Δ of the anti-shedding component 406.

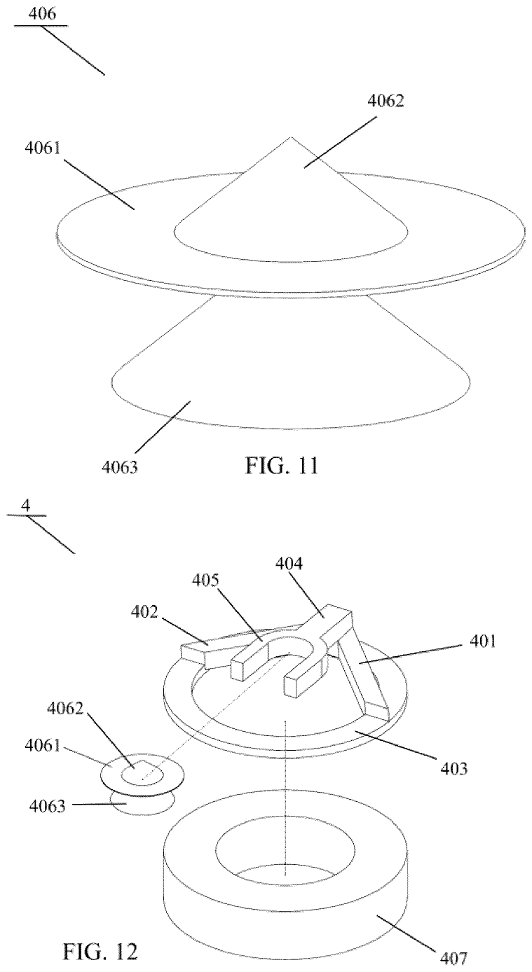

As shown in FIG. 12, after the anti-shedding component 406 is fabricated, the concave part of the U-shaped rod member 405 clamps the joint of the lower surface of the round wafer 4061 and the lower hollow cone 4063. After verifying that the axis Δ of the anti-shedding component 406 is vertically passing through the center of the ring member 403, the joint securely bonded using industrial adhesive.

The counterweight as part of the electromagnetic power generation unit is defined as follows: an object that serves both as a part of the electromagnetic power generation unit and as a counterweight used in the vibration harvesting component.

As shown in FIG. 12, the counterweight as part of the electromagnetic power generation unit 407 is in the shape of a ring and is made of neodymium-iron-boron magnet, with thickness magnetization, and designers aim to select a ring-shaped neodymium iron boron magnet with a relatively thin thickness. The outer diameter of the counterweight as part of the electromagnetic power generation unit 407 is equal to the outer diameter of ring member 403; the width of the counterweight as part of the electromagnetic power generation unit 407 is slightly greater than the width of ring member 403. Preferably, the width of the counterweight as part of the electromagnetic power generation unit 407 is equal to 140% of the width of ring member 403. The upper surface of the counterweight as part of the electromagnetic power generation unit 407 is bonded to the lower surface of ring member 403 using industrial adhesive, ensuring that the outer rings of both components coincide. After the bonding is completed, the axis Δ of the anti-shedding component 406 vertically passes through the center of the upper surface of the counterweight as part of the electromagnetic power generation unit 407.

As shown in FIG. 1, after the oscillator swinging around a point above the center of gravity 4 is assembled, the inner apex of the lower hollow cone 4063 is placed on the dome of the pillar 3. At this point, the oscillator swinging around a point above the center of gravity 4 can maintain its balance autonomously. During swinging or rotation, the bottom edge of the counterweight as part of the electromagnetic power generation unit 407, must not touch the upper surface of the base plate 201. Preferably, during swinging or rotation, there should be a gap of 2 mm between the bottom edge of the counterweight as part of the electromagnetic power generation unit 407 and the upper surface of the base plate 201.

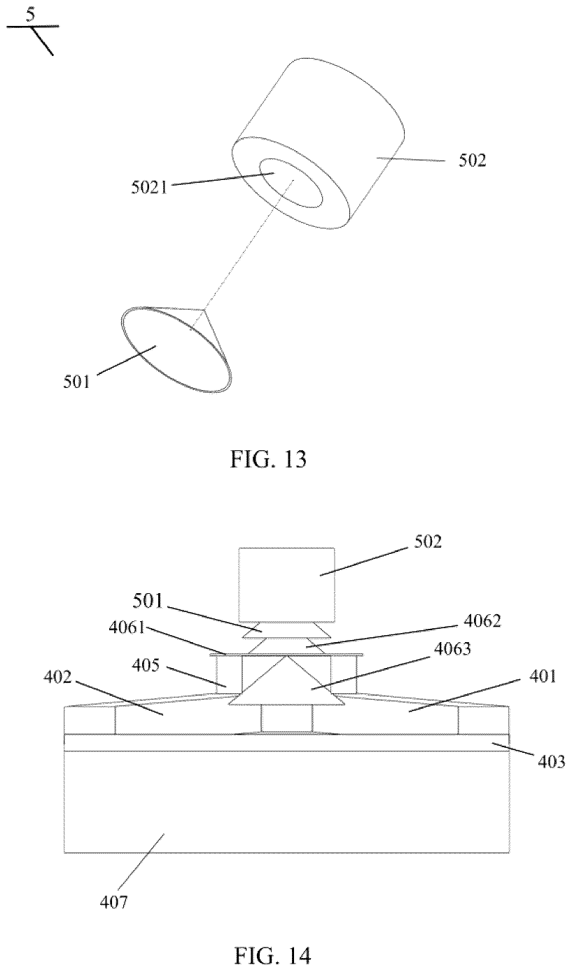

As shown in FIG. 13, the anti-shedding component 5 consisting essentially of a hollow cone 501 and a movable column 502. The anti-shedding component 406 and the anti-shedding component 5 together form the anti-shedding part of the vibration harvesting component 1.

The hollow cone 501 is made of copper sheet.

The movable column 502 is a cylindrical body made of a plastic material selected from diamagnetic materials. A shallow round hole 5021 is created at the center of the lower surface of the movable column 502. The top of the hollow cone 501 is bonded into the shallow round hole 5021 using industrial adhesive, ensuring that the axis of the movable column 502 vertically passes through the center of the bottom surface of the hollow cone 501. The assembly of the anti-shedding component 5 is now complete.

As shown in FIG. 1, the movable column 502 of the anti-shedding component 5 is inserted into the round hole 208 and the circular ring 209. As illustrated in FIG. 14, adjustments are made using the movable column 502 to ensure that the bottom of the hollow cone 501 is positioned directly above the upper hollow cone 4062, while maintaining a certain gap between the two components. Preferably, the bottom of the hollow cone 501 is lowered to one-third of the height of the upper hollow cone 4062, and the axis of the hollow cone 501 coincides with the axis Δ of the anti-shedding component 406. After the assembly adjustments are completed, industrial adhesive is used to securely bond the joint of the movable column 502 with the round hole 208 and the circular ring 209, ensuring that the upper end of the movable column 502 does not protrude above the upper surface of the top plate 206 of the rectangular-shaped frame 2. The assembly of the vibration harvesting component 1 is now complete.

The technical principles, technical problems addressed, and technical effects achieved by the embodiment of the vibration harvesting component will now be described in conjunction with the technical solutions.

In the vibration harvesting component, the center of gravity of the oscillator swinging around a point above the center of gravity 4 is located at the lower end of the dome which is a pivot of the pillar 3, allowing the system to maintain balance. In the presence of external excitation, maintaining balance becomes challenging; however, the system will immediately generate a torque to restore balance. After several spontaneous corrections, the system will once again achieve balance and ultimately return to a stationary state.

In the design of the vibration harvesting component, there is a fundamental principle: the natural frequency of the vibration harvesting component must be close to the frequency of the external excitation, thereby producing resonance. The overall characteristics of external excitation in the environment tend to favor low frequencies, with the frequency varying randomly depending on the nature of the external excitation. In the design, the natural frequency of the oscillator swinging around a point above the center of gravity 4 is made to be close to the vibration frequency band of the external excitation in the environment, allowing for resonance to occur. This approach addresses the technical problem found in the referenced literature, where vibration harvesting components with springs and cantilever beams struggle to capture low-frequency external excitations, particularly those below 1 Hz. As a result, this design achieves the technical effect of expanding the frequency bandwidth.

In the design of the vibration harvesting component, the center of gravity that belongs to the oscillator swinging around a point above the center of gravity 4 is located at the lower end of the dome of the pillar 3. When at rest, the system maintains its balance autonomously. However, the balance of the system can be easily disrupted. So that the oscillator swinging around a point above the center of gravity 4 is susceptibly swinging or rotating in the states of balanced-unbalanced-balanced, when faced with external excitation characterized by small acceleration and a short relative displacement. This design addresses the problem found in the referenced literature regarding vibration harvesting components that are unable to respond to random excitations with varying acceleration and displacement, particularly those with very small acceleration and short relative displacements. As a result, it achieves the technical effect of harvesting low vibration energy from the environment.

The oscillator swinging around a point above the center of gravity 4 employs a rigid structure. This design avoids the technical problem of fatigue failure in material that can occur with the use of springs and cantilever beams due to repeated stress over time. As a result, this approach achieves the technical effect of extending the service life of the vibration harvesting component.

At the same time, the oscillator swinging around a point above the center of gravity 4 utilizes mechanical principles for vibration energy harvesting, rather than employing the technical principle of converting vibration energy into elastic potential energy before releasing it. This design avoids the technical problem of excessive energy consumption due to material deformation during the energy harvesting process, thereby achieving the technical effect of reducing energy loss in the form of heat generated by material deformation.

### II. Vibration Harvesting Device Used in Electromagnetic Vibration Power Generator

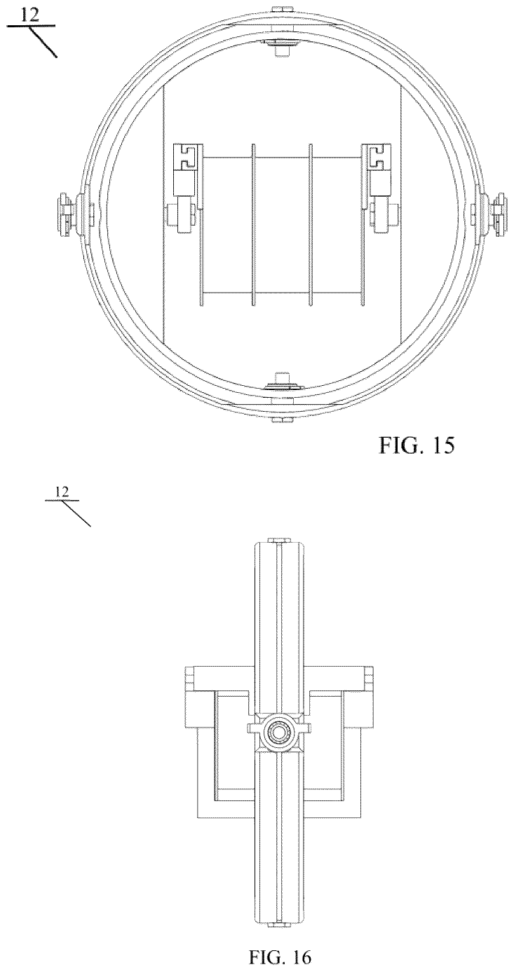

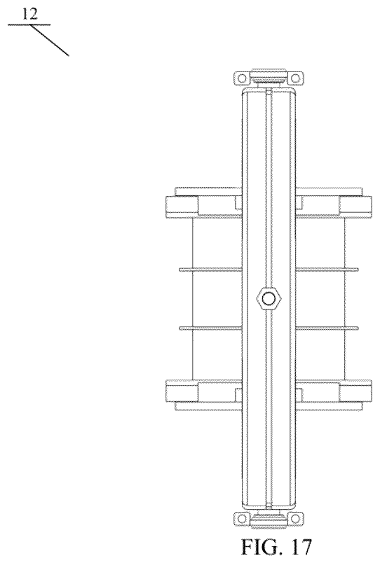

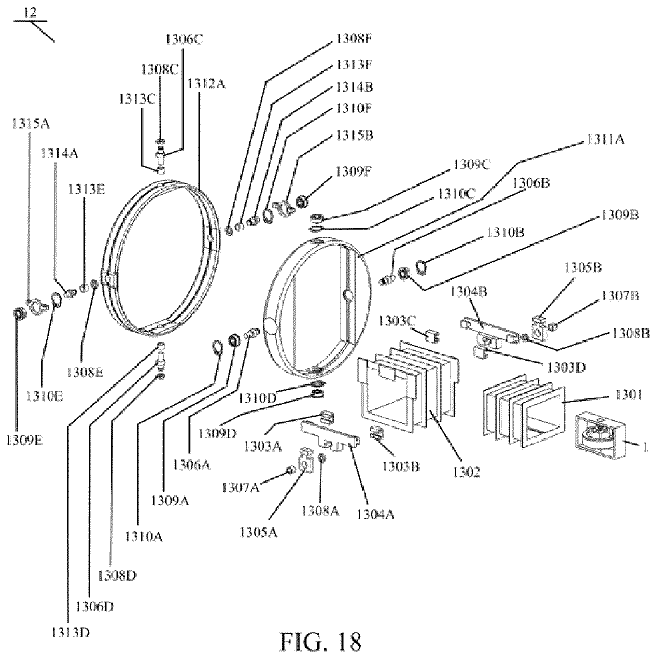

As shown in FIGS. 15, 16, 17, and 18, the vibration harvesting device used in electromagnetic vibration power generator 12 comprising a vibration harvesting component 1 and a gimbal 13.

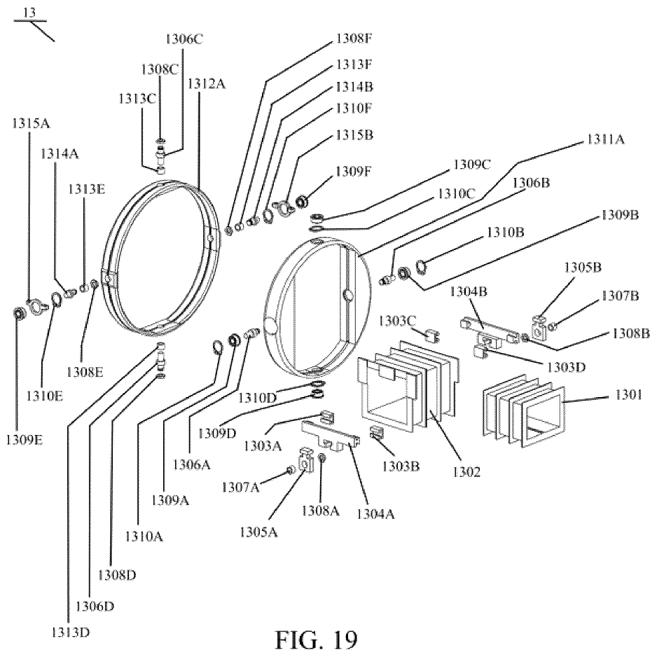

As shown in FIG. 19, the gimbal 13 consisting essentially of a frame 1301, a frame 1302, a T-shaped groove 1303A, a T-shaped groove 1303B, a T-shaped beam 1304A, a T-shaped groove 1303C, a T-shaped groove 1303D, a T-shaped beam 1304B, a [symbol] -shaped part 1305A, a shaft sleeve 1307A, a multi-diameter shaft 1306A, a hexagonal thin nut 1308A, a [symbol] -shaped part 1305B, a shaft sleeve 1307B, a multi-diameter shaft 1306B, a hexagonal thin nut 1308B, a flange bearing 1309A, a circlip for shaft 1310A, a flange bearing 1309B, a circlip for shaft 1310B, an inner ring 1311A, a flange bearing 1309C, a circlip for shaft 1310C, a flange bearing 1309D, a circlip for shaft 1310D, an outer ring 1312A, a shaft sleeve 1313C, a multi-diameter shaft 1306C, a hexagonal thin nut 1308C, a shaft sleeve 1313D, a multi-diameter shaft 1306D, a hexagonal thin nut 1308D, a shaft sleeve 1313E, a hexagonal thin nut 1308E, a multi-diameter shaft 1314A, a circlip for shaft 1310E, a diamond-shaped base 1315A, a flange bearing 1309E, a shaft sleeve 1313F, a hexagonal thin nut 1308F, a multi-diameter shaft 1314B, a circlip for shaft 1310F, a diamond-shaped base 1315B, and a flange bearing 1309F.

Designers in the field of vibration power generation can design the gimbal used in vibration power generators by simulating the gimbal used in the field of gyroscopes.

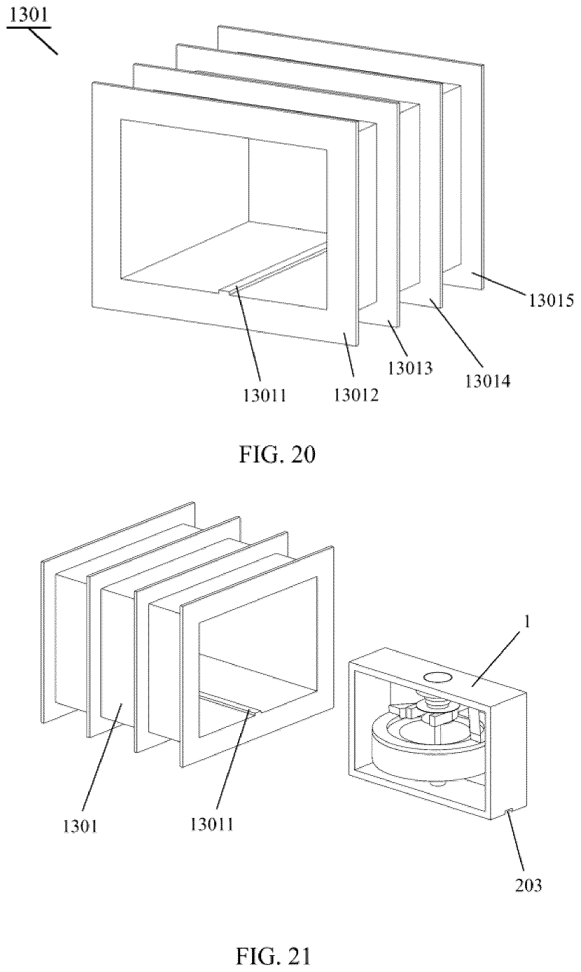

As shown in FIG. 20, the frame 1301 consisting essentially of an inner frame and slots, and is made of a plastic material selected from diamagnetic materials. The shape of the inner frame of the frame 1301 is a hollow cuboid, with the internal height of the hollow cuboid equal to the height of the vibration harvesting component 1, and the internal length of the hollow cuboid equal to the length of the vibration harvesting component 1. On the inner side of the bottom plate of the hollow cuboid, there is a track 13011 connecting the midpoints of the two open ends of the bottom plate, where the cross-section of the track 13011 is rectangular, the length of the track 13011 is the same as that of the groove 203 of the rectangular-shaped frame 2, and the width of the track 13011 is the same as that of the groove 203, allowing the groove 203 to fit perfectly into the track 13011. From left to right, surrounding the four solid faces of the hollow cuboid, there are square-shaped thin plate 13012, square-shaped thin plate 13013, square-shaped thin plate 13014, and square-shaped thin plate 13015 connected respectively, with the spacing between the four square-shaped thin plates being evenly distributed, forming three slots.

As shown in FIG. 21, the vibration harvesting component 1 is pushed into the track 13011 of the frame 1301 along the groove 203 located beneath the vibration harvesting component 1. This allows the vibration harvesting component 1 to be precisely embedded within the frame 1301. And after aligned, the seam is bonded using industrial adhesive.

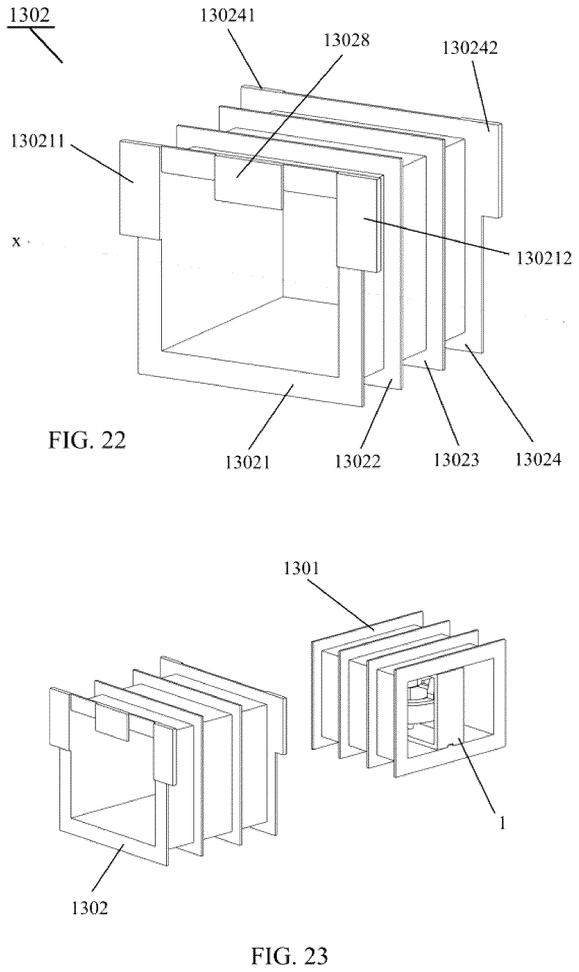

As shown in FIG. 22, the frame 1302 consisting essentially of an inner frame, slots, plates, and is made of a plastic material selected from diamagnetic materials. The shape of the inner frame of the frame 1302 is a hollow cuboid, with the internal height of the hollow cuboid equal to the height of the frame 1301, the internal width of the hollow cuboid equal to the length of the frame 1301, and the internal length of the hollow cuboid equal to the width of the frame 1301, in other words, allowing the frame 1301 to fit perfectly into the inner frame of the frame 1302, with the slots of frame 1301 and the slots of frame 1302 vertically staggered at 90° to each other. From left to right, surrounding the four solid faces of the hollow cuboid, there are square-shaped thin plate 13021, square-shaped thin plate 13022, square-shaped thin plate 13023, and square-shaped thin plate 13024 connected respectively, with the spacing between the four square-shaped thin plates being evenly distributed, forming three slots. At the opening on the front side of the hollow cuboid, on the left front side of the square-shaped thin plate 13021, the rear surface of the plate 130211 is vertically connected, the bottom surface of the plate 130211 is above the midline X, and the right side of the plate 130211 is in the same plane as the inner left side of the hollow cuboid. On the right front side of the square-shaped thin plate 13021, the rear surface of the plate 130212 is vertically connected, the bottom surface of the plate 130212 is above the midline X, and the left side of the plate 130212 is in the same plane as the inner right side of the hollow cuboid. In the middle of the front side above the square-shaped thin plate 13021, the rear surface of the plate 13028 is connected, and the plate 13028 protrudes downward to block the frame 1301. At the opening on the rear side of the hollow cuboid, on the left front side of the square-shaped thin plate 13024, the rear surface of the plate 130241 is vertically connected, the bottom surface of the plate 130241 is above the midline X, and the right side of the plate 130241 is in the same plane as the inner left side of the hollow cuboid. On the right front side of the square-shaped thin plate 13024, the rear surface of the plate 130242 is vertically connected, with the left side of the plate 130242 in the same plane as the inner right side of the hollow cuboid, and the bottom surface of the plate 130242 is above the midline X. The surface areas of the plate 130211, plate 130212, plate 130241, and plate 130242 are the same, and the midline is in the same plane.

As shown in FIG. 23, the vibration harvesting component 1 is located inside the frame 1301, and the frame 1301 is located inside the frame 1302. The dimensions of frame 1301 fit precisely with the inner frame of frame 1302, and the slots of frame 1301 and the slots of frame 1302 vertically staggered at 90° to each other, the upper part of the end embedded in frame 1302 abuts against the inner side of the plate 13028 of the frame 1302, after the frames are embedded and aligned, waiting for the subsequent process to complete the installation of the electromagnetic power generation unit components before bonding.

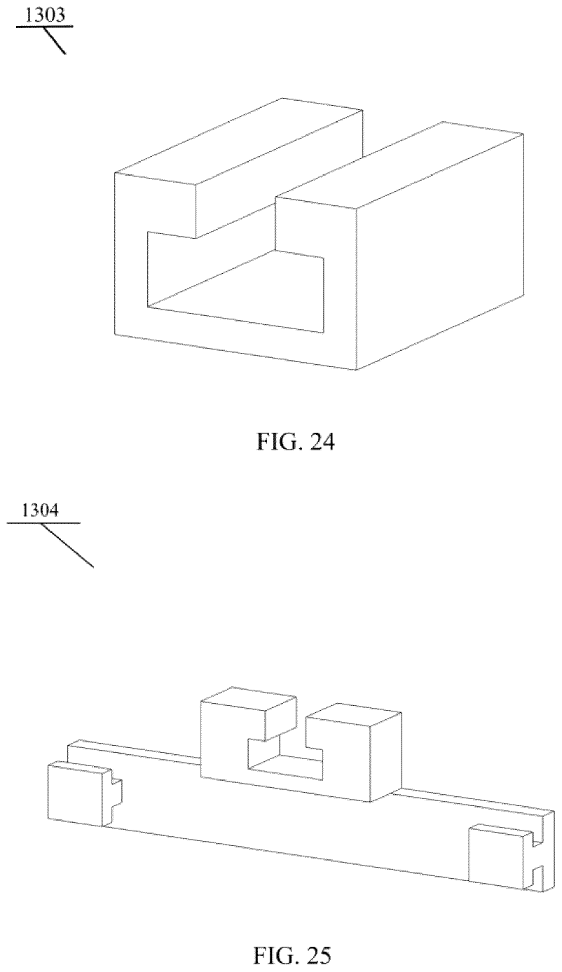

As shown in FIG. 24, the T-shaped groove 1303 is made of a plastic material selected from diamagnetic materials. It has a rectangular appearance, with the T-shaped groove extending through both the front and rear surfaces. The T-shaped groove 1303 further including: T-shaped grooves 1303A, 1303B, 1303C, and 1303D.

As shown in FIG. 25, the T-shaped beam 1304 consisting essentially of a beam, a T-shaped tenon, a T-shaped tenon, and a T-shaped groove, and is made of a plastic material selected from diamagnetic materials. The beam is a rectangular rod, with a T-shaped tenon at the left end of the inner side, where the head of the T is oriented horizontally. Similarly, there is another T-shaped tenon at the right end of the inner side, where the head of the T is oriented horizontally. The purpose of this design is twofold: firstly, it allows the T-shaped beam 1304 to move laterally along the two T-shaped grooves 1303 after assembly; secondly, it facilitates the assembly process. In the middle of the top side of the beam, there is a T-shaped groove, with the head of the T facing downward, one end of the T-shaped opening of the T-shaped groove protrudes inward, while the surface of the other end of the T-shaped opening is in the same plane as the outer surface of the beam. The T-shaped beam 1304 further including: T-shaped beams 1304A and 1304B.

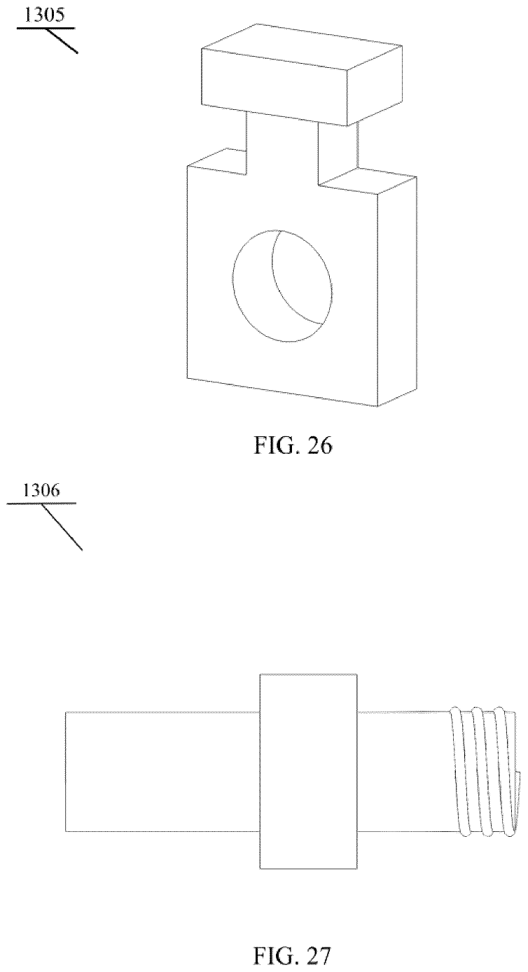

As shown in FIG. 26, the [symbol] -shaped part 1305 is made of a plastic material selected from diamagnetic materials. The upper end of the [symbol] -shaped part 1305 has a T-shaped tenon, with the head of the T facing upward. The purpose of the design of the T-shaped tenon is twofold: firstly, it allows the [symbol] -shaped part 1305 to move inward or outward along the T-shaped groove of the T-shaped beam 1304 after assembly; secondly, it facilitates the assembly process. And the lower end of the [symbol] -shaped part 1305 is a cuboid, with a through hole in the middle of the front side of the cuboid. The [symbol] -shaped part 1305 further including: [symbol] -shaped parts 1305A and 1305B.

As shown in FIG. 27, the multi-diameter shaft 1306 is made of copper material selected from diamagnetic materials. Structurally, from left to right, it consisting essentially of a shaft journal, a shaft shoulder, a spindle nose, and threads. The multi-diameter shaft 1306 further including: multi-diameter shafts 1306A, 1306B, 1306C, and 1306D.

The shaft sleeve 1307 is made of copper material selected from diamagnetic materials. The shaft sleeve 1307 further including: shaft sleeves 1307A and 1307B.

The hexagonal thin nut 1308 is made of copper material selected from diamagnetic materials. The hexagonal thin nut 1308 further including: hexagonal thin nuts 1308A, 1308B, 1308C, 1308D, 1308E, and 1308F.

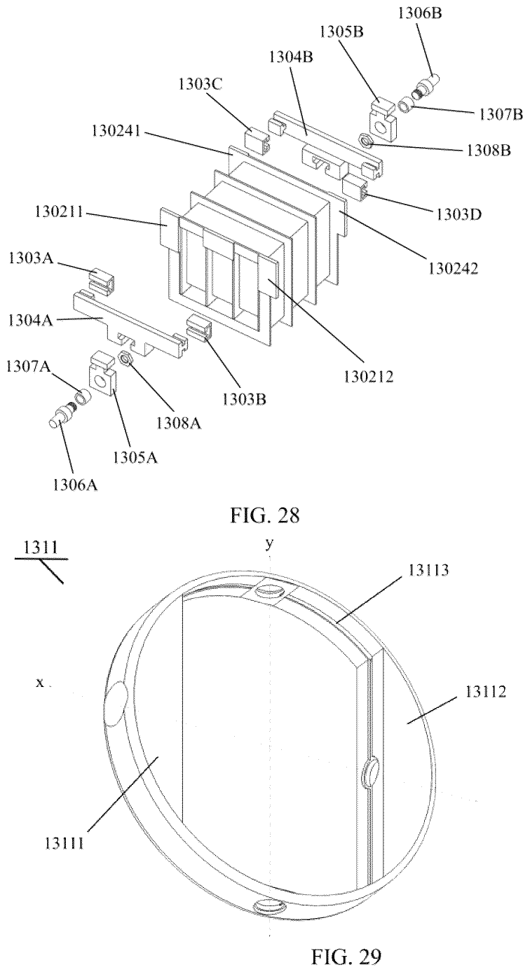

As shown in FIG. 28, the shaft sleeve 1307A is embedded into the through hole of the [symbol] -shaped part 1305A, and the spindle nose of the multi-diameter shaft 1306A passes through the through hole of the shaft sleeve 1307A. The hexagonal thin nut 1308A is threaded onto the multi-diameter shaft 1306A for fastening. The hexagonal thin nut 1308A is reserved for use as a terminal.

The shaft sleeve 1307B is embedded into the through hole of the [symbol] -shaped part 1305B, and the spindle nose of the multi-diameter shaft 1306B passes through the through hole of the shaft sleeve 1307B. The hexagonal thin nut 1308B is threaded onto the multi-diameter shaft 1306B for fastening. The hexagonal thin nut 1308B is reserved for use as a terminal.

Insert the T-shaped tenon at the left end of the T-shaped beam 1304A into the T-shaped groove 1303A, and insert the T-shaped tenon at the right end of the T-shaped beam 1304A into the other T-shaped groove 1303B. The T-shaped tenon of the [symbol] -shaped part 1305A is inserted into the T-shaped groove of the T-shaped beam 1304A, with the shaft journal of the multi-diameter shaft 1306A facing outward. The back of the T-shaped groove 1303A is bonded to the front of the plate 130211, and the back of the T-shaped groove 1303B is bonded to the front of the plate 130212.

Insert the T-shaped tenon at the left end of the T-shaped beam 1304B into the T-shaped groove 1303C, and insert the T-shaped tenon at the right end of the T-shaped beam 1304B into the other T-shaped groove 1303D. The T-shaped tenon of the [symbol] -shaped part 1305B is inserted into the T-shaped groove of the T-shaped beam 1304B, with the shaft journal of the multi-diameter shaft 1306B facing outward. The back of the T-shaped groove 1303C is bonded to the front of the plate 130241, and the back of the T-shaped groove 1303D is bonded to the front of the plate 130242.

The method of movable connection between the components serves two main purposes: firstly, it facilitates assembly; secondly, it allows for the adjustment of the system's center of gravity along the X and Y axes of the three-dimensional coordinate system. The specific usage method will be detailed during the assembly and debugging phase of the vibration harvesting device.

The flange bearing 1309, after considering the radial and lateral loads it needs to withstand, can be selected as a demagnetized deep groove ball bearing. It is confirmed that the entire bearing is conductive, meaning that electrical conductivity exists between the inner ring and outer ring of the bearing. The flange bearing 1309 further including: flange bearings 1309A, 1309B, 1309C, 1309D, 1309E, and 1309F.

The circlip for shaft 1310 is made of stainless steel and has undergone demagnetization treatment. The circlip for shaft 1310 further including: circlips for shaft 1310A, 1310B, 1310C, 1310D, 1310E, and 1310F.

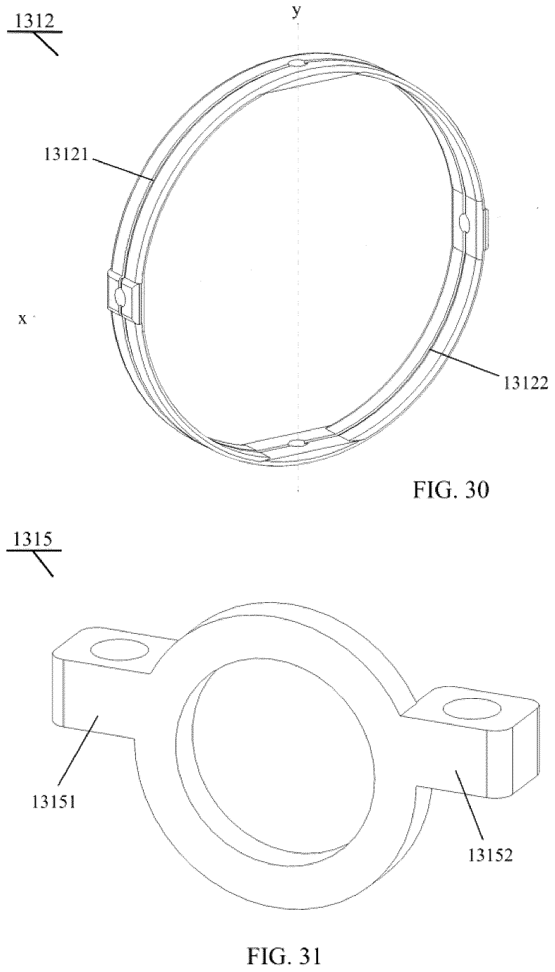

As shown in FIG. 29, the inner ring 1311 is made of a plastic material selected from diamagnetic materials. For convenience of explanation, the center of the inner ring 1311 is taken as the midpoint, and centerlines x and y are drawn.

The inner ring 1311 is annular in shape, with a reinforcing block 13111 at the left end of the inner side and another reinforcing block 13112 at the right end of the inner side. The left end of the outer side of the inner ring 1311 has a counterbore and a through hole, and the inner side of the reinforcing block 13111 has a counterbore. The right end of the outer side of the inner ring 1311 also has a counterbore and a through hole, with the inner side of the reinforcing block 13112 having a counterbore, the centerline x passes through the centers of the counterbores and through hole at the left end and the centers of the counterbores and through hole at the right end. The upper end of the outer side of the inner ring 1311 has a counterbore and a through hole, while the lower end of the outer side has a counterbore and a through hole, with the centerline y passing through the centers of the counterbore and through hole at the upper end and the centers of the counterbore and through hole at the lower end. Surrounding the inner side of the inner ring 1311 in the middle, there is a wire groove 13113. The inner ring 1311 further including: inner ring 1311A, with the specific structural designation following the main body's numbering convention, where the suffix letter corresponds to the main body's suffix letter.

As shown in FIG. 19, the shaft journal of multi-diameter shaft 1306A is inserted into the hole of flange bearing 1309A, which is installed in the left side through hole of inner ring 1311A, the flange of flange bearing 1309A abuts against the inner side of the counterbore of reinforcing block 13111A, and the circlip for shaft 1310A secures the other end of flange bearing 1309A for fastening, with the flange of flange bearing 1309A reserved for use as a terminal.

Likewise, the shaft journal of multi-diameter shaft 1306B is inserted into the hole of flange bearing 1309B, which is installed in the right side through hole of inner ring 1311A, the flange of flange bearing 1309B abuts against the inner side of the counterbore of reinforcing block 13112A, and the circlip for shaft 1310B secures the other end of flange bearing 1309B for fastening, with the flange of flange bearing 1309B reserved for use as a terminal,

The shaft journal of multi-diameter shaft 1306C is inserted into the hole of flange bearing 1309C, which is installed in the upper side through hole of inner ring 1311A, the flange of flange bearing 1309C abuts against the upper side counterbore of inner ring 1311A, and the circlip for shaft 1310C secures the other end of flange bearing 1309C for fastening, with the circlip for shaft 1310C reserved for use as a terminal.

The shaft journal of multi-diameter shaft 1306D is inserted into the hole of flange bearing 1309D, which is installed in the lower side through hole of inner ring 1311A, the flange of flange bearing 1309D abuts against the lower side counterbore of inner ring 1311A, and the circlip for shaft 1310D secures the other end of flange bearing 1309D for fastening, with the circlip for shaft 1310D reserved for use as a terminal.

As shown in FIG. 30, the outer ring 1312 is made of a plastic material selected from diamagnetic materials. For convenience of explanation, the center of the outer ring 1312 is taken as the midpoint, and centerlines x and y are drawn. The outer ring 1312 is annular in shape, with a through hole at the upper end of the inner side and another through hole at the lower end of the inner side, with the centerline y passing through the centers of the upper and lower through holes. The left end of the outer side of the outer ring 1312 has a through hole, and the right end of the outer side also has a through hole, with the centerline x passing through the centers of the left and right through holes. Surrounding the outer side of the outer ring 1312 in the middle, there is a wire groove 13121, and surrounding the inner side of the outer ring 1312 in the middle, there is another wire groove 13122. The outer ring 1312 further including: outer ring 1312A, with the specific structural designation following the main body's numbering convention, where the suffix letter corresponds to the main body's suffix letter.

The shaft sleeve 1313 is made of copper material selected from diamagnetic materials. Compared to the shaft sleeve 1307, the structure of shaft sleeve 1313 is the same, but the dimensions differ. The shaft sleeve 1313 further including: shaft sleeves 1313C, 1313D, 1313E, and 1313F.

As shown in FIG. 19, the shaft sleeve 1313C is embedded in the upper through hole of the outer ring 1312A, and the spindle nose of the multi-diameter shaft 1306C passes through the through hole of the shaft sleeve 1313C, the hexagonal thin nut 1308C is screwed onto the thread of the multi-diameter shaft 1306C for fastening, with hexagonal thin nut 1308C reserved for use as a terminal.

The shaft sleeve 1313D is embedded in the lower through hole of the outer ring 1312A, and the spindle nose of the multi-diameter shaft 1306D passes through the through hole of the shaft sleeve 1313D, the hexagonal thin nut 1308D is screwed onto the thread of the multi-diameter shaft 1306D for fastening, with hexagonal thin nut 1308D reserved for use as a terminal.

The multi-diameter shaft 1314 is made of copper material selected from diamagnetic materials. Its structure is the same as the multi-diameter shaft 1306, but the dimensions differ. The multi-diameter shaft 1314 further including: multi-diameter shafts 1314A and 1314B.

The shaft sleeve 1313E is embedded in the left side through hole of the outer ring 1312A, and the spindle nose of the multi-diameter shaft 1314A passes through the through hole of the shaft sleeve 1313E, the hexagonal thin nut 1308E is screwed onto the thread of the multi-diameter shaft 1314A for fastening, with hexagonal thin nut 1308E reserved for use as a terminal.

The shaft sleeve 1313F is embedded in the right side through hole of the outer ring 1312A, and the spindle nose of the multi-diameter shaft 1314B passes through the through hole of the shaft sleeve 1313F, the hexagonal thin nut 1308F is screwed onto the thread of the multi-diameter shaft 1314B for fastening, with hexagonal thin nut 1308F reserved for use as a terminal.

As shown in FIG. 31, the diamond-shaped base 1315 is made of a plastic material selected from diamagnetic materials. The main body is annular in shape, with a through hole at the center, the left side of the main body is connected to the right side of the foot 13151, which has a through hole on its upper surface; and the right side of the main body is connected to the left side of the foot 13152, which also has a through hole on its upper surface. The diamond-shaped base 1315 further including: diamond-shaped bases 1315A and 1315B, with the specific structural designation following the main body's numbering convention, where the suffix letter corresponds to the main body's suffix letter.

As shown in FIG. 19, the flange bearing 1309E is installed in the main through hole of the diamond-shaped base 1315A, with the flange clamped against the outer edge of the main through hole, the shaft journal of multi-diameter shaft 1314A is inserted into the hole of the flange bearing 1309E, and the circlip for shaft 1310E secures the other end of the flange bearing 1309E for fastening, with the flange of the flange bearing 1309E reserved for use as a terminal.

The flange bearing 1309F is installed in the main through hole of the diamond-shaped base 1315B, with the flange clamped against the outer edge of the main through hole, the shaft journal of multi-diameter shaft 1314B is inserted into the hole of the flange bearing 1309F, and the circlip for shaft 1310F secures the other end of the flange bearing 1309F for fastening, with the flange of the flange bearing 1309F reserved for use as a terminal.

After the vibration harvesting device is assembled, the system's center of gravity needs to be debugged due to the reasons of mass imbalance, assembly errors and the like of components. This involves making adjustments along the three-dimensional coordinate axes: X, Y, and Z. In this context, the X and Y axes are taken as mutually perpendicular horizontal directions, while the Z axis is aligned with the direction of the gravitational vertical.

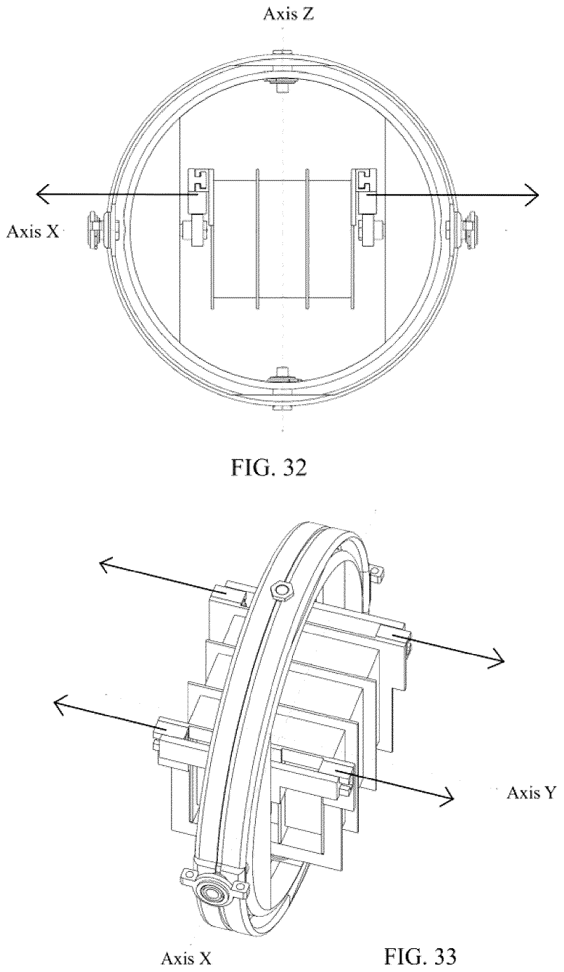

As shown in FIG. 32, the diamond-shaped base 1315A and diamond-shaped base 1315B of the vibration harvesting device are installed horizontally on the test bench, using the upper end of the frame 1302 as a reference for levelness. In the X-axis direction, the T-shaped tenon of [symbol] -shaped part 1305A is moved left and right within the T-shaped groove of T-shaped beam 1304A, while the T-shaped tenon of [symbol] -shaped part 1305B is moved left and right within the T-shaped groove of T-shaped beam 1304B.

As shown in FIG. 33, in the Y-axis direction, the T-shaped tenons at the left and right ends of T-shaped beam 1304A are moved in and out of the T-shaped groove 1303A and T-shaped groove 1303B, meanwhile the T-shaped tenons at the left and right ends of T-shaped beam 1304B are moved in and out of the T-shaped groove 1303C and T-shaped groove 1303D. In the Z-axis direction, since the system's center of gravity is located below the line connecting the multi-diameter shaft 1306A and multi-diameter shaft 1306B, the rigid body can self-adjust regardless of how it is rotated, keeping the underside of frame 1302 facing downward. Once the system's center of gravity adjustment is completed, the aforementioned movable components are not fixed with industrial adhesive for the time being; they will be secured after the installation of the power generation unit components is completed.

### III. Vibration Harvesting Device Used in Composite Vibration Power Generator

Compared with the vibration harvesting device used in electromagnetic vibration power generator, the vibration harvesting device used in composite vibration power generator utilizes more diversity of feedback action types generated after vibration harvesting. For example, this including the swinging motion of an object around axes caused by moment of inertia; impact actions generated between objects; friction between objects; and the rotational motion around axes between the inner and outer rings, etc.

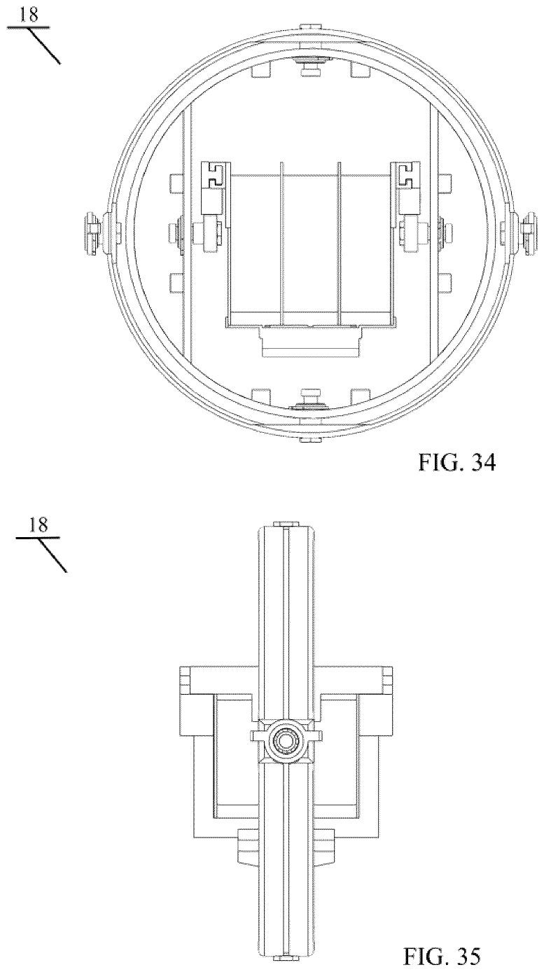

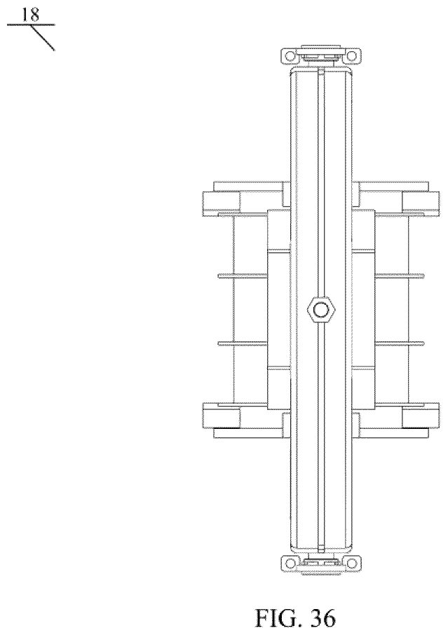

As shown in FIGS. 34, 35, 36, and 37, the vibration harvesting device used in composite vibration power generator 18 comprising a vibration harvesting component 1 and a gimbal 19.

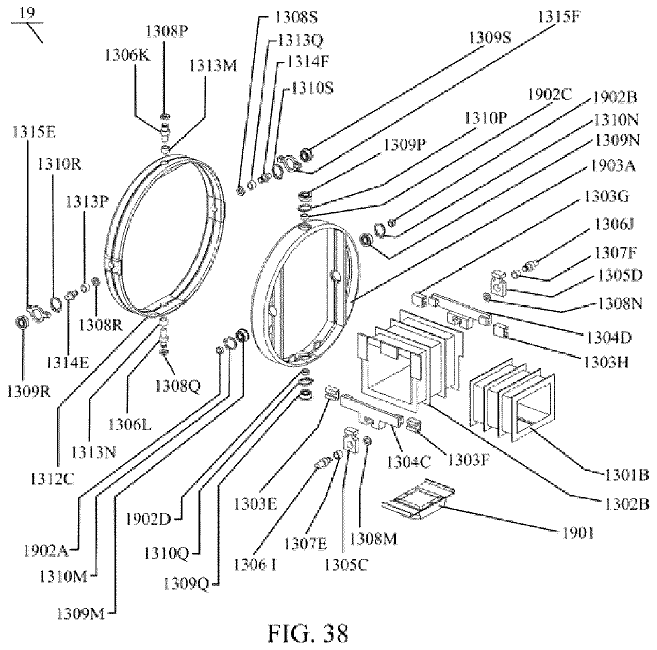

As shown in FIG. 38, the gimbal 19 consisting essentially of a frame 1301B, a frame 1302B, a piezoelectric and friction power generation subassembly 1901, a T-shaped groove 1303E, a T-shaped groove 1303F, a T-shaped beam 1304C, a T-shaped groove 1303G, a T-shaped groove 1303H, a T-shaped beam 1304D, a [symbol] -shaped part 1305C, a multi-diameter shaft 1306I, a shaft sleeve 1307E, a hexagonal thin nut 1308M, a hose 1902A, a [symbol] -shaped part 1305D, a multi-diameter shaft 1306J, a shaft sleeve 1307F, a hexagonal thin nut 1308N, a hose 1902B, an inner ring 1903A, a flange bearing 1309M, a circlip for shaft 1310M, a flange bearing 1309N, a circlip for shaft 1310N, an outer ring 1312C, a shaft sleeve 1313M, a multi-diameter shaft 1306K, a hexagonal thin nut 1308P, a flange bearing 1309P, a circlip for shaft 1310P, a hose 1902C, a shaft sleeve 1313N, a multi-diameter shaft 1306L, a hexagonal thin nut 1308Q, a flange bearing 1309Q, a circlip for shaft 1310Q, a hose 1902D, a shaft sleeve 1313P, a hexagonal thin nut 1308R, a multi-diameter shaft 1314E, a circlip for shaft 1310R, a diamond-shaped base 1315E, a flange bearing 1309R, a shaft sleeve 1313Q, a hexagonal thin nut 1308S, a multi-diameter shaft 1314F, a circlip for shaft 1310S, a diamond-shaped base 1315F, and a flange bearing 1309S.

Designers in the field of vibration power generation can design the gimbal used in vibration power generators by simulating the gimbal used in the field of gyroscopes.

The gimbal 19 of the vibration harvesting device used in composite vibration power generator 18 differs from the gimbal 13 of the vibration harvesting device used in electromagnetic vibration power generator 12 in that it including an inner ring 1903, a piezoelectric and friction power generation subassembly 1901, and hose 1902.

The components have identical parts, among which the frame 1301 further including: a frame 1301B, with the specific structural designation following the main body's numbering convention, where the suffix letter corresponds to the main body's suffix letter.

The frame 1302 further including: a frame 1302B, with the specific structural designation following the main body's numbering convention, where the suffix letter corresponds to the main body's suffix letter. The middle section of the front surface of the lower side of the square-shaped thin plate 13021 of the frame 1302 can also serve as a bonding area, and the middle section of the front surface of the lower side of the square-shaped thin plate 13024 can also serve as a bonding area, which is used for bonding the piezoelectric and friction power generation subassembly 1901.

The T-shaped groove 1303 further including: T-shaped grooves 1303E, 1303F, 1303G, and 1303H.

The T-shaped beam 1304 further including: T-shaped beams 1304C and 1304D.

The [symbol] -shaped part 1305 further including: [symbol] -shaped parts 1305C and 1305D.

The multi-diameter shaft 1306 further including: multi-diameter shafts 1306I, 1306J, 1306K, and 1306L.

The shaft sleeve 1307 further including: shaft sleeves 1307E and 1307F.

The hexagonal thin nut 1308 further including: hexagonal thin nuts 1308M, 1308N, 1308P, 1308Q, 1308R, and 1308S.

The flange bearing 1309 further including: flange bearings 1309M, 1309N, 1309P, 1309Q, 1309R, and 1309S.

The circlip for shaft 1310 further including: circlips for shaft 1310M, 1310N, 1310P, 1310Q, 1310R, and 1310S.

The outer ring 1312 further including: an outer ring 1312C, with the specific structural designation following the main body's numbering convention, where the suffix letter corresponds to the main body's suffix letter.

The shaft sleeve 1313 further including: shaft sleeves 1313M, 1313N, 1313P, and 1313Q.

The multi-diameter shaft 1314 further including: multi-diameter shafts 1314E and 1314F.

The diamond-shaped base 1315 further including: diamond-shaped bases 1315E and 1315F.

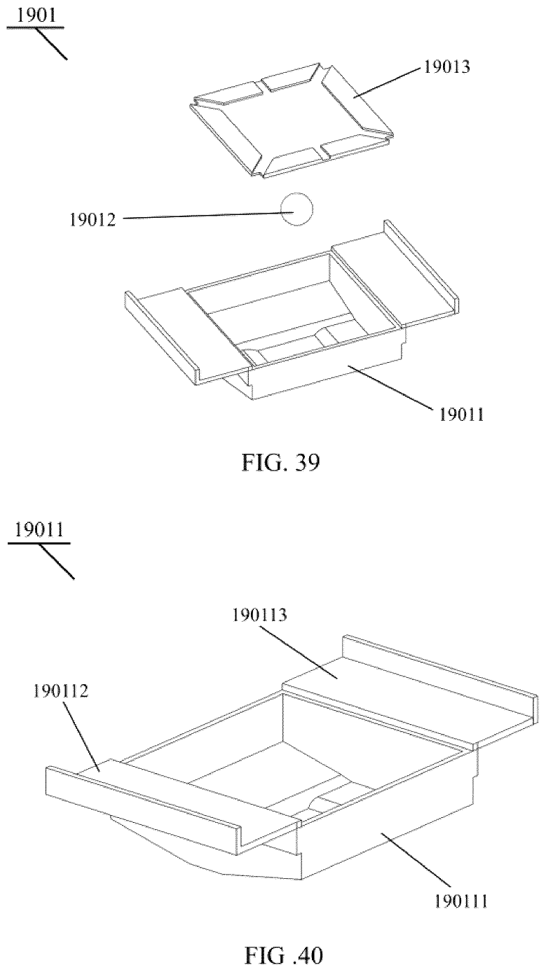

As shown in FIG. 39, the piezoelectric and friction power generation subassembly 1901 consisting essentially of a frame 19011, a ball 19012, and a top cover 19013.

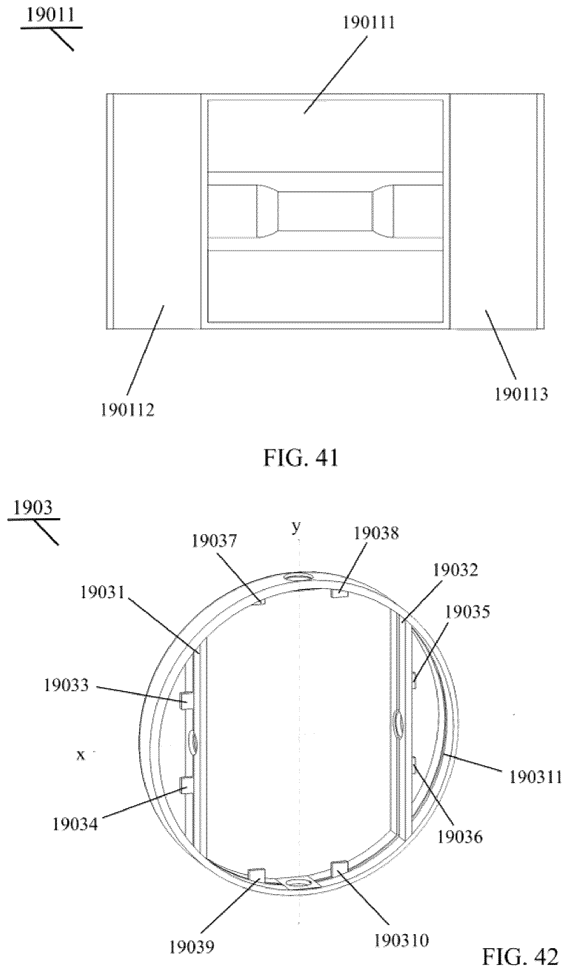

As shown in FIGS. 40 and 41, the frame 19011 consisting essentially of a hull-shaped base 190111, a [symbol] -shaped plate 190112, and a [symbol] -shaped plate 190113, which is made of a plastic material selected from diamagnetic materials. The hull-shaped base 190111 has an upper part formed by four plate members enclosing a square opening, and a lower part shaped like a hull, with a rectangular shallow groove located in the middle of the bottom of the hull shape. The upper surface of the left plate of the square opening is connected to the lower surface of the [symbol] -shaped plate 190112, and the upper surface of the right plate of the square opening is connected to the lower surface of the [symbol] -shaped plate 190113.

The ball 19012 is made of polyamide selected from diamagnetic materials. Designers in this field may select higher-mass materials to increase inertia. The ball 19012 is placed within the hull-shaped base 190111, where the ball 19012 automatically enters the rectangular shallow groove.

The top cover 19013 is a square plate made of a plastic material selected from diamagnetic materials, with dimensions that fit precisely over the upper end of the hull-shaped base 190111. The top cover 19013 has square holes at each of its four corners for wire passage. And the outer edge of the upper surface of the top cover 19013 has a [symbol] -shaped groove in the center for wire placement. The top cover 19013 is temporarily not bonded or fixed, awaiting the installation of the piezoelectric ceramic power generation unit and the triboelectric nano power generation unit before being secured.

The vertical inner side of the [symbol] -shaped plate 190112 of the piezoelectric and friction power generation subassembly 1901 is fitted to the bonding area of the square-shaped thin plate 13021B of the frame 1302B, but bonding is temporarily not performed. The vertical inner side of the [symbol] -shaped plate 190113 is fitted to the bonding area of the square-shaped thin plate 13024B of the frame 1302B, but bonding is temporarily not performed, waiting for the installation of the piezoelectric ceramic power generation unit and the triboelectric nano power generation unit to be completed before bonding.

The main function of piezoelectric and friction power generation subassembly 1901 is to capture the impact actions generated between objects, as well as the friction between the objects.

As shown in FIG. 42, the inner ring 1903 is made of a plastic material selected from diamagnetic materials. For the sake of convenience in explanation, the center of the inner ring 1903 is the midpoint, and the centerlines x and y are drawn. The inner ring 1903 is in a circular ring shape, the left end of the inner side of the inner ring 1903 has a connecting frame 19031, and the right end of the inner side of the inner ring 1903 has a connecting frame 19032, the right side of the connecting frame 19031 is parallel to the left side of the connecting frame 19032 along the centerline y. The right side of the connecting frame 19031 has a counterbore and a through hole, the left side of the connecting frame 19032 has a counterbore and a through hole. The centerline x passes through the center of the through hole and the counterbore of the connecting frame 19031, and the centerline x passes through the center of the through hole and the counterbore of the connecting frame 19032. The right surface of the plate 19033 is connected above the left side of the connecting frame 19031; the right surface of the plate 19034 is connected below the left side of the connecting frame 19031, the plate 19033 and plate 19034 are symmetrical with respect to the centerline x. The left surface of the plate 19035 is connected above the right side of the connecting frame 19032; the left surface of the plate 19036 is connected below the right side of the connecting frame 19032, the plate 19035 and plate 19036 are symmetrical with respect to the centerline x. The upper surface of the plate 19037 is connected to the inner side of the inner ring 1903, to the left of the through hole at the upper end of the inner ring 1903. The upper surface of the plate 19038 is connected to the inner side of the inner ring 1903, to the right of the through hole at the upper end of the inner ring 1903, the plate 19037 and plate 19038 are symmetrical with respect to the centerline y. The lower surface of the plate 19039 is connected to the inner side of the inner ring 1903, to the left of the through hole at the lower end of the inner ring 1903. The lower surface of the plate 190310 is connected to the inner side of the inner ring 1903, to the right of the through hole at the lower end of the inner ring 1903, the plate 19039 and plate 190310 are symmetrical with respect to the centerline y. Around the inner side of the inner ring 1903, in the middle between the two sides of the connecting frame 19031, and in the middle between the two sides of the connecting frame 19032, there is a wire groove 190311. The inner ring 1903 further including: inner ring 1903A, with the specific structural designation following the main body's numbering convention, where the suffix letter corresponds to the main body's suffix letter.

The hose 1902 is made of silicone rubber selected from diamagnetic materials for transmission. Designers in this field may also use other known components for transmission. The hose 1902 further including: hoses 1902A, 1902B, 1902C, and 1902D.

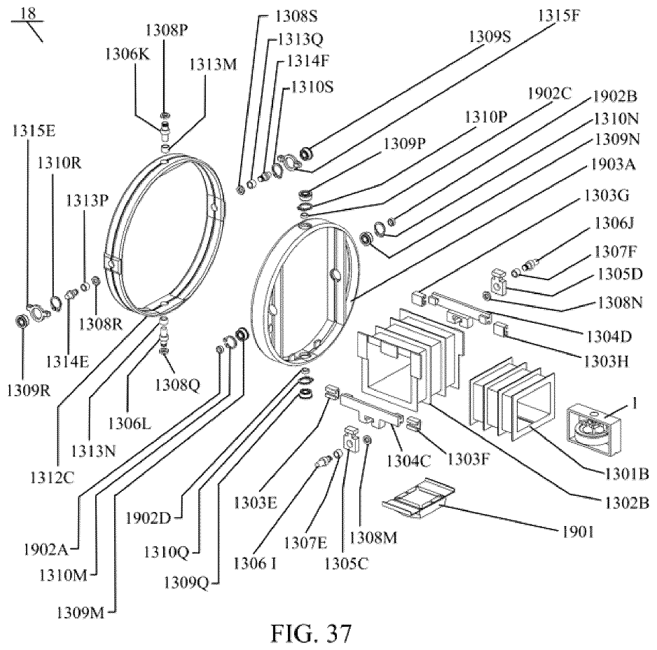

As shown in FIG. 37, along the groove 203 beneath the vibration harvesting component 1, the vibration harvesting component 1 is pushed into the track 13011B of the frame 1301B, ensuring that the vibration harvesting component embedded in the frame 1301B. After alignment, bonded the seam with industrial adhesive.

The vibration harvesting component 1 is located inside the frame 1301B, and the frame 1301B is located inside the frame 1302B. The dimensions of frame 1301B fit precisely with the inner frame of frame 1302B, and the slots of frame 1301B and the slots of frame 1302B vertically staggered at 90° to each other, after the frames are embedded and aligned, waiting for the subsequent process to complete the installation of the electromagnetic power generation unit components before bonding.

The shaft sleeve 1307E is embedded in the through hole of [symbol] -shaped part 1305C, and the spindle nose of multi-diameter shaft 1306I passes through the through hole of shaft sleeve 1307E, the hexagonal thin nut 1308M is screwed onto the thread of multi-diameter shaft 1306I for fastening, with hexagonal thin nut 1308M reserved for use as a terminal.

The shaft sleeve 1307F is embedded in the through hole of [symbol] -shaped part 1305D, and the spindle nose of multi-diameter shaft 1306J passes through the through hole of shaft sleeve 1307F, the hexagonal thin nut 1308N is screwed onto the thread of multi-diameter shaft 1306J for fastening, with hexagonal thin nut 1308N reserved for use as a terminal.

The T-shaped tenon at the left end of T-shaped beam 1304C is inserted into the T-shaped groove 1303E, and the T-shaped tenon at the right end of T-shaped beam 1304C is inserted into the T-shaped groove 1303F. The tenon of [symbol] -shaped part 1305C is inserted into the T-shaped groove of T-shaped beam 1304C, with the shaft journal of the multi-diameter shaft 1306I facing towards. The back of T-shaped groove 1303E is bonded to the front of plate 130211B, and the back of T-shaped groove 1303F is bonded to the front of plate 130212B.

The T-shaped tenon at the left end of T-shaped beam 1304D is inserted into the T-shaped groove 1303G, and the T-shaped tenon at the right end of T-shaped beam 1304D is inserted into the T-shaped groove 1303H. The tenon of [symbol] -shaped part 1305D is inserted into the T-shaped groove of T-shaped beam 1304D, with the shaft journal of the multi-diameter shaft 1306J facing towards. The back of T-shaped groove 1303G is bonded to the front of plate 130241B, and the back of T-shaped groove 1303H is bonded to the front of plate 130242B.

The shaft journal of multi-diameter shaft 1306I is inserted into the hole of flange bearing 1309M, which is installed in the through hole of the connecting frame 19031A, the flange of flange bearing 1309M abuts against the inner side of the counterbore of the connecting frame 19031A, and the circlip for shaft 1310M secures the other end of flange bearing 1309M for fastening, with the flange of flange bearing 1309M and the circlip for shaft 1310M are reserved for use as terminals.

Similarly, the shaft journal of multi-diameter shaft 1306J is inserted into the hole of flange bearing 1309N, which is installed in the right side through hole of the connecting frame 19032A, the flange of flange bearing 1309N abuts against the inner side of the counterbore of the connecting frame 19032A, and the circlip for shaft 1310N secures the other end of flange bearing 1309N for fastening, with the flange of flange bearing 1309N and the circlip for shaft 1310N are reserved for use as terminals.

The hose 1902A is sleeved on the shaft journal of the multi-diameter shaft 1306I, with the joint bonded for transmission.

The hose 1902B is sleeved on the shaft journal of the multi-diameter shaft 1306J, with the joint bonded for transmission.

The shaft sleeve 1313M is embedded in the upper through hole of the outer ring 1312C, and the spindle nose of the multi-diameter shaft 1306K passes through the through hole of the shaft sleeve 1313M, the hexagonal thin nut 1308P is screwed onto the thread of the multi-diameter shaft 1306K for fastening, with hexagonal thin nut 1308P reserved for use as a terminal.

The shaft sleeve 1313N is embedded in the lower through hole of the outer ring 1312C, and the spindle nose of the multi-diameter shaft 1306L passes through the through hole of the shaft sleeve 1313N, the hexagonal thin nut 1308Q is screwed onto the thread of the multi-diameter shaft 1306L for fastening, with hexagonal thin nut 1308Q reserved for use as a terminal.

The shaft journal of multi-diameter shaft 1306K is inserted into the hole of flange bearing 1309P, which is installed in the upper side through hole of inner ring 1903A, the flange of flange bearing 1309P abuts against the upper side counterbore of inner ring 1903A, and the circlip for shaft 1310P secures the other end of flange bearing 1309P for fastening, with the circlip for shaft 1310P reserved for use as a terminal.

The shaft journal of multi-diameter shaft 1306L is inserted into the hole of flange bearing 1309Q, which is installed in the lower side through hole of inner ring 1903A, the flange of flange bearing 1309Q abuts against the lower side counterbore of inner ring 1903A, and the circlip for shaft 1310Q secures the other end of flange bearing 1309Q for fastening, with the circlip for shaft 1310Q reserved for use as a terminal.

The hose 1902C is sleeved on the shaft journal of the multi-diameter shaft 1306K, with the joint bonded for transmission.

The hose 1902D is sleeved on the shaft journal of the multi-diameter shaft 1306L, with the joint bonded for transmission.

The shaft sleeve 1313P is embedded in the left side through hole of the outer ring 1312C, and the spindle nose of the multi-diameter shaft 1314E passes through the through hole of the shaft sleeve 1313P, the hexagonal thin nut 1308R is screwed onto the thread of the multi-diameter shaft 1314E for fastening, with hexagonal thin nut 1308R reserved for use as a terminal.

The shaft sleeve 1313Q is embedded in the right side through hole of the outer ring 1312C, and the spindle nose of the multi-diameter shaft 1314F passes through the through hole of the shaft sleeve 1313Q, the hexagonal thin nut 1308S is screwed onto the thread of the multi-diameter shaft 1314F for fastening, with hexagonal thin nut 1308S reserved for use as a terminal.

The flange bearing 1309R is installed in the main through hole of the diamond-shaped base 1315E, with the flange clamped against the outer edge of the main through hole, the shaft journal of multi-diameter shaft 1314E is inserted into the hole of the flange bearing 1309R, and the circlip for shaft 1310R secures the other end of the flange bearing 1309R for fastening, with the flange of the flange bearing 1309R reserved for use as a terminal.

The flange bearing 1309S is installed in the main through hole of the diamond-shaped base 1315F, with the flange clamped against the outer edge of the main through hole, the shaft journal of multi-diameter shaft 1314F is inserted into the hole of the flange bearing 1309S, and the circlip for shaft 1310S secures the other end of the flange bearing 1309S for fastening, with the flange of the flange bearing 1309S reserved for use as a terminal.

After the vibration harvesting device is assembled, the system's center of gravity needs to be debugged due to the reasons of mass imbalance, assembly errors and the like of components. This involves making adjustments along the three-dimensional coordinate axes: X, Y, and Z. In this context, the X and Y axes are taken as mutually perpendicular horizontal directions, while the Z axis is aligned with the direction of the gravitational vertical.

Similar to the debugging method used for the vibration harvesting device used in electromagnetic vibration power generator 12. The diamond-shaped base 1315E and diamond-shaped base 1315F of the vibration harvesting device are installed horizontally on the test bench, using the upper end of the frame 1302B as a reference for levelness. In the X-axis direction, the T-shaped tenon of [symbol] -shaped part 1305C is moved left and right within the T-shaped groove of T-shaped beam 1304C, while the T-shaped tenon of [symbol] -shaped part 1305D is moved left and right within the T-shaped groove of T-shaped beam 1304D.

In the Y-axis direction, the T-shaped tenons at the left and right ends of T-shaped beam 1304C are moved in and out of the T-shaped groove 1303E and T-shaped groove 1303F, meanwhile the T-shaped tenons at the left and right ends of T-shaped beam 1304D are moved in and out of the T-shaped groove 1303G and T-shaped groove 1303H. In the Z-axis direction, since the system's center of gravity is located below the line connecting the multi-diameter shaft 1306I and multi-diameter 1306J, the rigid body can self-adjust regardless of how it is rotated, keeping the underside of frame 1302B facing downward. Once the system's center of gravity adjustment is completed, the aforementioned movable components are not fixed with industrial adhesive for the time being; they will be secured after the installation of the power generation unit components is completed.

After the assembly of the vibration harvesting device used in composite vibration power generator 18 is completed, the entire harvesting device exhibits various types of feedback actions upon capturing vibrations. Firstly, in addition to the harvesting feedback from the vibration harvesting component 1 itself, the rigid body connected to the multi-diameter shaft 1306I and multi-diameter shaft 1306J has moment of inertia. The swinging or rotational motion of the rigid body around the multi-diameter shafts causes the ball 19012 to generate rolling and impact actions, which are then transmitted to the power generation unit that utilizes impact actions for power generation. The rolling motion of the ball 19012 also results in rolling friction with the triboelectric nano power generation unit. During this process, the concave bottom of the hull-shaped base 190111 of the frame 19011 forces the ball 19012 to return to its original position, ensuring that its repositioning does not affect the system's center of gravity. Secondly, when the rigid body rotates around the multi-diameter shaft 1306I and multi-diameter shaft 1306J, the rotational motion of the shafts is transmitted to the power generation unit that utilizes rotational energy through hose 1902A and hose 1902B. Thirdly, the rotation between the inner ring 1903A and the outer ring 1312C transmits the rotational motion of the multi-diameter shaft 1306K and multi-diameter shaft 1306L to the power generation units that utilizes rotational energy through hose 1902C and hose 1902D. Fourthly, if there are no volume constraints, designers in this field can also utilize the rotational motion between the outer ring 1312C and the diamond-shaped base 1315E and diamond-shaped base 1315F, arranging additional hoses for transmission to convey the rotational motion of the multi-diameter shaft 1314E and multi-diameter shaft 1314F to additional power generation units that utilize rotational energy.

### IV. Electromagnetic Vibration Power Generator

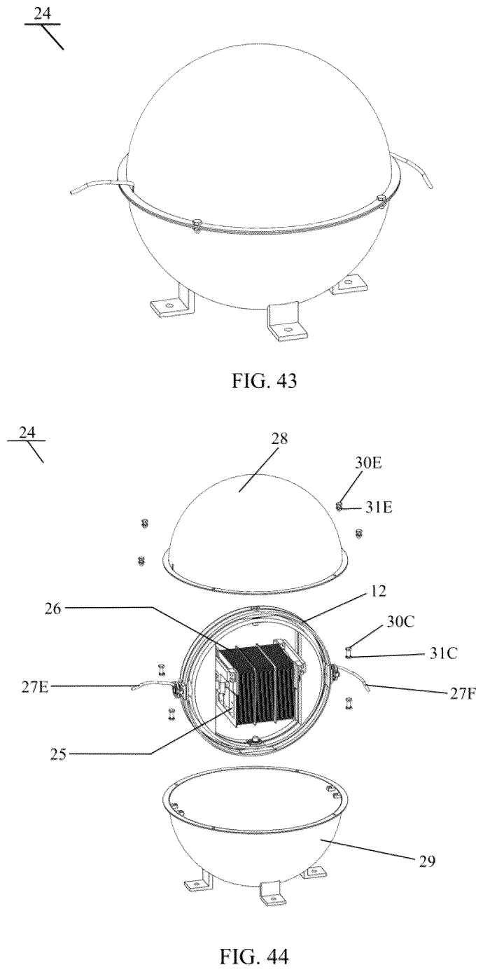

As shown in FIGS. 43 and 44, the electromagnetic vibration power generator 24 comprising a vibration harvesting device used in electromagnetic vibration power generator 12, windings 25, windings 26, insulated wire 27, an upper hemispherical shell 28, a lower hemispherical shell 29, bolt 30, and nut 31.

The electromagnetic vibration power generator 24 is assembled by adding the aforementioned components to the vibration harvesting device used in electromagnetic vibration power generator 12. Since there is some repetition in the content, this embodiment will focus on the added components and their connection methods. For repeated content, please refer to the vibration harvesting device used in electromagnetic vibration power generator 12.

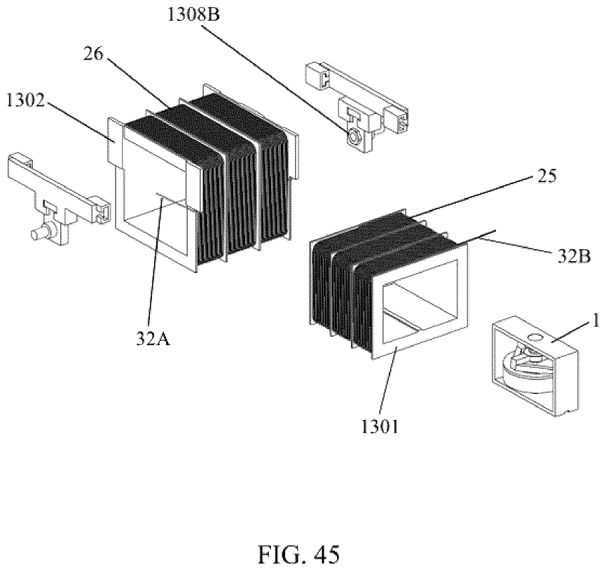

As shown in FIG. 45, the enameled wire is wound clockwise in three slots of the frame 1301 to form three coils, which are connected in series to form the windings 25.

Along the groove 203 that beneath the vibration harvesting component 1, the vibration harvesting component is pushed into the track 13011 of the frame 1301, ensuring that the vibration harvesting component 1 is precisely embedded within the frame 1301. After alignment, the seams are bonded with industrial adhesive.

The enameled wire is wound clockwise in three slots on the frame 1302 to form three coils, which are connected in series to form the windings 26.

The vibration harvesting component 1 is located inside the frame 1301, and the frame 1301 is located inside the frame 1302. The dimensions of frame 1301 fit precisely with the inner frame of frame 1302, and the slots of frame 1301 and the slots of frame 1302 vertically staggered at 90° to each other, after embedding and aligning, the seams are securely bonded with industrial adhesive.

The windings 25 and windings 26 are connected in series, leaving enameled wire end 32A and enameled wire end 32B.

The enameled wire end 32A is soldered to the surface of the hexagonal thin nut 1308A, and the enameled wire end 32B is soldered to the surface of the hexagonal thin nut 1308B.

The insulated wire 27 further including: insulated wires 27A, 27B, 27C, 27D, 27E, and 27F.

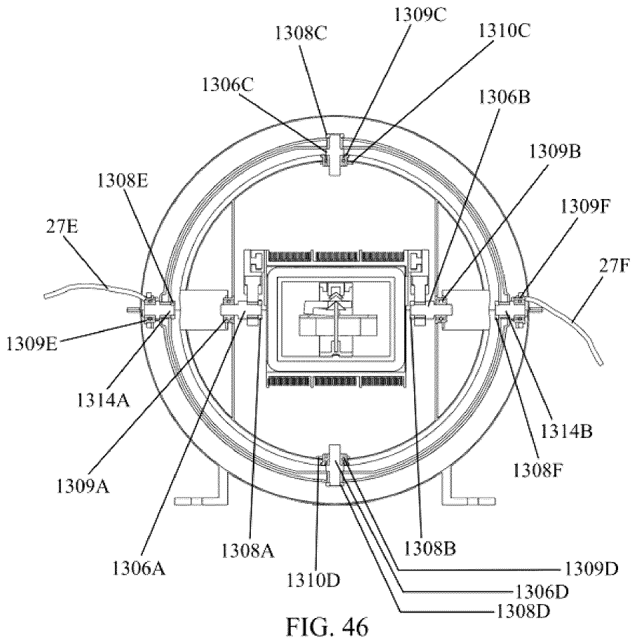

As shown in FIG. 46, one end of the insulated wire 27A is soldered to the flange surface of the flange bearing 1309A, and the wire body of the insulated wire 27A is bonded in the left upper wire groove 13113A to reach the upper end through hole of the inner ring 1311A, the other end of the insulated wire 27A is soldered to the surface of the circlip for shaft 1310C. One end of the insulated wire 27B is soldered to the flange surface of the flange bearing 1309B, and the wire body of the insulated wire 27B is bonded in the right lower wire groove 13113A to reach the lower end through hole of the inner ring 1311A, the other end of the insulated wire 27B is soldered to the surface of the circlip for shaft 1310D.

One end of the insulated wire 27C is soldered to the surface of the hexagonal thin nut 1308C, and the wire body of the insulated wire 27C is bonded in the left upper wire groove 13121A to reach the left end through hole of the outer ring 1312A, the other end of the insulated wire 27C is soldered to the surface of the hexagonal thin nut 1308E. One end of the insulated wire 27D is soldered to the surface of the hexagonal thin nut 1308D, and the wire body of the insulated wire 27D is bonded in the right lower wire groove 13121A to reach the right end through hole of the outer ring 1312A, the other end of the insulated wire 27D is soldered to the surface of the hexagonal thin nut 1308F.

One end of the insulated wire 27E is soldered to the flange surface of the flange bearing 1309E, and one end of the insulated wire 27F is soldered to the flange surface of the flange bearing 1309F.

In terms of electrical connections, specifically, one end is connected through: enameled wire end 32A, hexagonal thin nut 1308A, multi-diameter shaft 1306A, flange bearing 1309A, insulated wire 27A, circlip for shaft 1310C, flange bearing 1309C, multi-diameter shaft 1306C, hexagonal thin nut 1308C, insulated wire 27C, hexagonal thin nut 1308E, multi-diameter shaft 1314A, flange bearing 1309E, and insulated wire 27E. The other end is connected through: enameled wire end 32B, hexagonal thin nut 1308B, multi-diameter shaft 1306B, flange bearing 1309B, insulated wire 27B, circlip for shaft 1310D, flange bearing 1309D, multi-diameter shaft 1306D, hexagonal thin nut 1308D, insulated wire 27D, hexagonal thin nut 1308F, multi-diameter shaft 1314B, flange bearing 1309F, and insulated wire 27F. After connecting insulated wires 27E and 27F to the external load, a circuit is formed.

As shown in FIG. 44, the shell is consisting essentially of an upper hemispherical shell 28 and a lower hemispherical shell 29.

Designers in this field can design it as a sealed shell that can be vacuumed or filled with inert gas. Since this is part of the prior art, it will not be elaborated further.

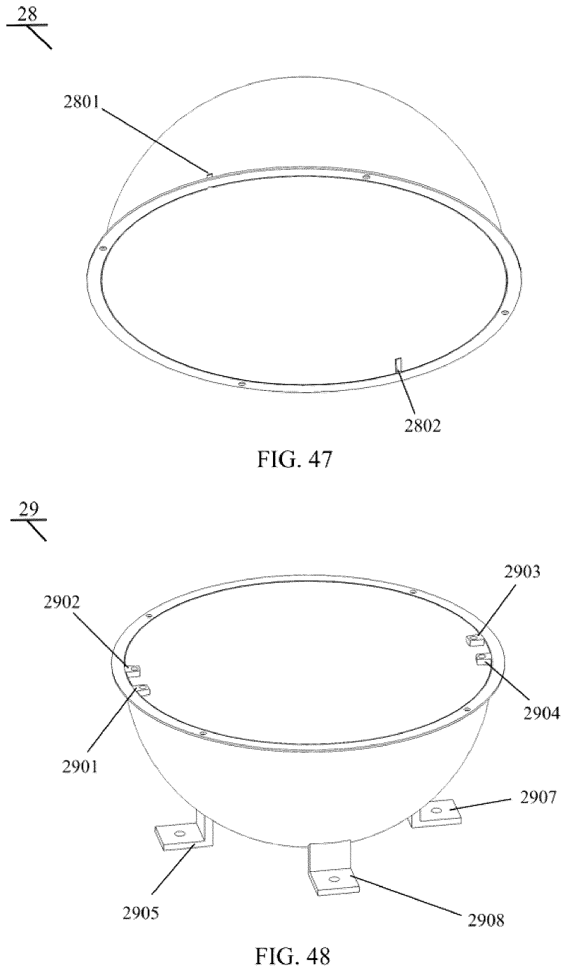

As shown in FIG. 47, the upper hemispherical shell 28 is made of a plastic material selected from diamagnetic materials. The upper hemispherical shell 28 is hollow inside, and the circular opening is surrounded by a flange, which has four through holes spaced 90° apart. The surface of the upper hemispherical shell 28 near the flange has a through hole 2801; and the surface of the upper hemispherical shell 28 near the flange has a through hole 2802, with the through hole 2801 and through hole 2802 being symmetrical. And the two through holes are used for the passage of insulated wires.

As shown in FIG. 48, the lower hemispherical shell 29 is made of a plastic material selected from diamagnetic materials. The lower hemispherical shell 29 is hollow inside, and a flange surrounds the circular opening, which has four through holes spaced 90° apart from the center of the circular opening.

Inside the lower hemispherical shell 29, below the left edge of the circular opening, the left side of the plate 2901 and the left side of the plate 2902 are connected to the inside edge of the circular opening, with through holes on the upper surfaces of the plate 2901 and plate 2902 corresponding in size and position to the two through holes of the diamond-shaped base 1315; inside the lower hemispherical shell 29, below the right edge of the circular opening, the right side of the plate 2903 and the right side of the plate 2904 are connected to the inside edge of the circular opening, with through holes on the upper surfaces of the plate 2903 and plate 2904 corresponding in size and position to the two through holes of the diamond-shaped base 1315.

The upper surface of the L-shaped foot 2905 is connected with the lower end of the outer side of the lower hemispherical shell 29, the upper surface of the L-shaped foot 2906 is connected with the lower end of the outer side of the lower hemispherical shell 29, the upper surface of the L-shaped foot 2907 is connected with the lower end of the outer side of the lower hemispherical shell 29, the upper surface of the L-shaped foot 2908 is connected with the lower end of the outer side of the lower hemispherical shell 29, the interval between the 4 L-shaped feet is 90 degrees, the connecting surfaces of the four L-shaped feet and the outer side of the lower hemispherical shell 29 are on the same plane, the plane is parallel to the plane of the circular opening of the lower hemispherical shell 29, the bottom surfaces of the four L-shaped feet are on the same plane. The center of the bottom surface of the L-shaped foot 2905, L-shaped foot 2906, L-shaped foot 2907, and L-shaped foot 2908 have through holes for the installation of fasteners.

Due to operation in a vibration environment, designers in this field may choose anti-loosening fasteners or employ riveting methods for fastening.

The bolt 30 is made of a plastic material selected from diamagnetic materials. The bolt 30 further including: bolts 30A, 30B, 30C, 30D, 30E, 30F, 30G, and 30H.

The nut 31 is made of a plastic material selected from diamagnetic materials. The nut 31 further including: nuts 31A, 31B, 31C, 31D, 31E, 31F, 31G, and 31H.

The diamond-shaped base 1315A is placed on the plate 2901 and plate 2902 of the lower hemispherical shell 29, and is fastened with bolt 30A, nut 31A, bolt 30B, and nut 31B; the diamond-shaped base 1315B is placed on the plate 2903 and plate 2904 of the lower hemispherical shell 29, and is fastened with bolt 30C, nut 31C, bolt 30D, and nut 31D.

The insulated wire 27E passes through the through hole 2801, with the wire body remaining outside the upper hemispherical shell 28 for connection to an external load, and the gap left by the insulated wire 27E passing through the through hole 2801 is sealed with industrial adhesive; the insulated wire 27F passes through the through hole 2802, with the wire body remaining outside the upper hemispherical shell 28 for connection to the external load, and the gap left by the insulated wire 27F passing through the through hole 2802 is sealed with industrial adhesive.

Similar to the debugging method used for the vibration harvesting device used in electromagnetic vibration power generator 12. After the adjustment of the system's center of gravity is completed, the movable components used for the adjustment are bonded and fixed with industrial adhesive.

As shown in FIG. 44, the upper hemispherical shell 28 covers the lower hemispherical shell 29, aligning the through holes with the through holes, and is fastened with bolt 30E, nut 31E, bolt 30F, nut 31F, bolt 30G, nut 31G, bolt 30H, and nut 31H. The assembly of the electromagnetic vibration power generator 24 is complete.

Due to the current characteristics of the electromagnetic vibration power generator, designers in this field can use a Schottky bridge rectifier with fast recovery characteristics for rectification when designing the circuit.

### V. Composite Vibration Power Generator

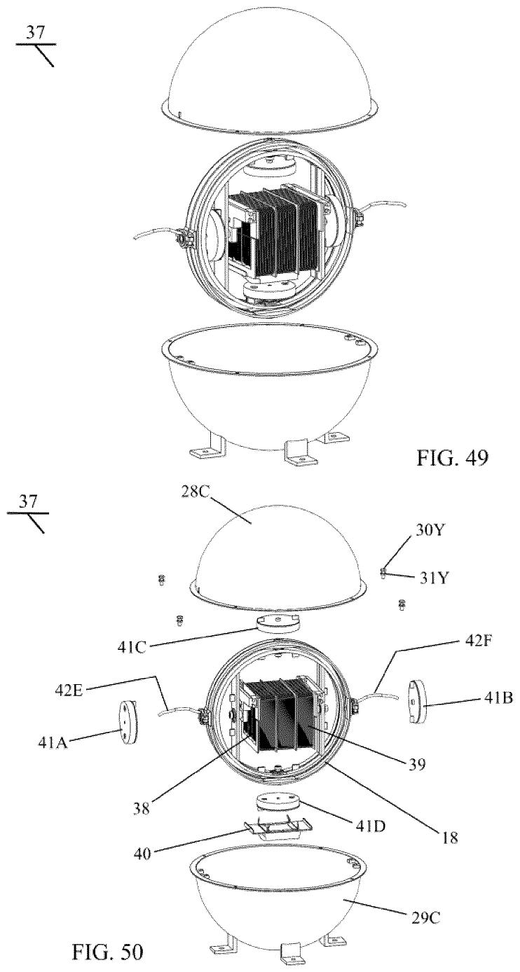

As shown in FIGS. 49 and 50, the composite vibration power generator 37 comprising the vibration harvesting device used in composite vibration power generator 18, windings 38, windings 39, a piezoelectric and triboelectric power generation unit 40, a disc-type triboelectric nano power generation unit 41A, a disc-type triboelectric nano power generation unit 41B, a disc-type triboelectric nano power generation unit 41C, a disc-type triboelectric nano power generation unit 41D, insulated wire 42, an upper hemispherical shell 28C, a lower hemispherical shell 29C, bolt 30, and nut 31.

The composite vibration power generator 37 is assembled by adding the aforementioned components and power generation units to the vibration harvesting device used in composite vibration power generator 18. Since there is some repetition in the content, this embodiment will focus on the added components, power generation units, and their connection methods. For repeated content, please refer to the vibration harvesting device used in composite vibration power generator 18.

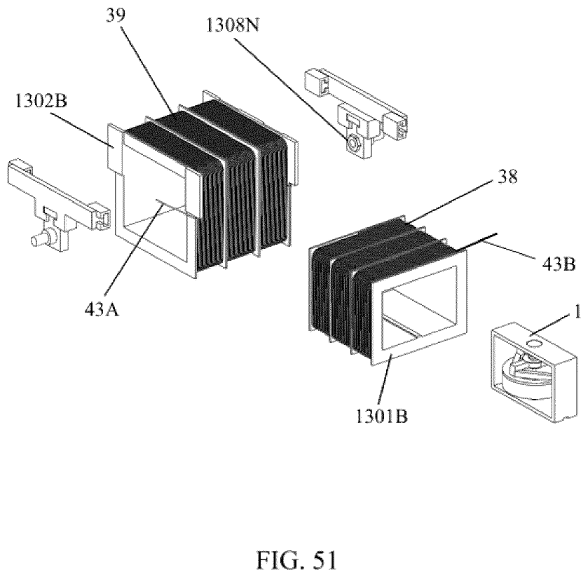

As shown in FIG. 51, the enameled wire is wound clockwise in three slots of the frame 1301B to form three coils, which are connected in series to form the windings 38.

Along the groove 203 that beneath the vibration harvesting component 1, the vibration harvesting component is pushed into the track 13011B of the frame 1301B, ensuring that the vibration harvesting component 1 is precisely embedded within the frame 1301B. After alignment, the seams are bonded with industrial adhesive.

The enameled wire is wound clockwise in three slots on the frame 1302B to form three coils, which are connected in series to form the windings 39.

The vibration harvesting component 1 is located inside the frame 1301B, and the frame 1301B is located inside the frame 1302B. The dimensions of frame 1301B fit precisely with the inner frame of frame 1302B, and the slots of frame 1301B and the slots of frame 1302B vertically staggered at 90° to each other, after embedding and aligning, the seams are securely bonded with industrial adhesive.

The windings 38 are connected in series with the windings 39, leaving enameled wire end 43A and enameled wire end 43B.

The enameled wire end 43A is soldered to the surface of the hexagonal thin nut 1308M, and the enameled wire end 43B is soldered to the surface of the hexagonal thin nut 1308N.

The insulated wire 42 further including: insulated wires 42A, 42B, 42C, 42D, 42E, and 42F.

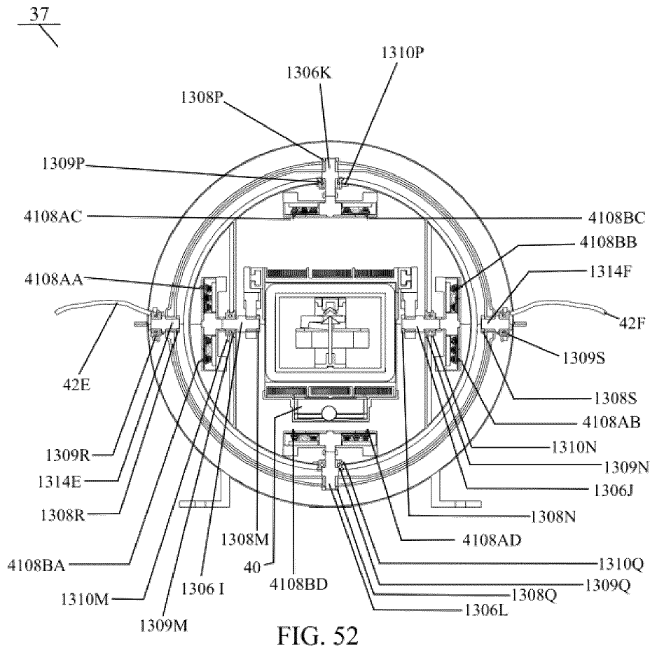

As shown in FIG. 52, on the main circuit, the end of the insulated wire 42A is soldered to the surface of the flange of the flange bearing 1309M, and the body of the insulated wire 42A is bonded in the wire groove 190311A on the upper left side, reaching the upper end through hole of the inner ring 1903A, the other end of the insulated wire 42A is soldered to the surface of the circlip for shaft 1310P. The end of the insulated wire 42B is soldered to the surface of the flange of the flange bearing 1309N, and the body of the insulated wire 42B is bonded in the wire groove 190311A on the lower right side, reaching the lower end through hole of the inner ring 1903A, the other end of the insulated wire 42B is soldered to the surface of the circlip for shaft 1310Q.

The end of the insulated wire 42C is soldered to the surface of the hexagonal thin nut 1308P, and the body of the insulated wire 42C is bonded in the wire groove 13121C on the upper left side, reaching the left end through hole of the outer ring 1312C, the other end of the insulated wire 42C is soldered to the surface of the hexagonal thin nut 1308R. The end of the insulated wire 42D is soldered to the surface of the hexagonal thin nut 1308Q, and the body of the insulated wire 42D is bonded in the wire groove 13121C on the lower right side, reaching the right end through hole of the outer ring 1312C, the other end of the insulated wire 42D is soldered to the surface of the hexagonal thin nut 1308S.

The end of the insulated wire 42E is soldered to the surface of the flange of the flange bearing 1309R. And the end of the insulated wire 42F is soldered to the surface of the flange of the flange bearing 1309S.

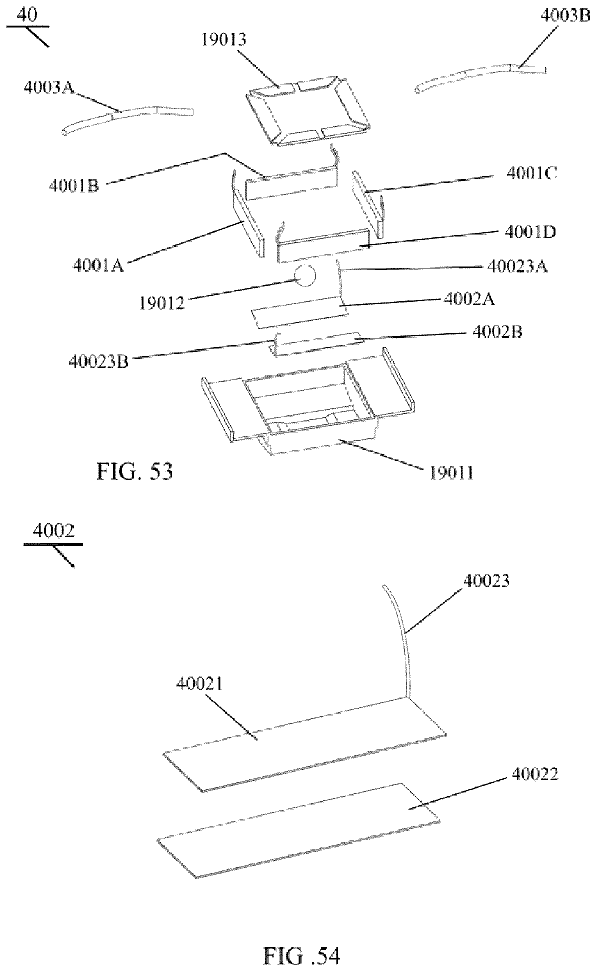

As shown in FIGS. 53 and 39, the piezoelectric and triboelectric power generation unit 40 consisting essentially of a piezoelectric and friction power generation subassembly 1901, a piezoelectric ceramic sheet 4001A, a piezoelectric ceramic sheet 4001B, a piezoelectric ceramic sheet 4001C, a piezoelectric ceramic sheet 4001D, a freestanding triboelectric layer based nano generation unit 4002A, a freestanding triboelectric layer based nano generation unit 4002B, insulated wire 4003.

The piezoelectric ceramic sheet 4001 is rectangular thin plate made of PZT5, with a copper substrate, having positive and negative electrodes on the same side, each connected to wires. The piezoelectric ceramic sheet 4001 further including: piezoelectric ceramic sheets 4001A, 4001B, 4001C, and 4001D.

The insulated wire 4003 further including: insulated wires 4003A and 4003B.

The bottom surface of the piezoelectric ceramic sheet 4001A is bonded to the left vertical side of the square opening on the inner side of the frame 19011, the bottom surface of the piezoelectric ceramic sheet 4001B is bonded to the upper vertical side of the square opening on the inner side of the frame 19011. The bottom surface of the piezoelectric ceramic sheet 4001C is bonded to the right vertical side of the square opening on the inner side of the frame 19011, and the bottom surface of the piezoelectric ceramic sheet 4001D is bonded to the lower vertical side of the square opening on the inner side of the frame 19011. The four pairs of wires from the four piezoelectric ceramic sheets are connected in parallel, with one end connected to the insulated wire 4003A and the other end connected to the insulated wire 4003B.

As shown in FIG. 54, the freestanding triboelectric layer based nano generation unit 4002 consisting essentially of an aluminum foil 40021, a double-sided adhesive 40022, an insulated wire 40023. The aluminum foil 40021 is rectangular and features micro-scale cubic structures fabricated on its upper surface using a selective deposition method. The double-sided adhesive 40022 is also rectangular and has the same dimensions as the aluminum foil 40021. The upper surface of double-sided adhesive 40022 is bonded to the lower surface of the aluminum foil 40021, one end of the insulated wire 40023 is bonded to the upper surface of the double-sided adhesive 40022, and the conductor of the insulated wire 40023 must be in contact with the aluminum foil 40021. The freestanding triboelectric layer based nano generation unit 4002 further including: freestanding triboelectric layer based nano generation units 4002A and 4002B, with the specific structural designation following the main body's numbering convention, where the suffix letter corresponds to the main body's suffix letter.

The bottom surface of freestanding triboelectric layer based nano generation unit 4002A is bonded to the upper surface of the rectangular base plate on the inner side of the hull-shaped base 190111, the bottom surface of freestanding triboelectric layer based nano generation unit 4002B is bonded to the upper surface of the other rectangular base plate on the inner side of the hull-shaped base 190111. The insulated wire 40023A of freestanding triboelectric layer based nano generation unit 4002A is connected to the insulated wire 4003A, and the insulated wire 40023B of freestanding triboelectric layer based nano generation unit 4002B is connected to the insulated wire 4003B.

The ball 19012 is placed inside the hull-shaped base 190111.

The top cover 19013 is bonded to the upper end of the frame 19011, with wires passing through the square holes of the top cover 19013. A [symbol] -shaped groove in the center of the upper surface of the top cover 19013 is used to accommodate the wires, and the insulated wire 4003A and insulated wire 4003B pass through the [symbol] -shaped groove.

The inner vertical side of the [symbol] -shaped plate 190112 of the frame 19011 of the piezoelectric and triboelectric power generation unit 40 is bonded to the bonding area of the square-shaped thin plate 13021B of the frame 1302B, and the inner vertical side of the [symbol] -shaped plate 190113 is bonded to the bonding area of the square-shaped thin plate 13024B of the frame 1302B.

As shown in FIG. 52, the insulated wire 4003A is soldered to the surface of the hexagonal thin nut 1308M, and the insulated wire 4003B is soldered to the surface of the hexagonal thin nut 1308N. The piezoelectric and triboelectric power generation unit 40 is connected to the main circuit.

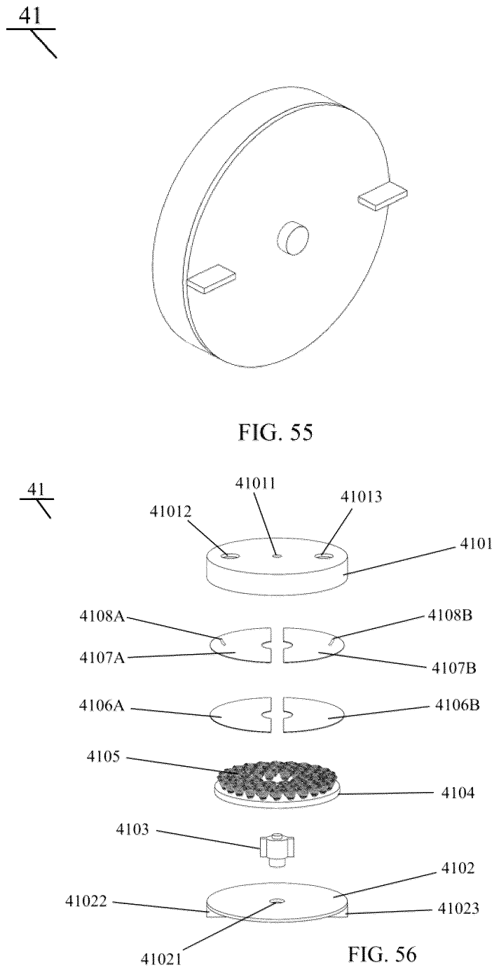

As shown in FIGS. 55, 56 and 57, the disc-type triboelectric nano power generation unit 41 consisting essentially of an upper outer shell 4101, a lower outer shell 4102, a multi-diameter shaft 4103, an intermediate disc 4104, silver-plated electrically conductive fiber clusters 4105, a polytetrafluoroethylene film 4106A, a polytetrafluoroethylene film 4106B, a double-sided adhesive copper foil 4107A, a double-sided adhesive copper foil 4107B, an insulated wire 4108A, and an insulated wire 4108B. The disc-type triboelectric nano power generation unit 41 further including: disc-type triboelectric nano power generation units 41A, 41B, 41C, and 41D, with the specific structural designation following the main body's numbering convention, where the suffix letter corresponds to the main body's suffix letter.

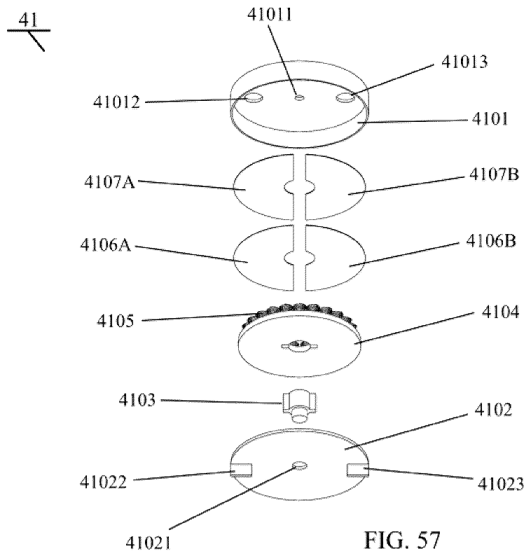

As shown in FIGS. 56 and 57, the upper outer shell 4101 is made of a plastic material selected from diamagnetic materials, and has the appearance of a hollow cylinder, with one open end and one closed end, the circular opening facing downward, there is a through hole 41011 at the center of the top surface of the upper outer shell 4101, with a through hole 41012 on the left side of through hole 41011 and a through hole 41013 on the right side of through hole 41011, the diameter line of the top surface passes through the centers of through hole 41011, through hole 41012, and through hole 41013.

The lower outer shell 4102 is made of a plastic material selected from diamagnetic materials and has the appearance of a circular disc, with a through hole 41021 at its center, the upper surface of the plate 41022 is connected to the left side of the diameter line on the lower surface of the lower outer shell 4102, while the upper surface of the plate 41023 is connected to the right side of the diameter line on the lower surface of the lower outer shell 4102, the plate 41022 and plate 41023 are symmetrical.

The polytetrafluoroethylene film 4106 is in a sector ring shape, the upper surface is etched by plasma in a dry etching method to obtain a uniform nanowire structure, the polytetrafluoroethylene film 4106 further including: the polytetrafluoroethylene films 4106A and 4106B.

The double-sided adhesive copper foil 4107 is in a sector ring shape and has the same dimensions as the polytetrafluoroethylene film 4106, the double-sided adhesive copper foil 4107 further including: the double-sided adhesive copper foils 4107A and 4107B.

The insulated wire 4108 further including: the insulated wires 4108A and 4108B.

One side of the double-sided adhesive copper foil 4107A is bonded to the lower surface of the polytetrafluoroethylene film 4106A, while one end of the insulated wire 4108A is bonded to the other side of the double-sided adhesive copper foil 4107A, the conductor of the insulated wire 4108A must be in contact with the copper foil of the double-sided adhesive copper foil 4107A.

One side of the double-sided adhesive copper foil 4107B is bonded to the lower surface of the polytetrafluoroethylene film 4106B, while one end of the insulated wire 4108B is bonded to the other side of the double-sided adhesive copper foil 4107B, the conductor of the insulated wire 4108B must be in contact with the copper foil of the double-sided adhesive copper foil 4107B.

The bottom surface of the double-sided adhesive copper foil 4107A is bonded to the bottom of the inner side of the upper shell 4101, and the bottom surface of the double-sided adhesive copper foil 4107B is also bonded to the bottom of the inner side of the upper shell 4101, with the bonding positions of the two not overlapping. The insulated wire 4108A passes through the through hole 41012, and the insulated wire 4108B passes through the through hole 41013.

The intermediate disc 4104 is made of a plastic material selected from diamagnetic materials and has the appearance of a circular disc, there is a double flat keyway at the center of the intermediate disc 4104.

Silver-plated electrically conductive fiber clusters 4105 consisting essentially of 40 groups of silver-plated conductive fiber strands. Preferably, the silver-plated electrically conductive fiber is specified as 140 D, made of nylon fibers, with a diameter of 0.089 to 0.1 mm and a resistance of 4 to 6.5 Ω/cm. Multiple equal-length silver-plated electrically conductive fiber strands are processed into a bundle, preferably, forming 40 groups of silver-plated electrically conductive fiber bundles. One end of the 40 groups of silver-plated electrically conductive fiber bundles is bonded to the upper surface of the intermediate disc 4104.

The multi-diameter shaft 4103 is made of a plastic material selected from diamagnetic materials and consisting essentially of the following parts from top to bottom: the shaft journal, the shaft shoulder, and the spindle nose, the shaft shoulder has a double flat key.

The multi-diameter shaft 4103 passes through the intermediate disc 4104, with the double flat key of the multi-diameter shaft 4103 bonded in the double flat keyway of the intermediate disc 4104. The spindle nose of the multi-diameter shaft 4103 penetrates the through hole 41021 of the lower outer shell 4102, with the silver-plated electrically conductive fiber clusters 4105 facing upward.

The shaft journal of the multi-diameter shaft 4103 passes through the through hole 41011 of the upper outer shell 4101, and the upper surface of the lower outer shell 4102 is bonded to the opening of the upper outer shell 4101. During rotation, the silver-plated electrically conductive fiber clusters 4105 come into contact with the polytetrafluoroethylene film 4106A and polytetrafluoroethylene film 4106B. Designers in the field should confirm the silver-plated electrically conductive fiber clusters keeps contact with the polytetrafluoroethylene film, and the rotational damping is appropriate.

As shown in FIG. 50, the surfaces of the plate 41022A and the plate 41023A of the disc-type triboelectric nano power generation unit 41A is bonded to the surfaces of the plate 19033A and plate 19034A of the inner ring 1903A. The hose 1902A is fitted onto the spindle nose of the multi-diameter shaft 4103A, with the contact portion bonded. As shown in FIG. 52, one end of the insulated wire 4108AA is soldered to the surface of the circlip for shaft 1310M, and the body of the insulated wire 4108BA is bonded in the wire groove 190311A on the lower left side, reaching the lower end through hole of the inner ring 1903A, the other end of the insulated wire 4108BA is soldered to the surface of the circlip for shaft 1310Q. The disc-type triboelectric nano power generation unit 41A is connected to the main circuit in parallel.

The surfaces of the plate 41022B and the plate 41023B of the disc-type triboelectric nano power generation unit 41B is bonded to the surfaces of the plate 19035A and plate 19036A of the inner ring 1903A. The hose 1902B is fitted onto the spindle nose of the multi-diameter shaft 4103B, with the contact portion bonded. One end of the insulated wire 4108AB is soldered to the surface of the circlip for shaft 1310N, and the body of the insulated wire 4108BB is bonded in the wire groove 190311A on the upper right side, reaching the upper end through hole of the inner ring 1903A, the other end of the insulated wire 4108BB is soldered to the surface of the circlip for shaft 1310P. The disc-type triboelectric nano power generation unit 41B is connected to the main circuit in parallel.

The surfaces of the plate 41022C and the plate 41023C of the disc-type triboelectric nano power generation unit 41C is bonded to the surfaces of the plate 19037A and plate 19038A of the inner ring 1903A. The hose 1902C is fitted onto the spindle nose of the multi-diameter shaft 4103C, with the contact portion bonded. One end of the insulated wire 4108AC is soldered to the surface of the circlip for shaft 1310P, and the body of the insulated wire 4108BC is bonded in the wire groove 190311A on the right side, reaching the lower end through hole of the inner ring 1903A, the other end of the insulated wire 4108BC is soldered to the surface of the circlip for shaft 1310Q. The disc-type triboelectric nano power generation unit 41C is connected to the main circuit in parallel.

The surfaces of the plate 41022D and the plate 41023D of the disc-type triboelectric nano power generation unit 41D is bonded to the surfaces of the plate 19039A and plate 190310A of the inner ring 1903A. The hose 1902D is fitted onto the spindle nose of the multi-diameter shaft 4103D, with the contact portion bonded. One end of the insulated wire 4108AD is soldered to the surface of the circlip for shaft 1310Q, and the body of the insulated wire 4108BD is bonded in the wire groove 190311A on the left side, reaching the upper end through hole of the inner ring 1903A, the other end of the insulated wire 4108BD is soldered to the surface of the circlip for shaft 1310P. The disc-type triboelectric nano power generation unit 41D is connected to the main circuit in parallel.

As shown in FIG. 52, the electrical connections on the main circuit, specifically, one end is connected through: enameled wire end 43A, hexagonal thin nut 1308M, multi-diameter shaft 1306I, flange bearing 1309M, insulated wire 42A, circlip for shaft 1310P, flange bearing 1309P, multi-diameter shaft 1306K, hexagonal thin nut 1308P, insulated wire 42C, hexagonal thin nut 1308R, multi-diameter shaft 1314E, flange bearing 1309R, and insulated wire 42E. The other end is connected through: enameled wire end 43B, hexagonal thin nut 1308N, multi-diameter shaft 1306J, flange bearing 1309N, insulated wire 42B, circlip for shaft 1310Q, flange bearing 1309Q, muti-diameter shaft 1306L, hexagonal thin nut 1308Q, insulated wire 42D, hexagonal thin nut 1308S, muti-diameter shaft 1314F, flange bearing 1309S, insulated wire 42F. After the insulated wires 42E and 42F are connected to an external load, a closed circuit is formed.

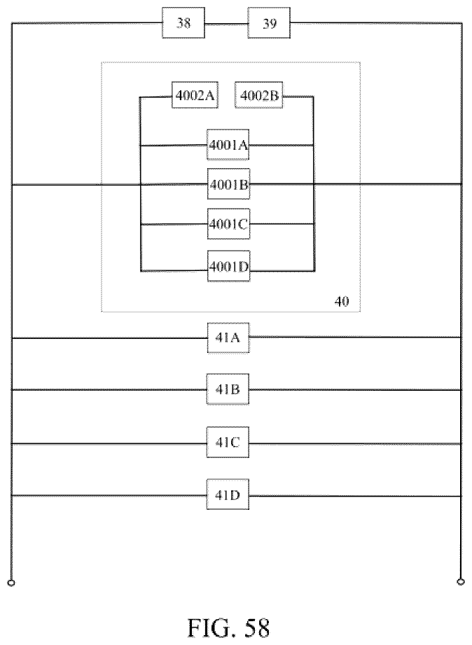

As shown in FIG. 58, the piezoelectric and triboelectric power generation unit 40, the disc-type triboelectric nano power generation unit 41A, the disc-type triboelectric nano power generation unit 41B, the disc-type triboelectric nano power generation unit 41C, and the disc-type triboelectric nano power generation unit 41D are connected in parallel to the main circuit.

As shown in FIG. 52, wherein the piezoelectric and triboelectric power generation unit 40 is connected at one end respectively through: insulated wire 4003A, hexagonal thin nut 1308M. And at the other end respectively through: insulated wire 4003B, hexagonal thin nut 1308N.

The disc-type triboelectric nano power generation unit 41A is connected at one end respectively through: insulated wire 4108AA, circlip for shaft 1310M. And at the other end respectively through: insulated wire 4108BA, circlip for shaft 1310Q.

The disc-type triboelectric nano power generation unit 41B is connected at one end respectively through: insulated wire 4108AB, circlip for shaft 1310N. And at the other end respectively through: insulated wire 4108BB, circlip for shaft 1310P.

The disc-type triboelectric nano power generation unit 41C is connected at one end respectively through: insulated wire 4108AC, circlip for shaft 1310P. And at the other end respectively through: insulated wire 4108BC, circlip for shaft 1310Q.

The disc-type triboelectric nano power generation unit 41D is connected at one end respectively through: insulated wire 4108AD, circlip for shaft 1310Q. And at the other end respectively through: insulated wire 4108BD, circlip for shaft 1310P.

The upper hemispherical shell 28 further including: the upper hemispherical shell 28C, with the specific structural designation following the main body's numbering convention, where the suffix letter corresponds to the main body's suffix letter.

The lower hemispherical shell 29 further including: the lower hemispherical shell 29C, with the specific structural designation following the main body's numbering convention, where the suffix letter corresponds to the main body's suffix letter.

The bolt 30 further including: bolts 30R, 30S, 30T, 30U, 30V, 30W, 30X and 30Y.

The nut 31 further including: nuts 31R, 31S, 31T, 31U, 31V, 31W, 31X and 31Y.

Place the diamond-shaped base 1315E on the plate 2901C and plate 2902C, and fasten using bolt 30R, nut 31R, bolt 30S, and nut 31S; place the diamond-shaped base 1315F on the plate 2903C and plate 2904C, and fasten using bolt 30T, nut 31T, bolt 30U, and nut 31U. The insulated wire 42E passes through the through hole 2801C, leaving the wire body outside the upper hemispherical shell 28C to connect to an external load. Seal the gap left by the insulated wire 42E passing through the through hole 2801C with industrial adhesive. The insulated wire 42F passes through the through hole 2802C, leaving the wire body outside the upper hemispherical shell 28C to connect to the external load, and seal the gap left by the insulated wire 42F passing through the through hole 2802C with industrial adhesive.

Designers in the field should refer to the debugging method used for the vibration harvesting device used in composite vibration power generator 18. After the adjustment of the system's center of gravity is completed, the movable components used for the adjustment are bonded and fixed with industrial adhesive.

As shown in FIG. 50, the upper hemispherical shell 28C covers the lower hemispherical shell 29C, with the through holes aligned with each other, bolt 30V, nut 31V, bolt 30W, nut 31W, bolt 30X, nut 31X, bolt 30Y, and nut 31Y are used for fastening. The installation of the composite vibration power generator 37 is completed.

Due to the current characteristics of the composite vibration power generator, designers in this field can use a Schottky bridge rectifier with fast recovery characteristics for rectification when designing the circuit.

What is claimed is:

1. A vibration harvesting component for vibration power generator (1) (hereinafter referred to as ‘vibration harvesting component (1)’), comprising: a rectangular-shaped frame (2), a pillar (3), an oscillator swinging around a point above the center of gravity (4), and an anti-shedding component (5),
the tail end of the pillar (3) is inserted into a round hole (207) of the rectangular-shaped frame (2) and bonded, the lower hollow cone (4063) of the oscillator swinging around a point above the center of gravity (4) is placed at the top end of the pillar (3), the system's center of gravity positioned below the top end of pillar (3), and when harvesting vibration energy, the oscillator swinging around a point above the center of gravity (4) swings or rotates, the movable column (502) of the anti-shedding component (5) is inserted into the round hole (208) and the circular ring (209) of the rectangular-shaped frame (2) and bonded, the bottom of the hollow cone (501) of the anti-shedding component (5) is positioned above the upper hollow cone (4062) of the anti-shedding component (406), the interaction between the anti-shedding component (406) of the oscillator swinging around a point above the center of gravity (4), and the anti-shedding component (5), and the pillar (3) prevents that when swinging or rotating, the oscillator swinging around a point above the center of gravity (4) is prevented disengaging from the pillar (3).

2. The vibration harvesting component according to claim 1, wherein the rectangular-shaped frame (2) consisting essentially of a base plate (201), a perforated cylinder (202), a groove (203), a side plate (204), a side plate (205), and a top plate (206), which is made of a plastic material selected from diamagnetic materials,
the center of the upper surface of the base plate (201) has a perforated cylinder (202), and the center of the round hole (207) on the upper surface of the perforated cylinder (202) does not penetrate through the base plate (201), below the base plate (201) along the midline of the two short sides, there is a groove (203) with a rectangular cross-section, the bottom surface of the side plate (204) is connected at a 90° angle to one short side of the base plate (201), and the bottom surface of the side plate (205) is connected at a 90° angle to the other short side of the base plate (201), the upper end of the side plate (204) is connected to one short side of the top plate (206), and the upper end of the side plate (205) is connected to the other short side of the top plate (206), the center of the upper surface of the top plate (206) has a round hole (208), with the axis of the perforated cylinder (202) passing through the center of the round hole (208), and the center of the lower surface of the top plate (206) is connected to the upper surface of a circular ring (209), with the axis of the perforated cylinder (202) simultaneously passing through the centers of the circular ring (209) and the round hole (208).

3. The vibration harvesting component according to claim 1, wherein the pillar (3) is made of a copper rod, the top of the pillar (3) is rounded to form a dome shape, and the tail end of the pillar (3) is inserted into the round hole (207) without protruding outside the base plate (201).

4. The vibration harvesting component according to claim 1, wherein the oscillator swinging around a point above the center of gravity (4) consisting essentially of a rod member (401), a rod member (402), a ring member (403), a rod member (404), a U-shaped rod member (405), an anti-shedding component (406), and a counterweight as part of the electromagnetic power generation unit (407), wherein the rod member (401), the rod member (402), the ring member (403), the rod member (404), and the U-shaped rod member (405) is made of a plastic material selected from diamagnetic materials,
the bottom surface of rod member (401) is connected to the bottom surface of rod member (402) in a V-shape, with the upper surface of the connecting part of the two connected to the tail end of the lower surface of rod member (404), the bottom surface of the other end of rod member (404) is connected to the protruding bottom surface of U-shaped rod member (405), ensuring that the upper surfaces of rod member (404) and U-shaped rod member (405) are in the same plane, the two sides of U-shaped rod member (405) are parallel to the axis of rod member (404),
the other side on the axis of rod member (401) is connected to the upper ring surface of ring member (403), connecting to one end of the diameter line α of ring member (403), the other side on the axis of rod member (402) is connected to the upper ring surface of ring member (403), connecting to the other end of the diameter line α of ring member (403),
the lower surface of rod member (401) forms an angle of 3° with the upper ring surface of ring member (403), the lower surface of rod member (402) forms an angle of 3° with the upper ring surface of ring member (403), the lower surface of rod member (404) forms an angle of 3° with the upper surface of rod member (401), and the lower surface of rod member (404) forms an angle of 3° with the upper surface of rod member (402), ensuring that the upper surface of rod member (404) is parallel to the upper ring surface of ring member (403),
the vertical auxiliary line β drawn from the center of ring member (403) intersects the auxiliary line γ on the upper surface of U-shaped rod member (405) at a right angle of 90°,
the concave part of the U-shaped rod member (405) clamps and bonds the joint of the lower surface of the round wafer (4061) and the lower hollow cone (4063) that belong to the anti-shedding component (406),
the upper surface of the counterweight as part of the electromagnetic power generation unit (407) is bonded to the lower surface of ring member (403), with the outer rings of the two circular rings overlapping.

5. The vibration harvesting component according to claim 4, wherein the anti-shedding component (406) consisting essentially of a round wafer (4061), an upper hollow cone (4062), and a lower hollow cone (4063), all of which are made of copper sheet,
the base of the upper hollow cone (4062) is welded to the upper surface of the round wafer (4061), and the axis of the upper hollow cone (4062) vertically passes through the center of the round wafer (4061), the apex of the lower hollow cone (4063) is welded to the center of the lower surface of the round wafer (4061), and the axis of the lower hollow cone (4063) vertically passes through the center of the round wafer (4061), coinciding with the axis of the upper hollow cone (4062), forming the axis Δ of the anti-shedding component (406).

6. The vibration harvesting component according to claim 4, wherein the counterweight as part of the electromagnetic power generation unit (407) is in the shape of a ring, made of annular neodymium-iron-boron magnet, thickness magnetization, the outer diameter of the counterweight as part of the electromagnetic power generation unit (407) equals the outer diameter of the ring member (403), and the ring width of the counterweight as part of the electromagnetic power generation unit (407) equals the ring width of the ring member (403) multiplied by 140%.

7. The vibration harvesting component according to claim 4, wherein the axis Δ of the anti-shedding component (406) vertically passes through the center of the upper surface that belongs to the counterweight as part of the electromagnetic power generation unit (407).

8. The vibration harvesting component according to claim 1, wherein the oscillator swinging around a point above the center of gravity (4) places the inner apex of the lower hollow cone (4063) on the dome of the pillar (3), allowing the oscillator swinging around a point above the center of gravity (4) to maintain balance on its own, when swinging or rotating, the edge of the bottom surface of the counterweight as part of the electromagnetic power generation unit (407) cannot touch the upper surface of the base plate (201),
and there is a gap of 2 mm between the edge of the bottom surface of the counterweight as part of the electromagnetic power generation unit (407) and the upper surface of the base plate (201) during swinging or rotating.

9. The vibration harvesting component according to claim 1, wherein the anti-shedding component (5) consisting essentially of a hollow cone (501) and a movable column (502), the hollow cone (501) is made of copper sheet, and the movable column (502) is a cylindrical body made of a plastic material selected from diamagnetic materials, there is a shallow round hole (5021) at the center of the lower surface of the movable column (502), and the top of the hollow cone (501) is bonded in the shallow round hole (5021), the axis of the movable column (502) vertically passes through the center of the bottom surface of the hollow cone (501).

10. The vibration harvesting component according to claim 1, wherein the anti-shedding component (406) and the anti-shedding component (5) together constitute the anti-shedding part of the vibration harvesting component (1).

11. The vibration harvesting component according to claim 1, wherein the bottom of the hollow cone (501) of the anti-shedding component (5) is positioned directly above the upper hollow cone (4062), with a certain distance maintained between the two such that they do not make contact, the bottom of the hollow cone (501) is moved downward to one-third of the height of the upper hollow cone (4062), and the axis of the hollow cone (501) coincides with the axis Δ of the anti-shedding component (406).

12. The vibration harvesting component according to claim 1, wherein the movable column (502) of the anti-shedding component (5) is bonded at the joint of the round hole (208) and the circular ring (209) of the rectangular-shaped frame (2), and the upper end of the movable column (502) cannot protrude above the upper surface of the top plate (206) of the rectangular-shaped frame (2).

13. A vibration harvesting device used in electromagnetic vibration power generator (12), comprising: a vibration harvesting component (1) and a gimbal (13),
the vibration harvesting component (1) is located inside the frame (1301) of the gimbal (13), with the groove (203) beneath the base plate (201) of the vibration harvesting component (1) embedded and aligned in the track (13011) of the frame (1301) that belongs the gimbal (13), and bonded at the seam,
the frame (1301) having the vibration harvesting component (1) mounted therein is located inside the frame (1302) of the gimbal (13), with the slots of the frame (1301) and the slots of the frame (1302) vertically staggered at 90° to each other, the upper part of one end of the embedded frame (1301) abuts against the inner side of the plate (13028) of the frame (1302), after the frames are embedded and aligned, the seam is temporarily not bonded for assembly, waiting for the subsequent process to complete the installation of the electromagnetic power generation unit components is fixed,
insert the T-shaped tenon of [symbol] -shaped part (1305A) of the gimbal (13) into the T-shaped groove at the lower end of the T-shaped beam (1304A) and move it left and right, concurrently, insert the T-shaped tenon of [symbol] -shaped part (1305B) of the gimbal (13) into the T-shaped groove at the lower end of the T-shaped beam (1304B) and move it left and right, thereby achieving adjustment of the system's center of gravity along the X-axis for the vibration harvesting component (1), the movable parts used for adjustment are not yet bonded and fixed, and will be secured after the installation of the electromagnetic power generation unit components in the subsequent process,
the T-shaped tenon at the left end of the T-shaped beam (1304A) of the gimbal (13) is inserted into the T-shaped groove (1303A), the T-shaped tenon at the right end of the T-shaped beam (1304A) is inserted into the T-shaped groove (1303B) to move inwards and outwards, meanwhile, the T-shaped tenon at the left end of the T-shaped beam (1304B) of the gimbal (13) is inserted into the T-shaped groove (1303C), and the T-shaped tenon at the right end of the T-shaped beam (1304B) is inserted into the T-shaped groove (1303D) to move inwards and outwards, so that the system's center of gravity of the vibration harvesting component (1) on the Y-axis is adjusted, the movable parts used for adjustment are not yet bonded and fixed, and will be secured after the installation of the electromagnetic power generation unit components in the subsequent process,
the system's center of gravity of the vibration harvesting component (1) is located below the line connecting multi-diameter shaft (1306A) and multi-diameter shaft (1306B) of the gimbal (13) so that the rigid body can be automatically adjusted no matter how the rigid body rotates, the system's center of gravity on the Z-axis can be adjusted,
during harvesting, regardless of rotation, the framework device formed by the inner ring (1311A) and outer ring (1312A) of the gimbal (13) adjusts mutually, allowing the vibration harvesting component (1) to harvest omnidirectional external excitation.

14. The vibration harvesting device used in electromagnetic vibration power generator according to claim 13, wherein the vibration harvesting component (1) is the vibration harvesting component as recited in claim 1.

15. The vibration harvesting device used in electromagnetic vibration power generator according to claim 13, wherein the gimbal (13) consisting essentially of a frame (1301), a frame (1302), a T-shaped groove (1303A), a T-shaped groove (1303B), a T-shaped beam (1304A), a T-shaped groove (1303C), a T-shaped groove (1303D), a T-shaped beam (1304B), a [symbol] -shaped part (1305A), a shaft sleeve (1307A), a multi-diameter shaft (1306A), a hexagonal thin nut (1308A), a [symbol] -shaped part (1305B), a shaft sleeve (1307B), a multi-diameter shaft (1306B), a hexagonal thin nut (1308B), a flange bearing (1309A), a circlip for shaft (1310A), a flange bearing (1309B), a circlip for shaft (1310B), an inner ring (1311A), a flange bearing (1309C), a circlip for shaft (1310C), a flange bearing (1309D), a circlip for shaft (1310D), an outer ring (1312A), a shaft sleeve (1313C), a multi-diameter shaft (1306C), a hexagonal thin nut (1308C), a shaft sleeve (1313D), a multi-diameter shaft (1306D), a hexagonal thin nut (1308D), a shaft sleeve (1313E), a hexagonal thin nut (1308E), a multi-diameter shaft (1314A), a circlip for shaft (1310E), a diamond-shaped base (1315A), a flange bearing (1309E), a shaft sleeve (1313F), a hexagonal thin nut (1308F), a multi-diameter shaft (1314B), a circlip for shaft (1310F), a diamond-shaped base (1315B), and a flange bearing (1309F),
the frame (1301) is located inside the frame (1302), with the slots of frame (1301) and the slots of frame (1302) vertically staggered at 90° to each other, the upper part of the end embedded in frame (1302) abuts against the inner side of the plate (13028) of the frame (1302), after the frames are embedded and aligned, waiting for the subsequent process to complete the installation of the electromagnetic power generation unit components before bonding,
the T-shaped tenon at the left end of T-shaped beam (1304A) is inserted into the T-shaped groove (1303A), and the T-shaped tenon at the right end of T-shaped beam (1304A) is inserted into the T-shaped groove (1303B), the tenon of [symbol] -shaped part (1305A) is inserted into the T-shaped groove of T-shaped beam (1304A), the back of T-shaped groove (1303A) is bonded to the front of plate (130211), and the back of T-shaped groove (1303B) is bonded to the front of plate (130212),
the T-shaped tenon at the left end of T-shaped beam (1304B) is inserted into the T-shaped groove (1303C), and the T-shaped tenon at the right end of T-shaped beam (1304B) is inserted into the T-shaped groove (1303D), the tenon of [symbol] -shaped part (1305B) is inserted into the T-shaped groove of T-shaped beam (1304B), the back of T-shaped groove (1303C) is bonded to the front of plate (130241), and the back of T-shaped groove (1303D) is bonded to the front of plate (130242),
the shaft sleeve (1307A) is embedded in the through hole of [symbol] -shaped part (1305A), and the spindle nose of multi-diameter shaft (1306A) passes through the through hole of shaft sleeve (1307A), the hexagonal thin nut (1308A) is screwed onto the thread of multi-diameter shaft (1306A) for fastening, with hexagonal thin nut (1308A) reserved for use as a terminal,
the shaft sleeve (1307B) is embedded in the through hole of [symbol] -shaped part (1305B), and the spindle nose of multi-diameter shaft (1306B) passes through the through hole of shaft sleeve (1307B), the hexagonal thin nut (1308B) is screwed onto the thread of multi-diameter shaft (1306B) for fastening, with hexagonal thin nut (1308B) reserved for use as a terminal,
the shaft journal of multi-diameter shaft (1306A) is inserted into the hole of flange bearing (1309A), which is installed in the left side through hole of inner ring (1311A), the flange of flange bearing (1309A) abuts against the inner side of the counterbore of reinforcing block (13111A), and the circlip for shaft (1310A) secures the other end of flange bearing (1309A) for fastening, with the flange of flange bearing (1309A) reserved for use as a terminal,
the shaft journal of multi-diameter shaft (1306B) is inserted into the hole of flange bearing (1309B), which is installed in the right side through hole of inner ring (1311A), the flange of flange bearing (1309B) abuts against the inner side of the counterbore of reinforcing block (13112A), and the circlip for shaft (1310B) secures the other end of flange bearing (1309B) for fastening, with the flange of flange bearing (1309B) reserved for use as a terminal,
the shaft journal of multi-diameter shaft (1306C) is inserted into the hole of flange bearing (1309C), which is installed in the upper side through hole of inner ring (1311A), the flange of flange bearing (1309C) abuts against the upper side counterbore of inner ring (1311A), and the circlip for shaft (1310C) secures the other end of flange bearing (1309C) for fastening, with the circlip for shaft (1310C) reserved for use as a terminal,
the shaft journal of multi-diameter shaft (1306D) is inserted into the hole of flange bearing (1309D), which is installed in the lower side through hole of inner ring (1311A), the flange of flange bearing (1309D) abuts against the lower side counterbore of inner ring (1311A), and the circlip for shaft (1310D) secures the other end of flange bearing (1309D) for fastening, with the circlip for shaft (1310D) reserved for use as a terminal,
the shaft sleeve (1313C) is embedded in the upper through hole of the outer ring (1312A), and the spindle nose of the multi-diameter shaft (1306C) passes through the through hole of the shaft sleeve (1313C), the hexagonal thin nut (1308C) is screwed onto the thread of the multi-diameter shaft (1306C) for fastening, with hexagonal thin nut (1308C) reserved for use as a terminal,
the shaft sleeve (1313D) is embedded in the lower through hole of the outer ring (1312A), and the spindle nose of the multi-diameter shaft (1306D) passes through the through hole of the shaft sleeve (1313D), the hexagonal thin nut (1308D) is screwed onto the thread of the multi-diameter shaft (1306D) for fastening, with hexagonal thin nut (1308D) reserved for use as a terminal,
the shaft sleeve (1313E) is embedded in the left side through hole of the outer ring (1312A), and the spindle nose of the multi-diameter shaft (1314A) passes through the through hole of the shaft sleeve (1313E), the hexagonal thin nut (1308E) is screwed onto the thread of the multi-diameter shaft (1314A) for fastening, with hexagonal thin nut (1308E) reserved for use as a terminal,
the shaft sleeve (1313F) is embedded in the right side through hole of the outer ring (1312A), and the spindle nose of the multi-diameter shaft (1314B) passes through the through hole of the shaft sleeve (1313F), the hexagonal thin nut (1308F) is screwed onto the thread of the multi-diameter shaft (1314B) for fastening, with hexagonal thin nut (1308F) reserved for use as a terminal,
the flange bearing (1309E) is installed in the main through hole of the diamond-shaped base (1315A), with the flange clamped against the outer edge of the main through hole, the shaft journal of multi-diameter shaft (1314A) is inserted into the hole of the flange bearing (1309E), and the circlip for shaft (1310E) secures the other end of the flange bearing (1309E) for fastening, with the flange of the flange bearing (1309E) reserved for use as a terminal,
the flange bearing (1309F) is installed in the main through hole of the diamond-shaped base (1315B), with the flange clamped against the outer edge of the main through hole, the shaft journal of multi-diameter shaft (1314B) is inserted into the hole of the flange bearing (1309F), and the circlip for shaft (1310F) secures the other end of the flange bearing (1309F) for fastening, with the flange of the flange bearing (1309F) reserved for use as a terminal.

16. The vibration harvesting device used in electromagnetic vibration power generator according to claim 15, wherein the frame (1301) consisting essentially of an inner frame and slots, and is made of a plastic material selected from diamagnetic materials,
the shape of the inner frame of the frame (1301) is a hollow cuboid, with the internal height of the hollow cuboid equal to the height of the vibration harvesting component (1), and the internal length of the hollow cuboid equal to the length of the vibration harvesting component (1),
on the inner side of the bottom plate of the hollow cuboid, there is a track (13011) connecting the midpoints of the two open ends of the bottom plate, where the cross-section of the track (13011) is rectangular, the length of the track (13011) is the same as that of the groove (203) of the rectangular-shaped frame (2), and the width of the track (13011) is the same as that of the groove (203), allowing the groove (203) to fit perfectly into the track (13011),
from left to right, surrounding the four solid faces of the hollow cuboid, there are square-shaped thin plate (13012), square-shaped thin plate (13013), square-shaped thin plate (13014), and square-shaped thin plate (13015) connected respectively, with the spacing between the four square-shaped thin plates being evenly distributed, forming three slots.

17. The vibration harvesting device used in electromagnetic vibration power generator according to claim 15, wherein the frame (1302) consisting essentially of an inner frame, slots, plates, and is made of a plastic material selected from diamagnetic materials,
the shape of the inner frame of the frame (1302) is a hollow cuboid, with the internal height of the hollow cuboid equal to the height of the frame (1301), the internal width of the hollow cuboid equal to the length of the frame (1301), and the internal length of the hollow cuboid equal to the width of the frame (1301), allowing the frame (1301) to fit perfectly into the inner frame of the frame (1302),
from left to right, surrounding the four solid faces of the hollow cuboid, there are square-shaped thin plate (13021), square-shaped thin plate (13022), square-shaped thin plate (13023), and square-shaped thin plate (13024) connected respectively, with the spacing between the four square-shaped thin plates being evenly distributed, forming three slots,
at the opening on the front side of the hollow cuboid, on the left front side of the square-shaped thin plate (13021), the rear surface of the plate (130211) is vertically connected, the bottom surface of the plate (130211) is above the midline X, and the right side of the plate (130211) is in the same plane as the inner left side of the hollow cuboid,
on the right front side of the square-shaped thin plate (13021), the rear surface of the plate (130212) is vertically connected, the bottom surface of the plate (130212) is above the midline X, and the left side of the plate (130212) is in the same plane as the inner right side of the hollow cuboid,
in the middle of the front side above the square-shaped thin plate (13021), the rear surface of the plate (13028) is connected, and the plate (13028) protrudes downward to block the frame (1301),
at the opening on the rear side of the hollow cuboid, on the left front side of the square-shaped thin plate (13024), the rear surface of the plate (130241) is vertically connected, the bottom surface of the plate (130241) is above the midline X, and the right side of the plate (130241) is in the same plane as the inner left side of the hollow cuboid,
on the right front side of the square-shaped thin plate (13024), the rear surface of the plate (130242) is vertically connected, with the left side of the plate (130242) in the same plane as the inner right side of the hollow cuboid, and the bottom surface of the plate (130242) is above the midline X,
the surface areas of the plate (130211), plate (130212), plate (130241), and plate (130242) are the same, and the midline is in the same plane.

18. The vibration harvesting device used in electromagnetic vibration power generator according to claim 15, wherein the T-shaped groove (1303) is made of a plastic material selected from diamagnetic materials and has a rectangular appearance, with the T-shaped groove penetrating through the front and rear surfaces,
the T-shaped groove (1303) further including: T-shaped grooves (1303A), (1303B), (1303C), and (1303D).

19. The vibration harvesting device used in electromagnetic vibration power generator according to claim 15, wherein the T-shaped beam (1304) consisting essentially of a beam, a T-shaped tenon, a T-shaped tenon and a T-shaped groove, and is made of a plastic material selected from diamagnetic materials, the beam is a rectangular rod, with a T-shaped tenon at the left end on the inner side, where the head of the T is oriented horizontally, and another T-shaped tenon at the right end on the inner side, also with the head of the T is oriented horizontally,
in the middle of the top side of the beam, there is a T-shaped groove, with the head of the T facing downward, one end of the T-shaped opening of the T-shaped groove protrudes inward, while the surface of the other end of the T-shaped opening of the T-shaped groove and the surface of the outer side of the beam are on the same plane,
the T-shaped beam (1304) further including: T-shaped beams (1304A) and (1304B).

20. The vibration harvesting device used in electromagnetic vibration power generator according to claim 15, wherein the [symbol] -shaped part (1305) is made of a plastic material selected from diamagnetic materials, the upper end of the [symbol] -shaped part (1305) has a T-shaped tenon, with the head of the T facing upward, and the lower end of the [symbol] -shaped part (1305) is a cuboid, with a through hole in the middle of the front side of the cuboid,
the [symbol] -shaped part (1305) further including: [symbol] -shaped parts (1305A) and (1305B).

21. The vibration harvesting device used in electromagnetic vibration power generator according to claim 15, wherein the multi-diameter shaft (1306) is made of copper selected from diamagnetic materials, structurally, from left to right, it consisting essentially of a shaft journal, a shaft shoulder, a spindle nose, and threads,
the multi-diameter shaft (1306) further including: multi-diameter shafts (1306A), (1306B), (1306C), and (1306D).

22. The vibration harvesting device used in electromagnetic vibration power generator according to claim 15, wherein the shaft sleeve (1307) is made of copper selected from diamagnetic materials,
the shaft sleeve (1307) further including: shaft sleeves (1307A) and (1307B).

23. The vibration harvesting device used in electromagnetic vibration power generator according to claim 15, wherein the hexagonal thin nut (1308) is made of copper selected from diamagnetic materials,
the hexagonal thin nut (1308) further including: hexagonal thin nuts (1308A), (1308B), (1308C), (1308D), (1308E), and (1308F).

24. The vibration harvesting device used in electromagnetic vibration power generator according to claim 15, wherein the flange bearing (1309) is a demagnetized deep groove ball bearing, and there is electrical conductivity between the inner and outer rings of the bearing,
the flange bearing (1309) further including: flange bearings (1309A), (1309B), (1309C), (1309D), (1309E), and (1309F).

25. The vibration harvesting device used in electromagnetic vibration power generator according to claim 15, wherein the circlip for shaft (1310) is made of stainless steel and has undergone demagnetization treatment,
the circlip for shaft (1310) further including: circlips for shaft (1310A), (1310B), (1310C), (1310D), (1310E), and (1310F).

26. The vibration harvesting device used in electromagnetic vibration power generator according to claim 15, wherein the inner ring (1311) is made of a plastic material selected from diamagnetic materials, the inner ring (1311) is annular in shape, with a reinforcing block (13111) at the left end of the inner side and another reinforcing block (13112) at the right end of the inner side,
the left end of the outer side of the inner ring (1311) has a counterbore and a through hole, and the inner side of the reinforcing block (13111) has a counterbore, the right end of the outer side of the inner ring (1311) also has a counterbore and a through hole, with the inner side of the reinforcing block (13112) having a counterbore, the centerline x passes through the centers of the counterbores and through hole at the left end, and the centers of the counterbores and through hole at the right end,
the upper end of the outer side of the inner ring (1311) has a counterbore and a through hole, while the lower end of the outer side has a counterbore and a through hole, with the centerline y passing through the centers of the counterbore and through hole at the upper end and the centers of the counterbore and through hole at the lower end,
surrounding the inner side of the inner ring (1311) in the middle, there is a wire groove (13113),
the inner ring (1311) further including: inner ring (1311A).

27. The vibration harvesting device used in electromagnetic vibration power generator according to claim 15, wherein the outer ring (1312) is made of a plastic material selected from diamagnetic materials, the outer ring (1312) is annular in shape, with a through hole at the upper end of the inner side and another through hole at the lower end of the inner side, with the centerline y passing through the centers of the upper and lower through holes,
the left end of the outer side of the outer ring (1312) has a through hole, and the right end of the outer side also has a through hole, with the centerline x passing through the centers of the left and right through holes,
surrounding the outer side of the outer ring (1312) in the middle, there is a wire groove (13121), and surrounding the inner side of the outer ring (1312) in the middle, there is another wire groove (13122),
the outer ring (1312) further including: outer ring (1312A).

28. The vibration harvesting device used in electromagnetic vibration power generator according to claim 15, wherein the diamond-shaped base (1315) is made of a plastic material selected from diamagnetic materials,
the main body is annular in shape, with a through hole at the center, the left side of the main body is connected to the right side of the foot (13151), which has a through hole on its upper surface, and the right side of the main body is connected to the left side of the foot (13152), which also has a through hole on its upper surface,
the diamond-shaped base (1315) further including: diamond-shaped bases (1315A), (1315B).

29. A vibration harvesting device used in composite vibration power generator (18), comprising: a vibration harvesting component (1) and a gimbal (19),
the vibration harvesting component (1) is located inside the frame (1301B) of the gimbal (19), with the groove (203) beneath the base plate (201) of the vibration harvesting component (1) embedded and aligned in the track (13011B) of the frame (1301B) that belongs the gimbal (19), and bonded at the seam,
the frame (1301B) having the vibration harvesting component (1) mounted therein is located inside the frame (1302B) of the gimbal (19), with the slots of the frame (1301B) and the slots of the frame (1302B) vertically staggered at 90° to each other, the upper part of one end of the embedded frame (1301B) abuts against the inner side of the plate (13028B) of the frame (1302B), after the frames are embedded and aligned, the seam is temporarily not bonded for assembly, waiting for the subsequent process to complete the installation of the electromagnetic power generation unit components is fixed,
the vertical inner side of the [symbol] -shaped plate (190112) of the piezoelectric and friction power generation subassembly (1901) is fitted to the bonding area of the square-shaped thin plate (13021B) of the frame (1302B), but bonding is temporarily not performed, the vertical inner side of the [symbol] -shaped plate (190113) is fitted to the bonding area of the square-shaped thin plate (13024B) of the frame (1302B), but bonding is temporarily not performed, waiting for the installation of the piezoelectric ceramic power generation unit and the triboelectric nano power generation unit to be completed before bonding,
the piezoelectric and friction power generation subassembly (1901) is used to capture the impact actions generated between objects and the friction between objects,
the hose (1902A) is sleeved on the shaft journal of the multi-diameter shaft (1306I) of the gimbal (19), with the joint bonded for transmission,
the hose (1902B) is sleeved on the shaft journal of the multi-diameter shaft (1306J) of the gimbal (19), with the joint bonded for transmission,
the hose (1902C) is sleeved on the shaft journal of the multi-diameter shaft (1306K) of the gimbal (19), with the joint bonded for transmission,
the hose (1902D) is sleeved on the shaft journal of the multi-diameter shaft (1306L) of the gimbal (19), with the joint bonded for transmission,
insert the T-shaped tenon of [symbol] -shaped part (1305C) of the gimbal (19) into the T-shaped groove at the lower end of the T-shaped beam (1304C) and move it left and right, concurrently, insert the T-shaped tenon of [symbol] -shaped part (1305D) of the gimbal (19) into the T-shaped groove at the lower end of the T-shaped beam (1304D) and move it left and right, thereby achieving adjustment of the system's center of gravity along the X-axis for the vibration harvesting component (1), the movable parts used for adjustment are not yet bonded and fixed, and will be secured after the installation of the electromagnetic power generation unit components in the subsequent process,
the T-shaped tenon at the left end of the T-shaped beam (1304C) of the gimbal (19) is inserted into the T-shaped groove (1303E), the T-shaped tenon at the right end of the T-shaped beam (1304C) is inserted into the T-shaped groove (1303F) to move inwards and outwards, meanwhile, the T-shaped tenon at the left end of the T-shaped beam (1304D) of the gimbal (19) is inserted into the T-shaped groove (1303G), and the T-shaped tenon at the right end of the T-shaped beam (1304D) is inserted into the T-shaped groove (1303H) to move inwards and outwards, so that the system's center of gravity of the vibration harvesting component (1) on the Y-axis is adjusted, the movable parts used for adjustment are not yet bonded and fixed, and will be secured after the installation of the electromagnetic power generation unit components in the subsequent process,
the system's center of gravity of the vibration harvesting component (1) is located below the line connecting multi-diameter shaft (1306I) and multi-diameter shaft (1306J) of the gimbal (19), so that the rigid body can be automatically adjusted no matter how the rigid body rotates, the system's center of gravity on the Z-axis can be adjusted,
during harvesting, regardless of rotation, the framework device formed by the inner ring (1903A) and outer ring (1312C) of the gimbal (19) adjusts mutually, allowing the vibration harvesting component (1) to harvest omnidirectional external excitation.

30. The vibration harvesting device used in composite vibration power generator according to claim 29, wherein the vibration harvesting component (1) is the vibration harvesting component as recited in claim 1.

31. The vibration harvesting device used in composite vibration power generator according to claim 29, wherein the gimbal (19) consisting essentially of a frame (1301B), a frame (1302B), a piezoelectric and friction power generation subassembly (1901), a T-shaped groove (1303E), a T-shaped groove (1303F), a T-shaped beam (1304C), a T-shaped groove (1303G), a T-shaped groove (1303H), a T-shaped beam (1304D), a [symbol] -shaped part (1305C), a multi-diameter shaft (1306I), a shaft sleeve (1307E), a hexagonal thin nut (1308M), a hose (1902A), a [symbol] -shaped part (1305D), a multi-diameter shaft (1306J), a shaft sleeve (1307F), a hexagonal thin nut (1308N), a hose (1902B), an inner ring (1903A), a flange bearing (1309M), a circlip for shaft (1310M), a flange bearing (1309N), a circlip for shaft (1310N), an outer ring (1312C), a shaft sleeve (1313M), a multi-diameter shaft (1306K), a hexagonal thin nut (1308P), a flange bearing (1309P), a circlip for shaft (1310P), a hose (1902C), a shaft sleeve (1313N), a multi-diameter shaft (1306L), a hexagonal thin nut (1308Q), a flange bearing (1309Q), a circlip for shaft (1310Q), a hose (1902D), a shaft sleeve (1313P), a hexagonal thin nut (1308R), a multi-diameter shaft (1314E), a circlip for shaft (1310R), a diamond-shaped base (1315E), a flange bearing (1309R), a shaft sleeve 1313Q, a hexagonal thin nut 1308S, a multi-diameter shaft 1314F, a circlip for shaft 1310S, a diamond-shaped base 1315F, and a flange bearing 1309S,
the frame (1301B) is located inside the frame (1302B), with the slots of frame (1301B) and the slots of frame (1302B) vertically staggered at 90° to each other, the upper part of the end embedded in frame (1302B) abuts against the inner side of the plate (13028B) of the frame (1302B), after the frames are embedded and aligned, waiting for the subsequent process to complete the installation of the electromagnetic power generation unit components before bonding,
the vertical inner side of the [symbol] -shaped plate (190112) of the piezoelectric and friction power generation subassembly (1901) is fitted to the bonding area of the square-shaped thin plate (13021B) of the frame (1302B), but bonding is temporarily not performed, the vertical inner side of the [symbol] -shaped plate (190113) is fitted to the bonding area of the square-shaped thin plate (13024B) of the frame (1302B), but bonding is temporarily not performed, waiting for the installation of the piezoelectric ceramic power generation unit and the triboelectric nano power generation unit to be completed before bonding,
the T-shaped tenon at the left end of T-shaped beam (1304C) is inserted into the T-shaped groove (1303E), and the T-shaped tenon at the right end of T-shaped beam (1304C) is inserted into the T-shaped groove (1303F), the tenon of [symbol] -shaped part (1305C) is inserted into the T-shaped groove of T-shaped beam (1304C), the back of T-shaped groove (1303E) is bonded to the front of plate (130211B), and the back of T-shaped groove (1303F) is bonded to the front of plate (130212B),
the T-shaped tenon at the left end of T-shaped beam (1304D) is inserted into the T-shaped groove (1303G), and the T-shaped tenon at the right end of T-shaped beam (1304D) is inserted into the T-shaped groove (1303H), the tenon of [symbol] -shaped part (1305D) is inserted into the T-shaped groove of T-shaped beam (1304D), the back of T-shaped groove (1303G) is bonded to the front of plate (130241B), and the back of T-shaped groove (1303H) is bonded to the front of plate (130242B),
the shaft sleeve (1307E) is embedded in the through hole of [symbol] -shaped part (1305C), and the spindle nose of multi-diameter shaft (1306I) passes through the through hole of shaft sleeve (1307E), the hexagonal thin nut (1308M) is screwed onto the thread of multi-diameter shaft (1306I) for fastening, with hexagonal thin nut (1308M) reserved for use as a terminal,
the shaft sleeve (1307F) is embedded in the through hole of [symbol] -shaped part (1305D), and the spindle nose of multi-diameter shaft (1306J) passes through the through hole of shaft sleeve (1307F), the hexagonal thin nut (1308N) is screwed onto the thread of multi-diameter shaft (1306J) for fastening, with hexagonal thin nut (1308N) reserved for use as a terminal,
the shaft journal of multi-diameter shaft (1306I) is inserted into the hole of flange bearing (1309M), which is installed in the through hole of the connecting frame (19031A), the flange of flange bearing (1309M) abuts against the inner side of the counterbore of the connecting frame (19031A), and the circlip for shaft (1310M) secures the other end of flange bearing (1309M) for fastening, with the flange of flange bearing (1309M) and the circlip for shaft (1310M) are reserved for use as terminals,
the shaft journal of multi-diameter shaft (1306J) is inserted into the hole of flange bearing (1309N), which is installed in the right side through hole of the connecting frame (19032A), the flange of flange bearing (1309N) abuts against the inner side of the counterbore of the connecting frame (19032A), and the circlip for shaft (1310N) secures the other end of flange bearing (1309N) for fastening, with the flange of flange bearing (1309N) and the circlip for shaft (1310N) are reserved for use as terminals,
the hose (1902A) is sleeved on the shaft journal of the multi-diameter shaft (1306I), with the joint bonded for transmission,
the hose (1902B) is sleeved on the shaft journal of the multi-diameter shaft (1306J), with the joint bonded for transmission,
the shaft journal of multi-diameter shaft (1306K) is inserted into the hole of flange bearing (1309P), which is installed in the upper side through hole of inner ring (1903A), the flange of flange bearing (1309P) abuts against the upper side counterbore of inner ring (1903A), and the circlip for shaft (1310P) secures the other end of flange bearing (1309P) for fastening, with the circlip for shaft (1310P) reserved for use as a terminal,
the shaft journal of multi-diameter shaft (1306L) is inserted into the hole of flange bearing (1309Q), which is installed in the lower side through hole of inner ring (1903A), the flange of flange bearing (1309Q) abuts against the lower side counterbore of inner ring (1903A), and the circlip for shaft (1310Q) secures the other end of flange bearing (1309Q) for fastening, with the circlip for shaft (1310Q) reserved for use as a terminal,
the shaft sleeve (1313M) is embedded in the upper through hole of the outer ring (1312C), and the spindle nose of the multi-diameter shaft (1306K) passes through the through hole of the shaft sleeve (1313M), the hexagonal thin nut (1308P) is screwed onto the thread of the multi-diameter shaft (1306K) for fastening, with hexagonal thin nut (1308P) reserved for use as a terminal,
the shaft sleeve (1313N) is embedded in the lower through hole of the outer ring (1312C), and the spindle nose of the multi-diameter shaft (1306L) passes through the through hole of the shaft sleeve (1313N), the hexagonal thin nut (1308Q) is screwed onto the thread of the multi-diameter shaft (1306L) for fastening, with hexagonal thin nut (1308Q) reserved for use as a terminal,
the hose (1902C) is sleeved on the shaft journal of the multi-diameter shaft (1306K), with the joint bonded for transmission,
the hose (1902D) is sleeved on the shaft journal of the multi-diameter shaft (1306L), with the joint bonded for transmission,
the shaft sleeve (1313P) is embedded in the left side through hole of the outer ring (1312C), and the spindle nose of the multi-diameter shaft (1314E) passes through the through hole of the shaft sleeve (1313P), the hexagonal thin nut (1308R) is screwed onto the thread of the multi-diameter shaft (1314E) for fastening, with hexagonal thin nut (1308R) reserved for use as a terminal,
the shaft sleeve (1313Q) is embedded in the right side through hole of the outer ring (1312C), and the spindle nose of the multi-diameter shaft (1314F) passes through the through hole of the shaft sleeve (1313Q), the hexagonal thin nut (1308S) is screwed onto the thread of the multi-diameter shaft (1314F) for fastening, with hexagonal thin nut (1308S) reserved for use as a terminal,
the flange bearing (1309R) is installed in the main through hole of the diamond-shaped base (1315E), with the flange clamped against the outer edge of the main through hole, the shaft journal of multi-diameter shaft (1314E) is inserted into the hole of the flange bearing (1309R), and the circlip for shaft (1310R) secures the other end of the flange bearing (1309R) for fastening, with the flange of the flange bearing (1309R) reserved for use as a terminal,
the flange bearing (1309S) is installed in the main through hole of the diamond-shaped base (1315F), with the flange clamped against the outer edge of the main through hole, the shaft journal of multi-diameter shaft (1314F) is inserted into the hole of the flange bearing (1309S), and the circlip for shaft (1310S) secures the other end of the flange bearing (1309S) for fastening, with the flange of the flange bearing (1309S) reserved for use as a terminal.

32. The vibration harvesting device used in composite vibration power generator according to claim 31, wherein the frame (1302B) is the frame as recited in claim 17,
and the middle of the lower side of the front surface of the square-shaped thin plate (13021B) serves as a bonding area, and the middle of the lower side of the front surface of the square-shaped thin plate (13024B) serves as a bonding area, for bonding the piezoelectric and friction power generation subassembly (1901).

33. The vibration harvesting device used in composite vibration power generator according to claim 31, wherein the piezoelectric and friction power generation subassembly (1901) consisting essentially of a frame (19011), a ball (19012), and a top cover (19013),
the frame (19011) consisting essentially of a hull-shaped base (190111), a [symbol] -shaped plate (190112), and a [symbol] -shaped plate (190113), which is made of a plastic material selected from diamagnetic materials,
the hull-shaped base (190111) has an upper part formed by four plate members enclosing a square opening, and a lower part shaped like a hull, with a rectangular shallow groove located in the middle of the bottom of the hull shape,
the upper surface of the left plate of the square opening is connected to the lower surface of the [symbol] -shaped plate (190112), and the upper surface of the right plate of the square opening is connected to the lower surface of the [symbol] -shaped plate (190113),
the ball (19012) is made of polyamide selected from diamagnetic materials, the ball (19012) is placed within the hull-shaped base (190111), where the ball (19012) automatically enters the rectangular shallow groove,
the top cover (19013) is a square plate that made of a plastic material selected from diamagnetic materials,
with dimensions that fit precisely over the upper end of the hull-shaped base (190111), the top cover (19013) has square holes at each of its four corners for wire passage, and the outer edge of the upper surface of the top cover (19013) has a [symbol] -shaped groove in the center for wire placement, the top cover (19013) is temporarily not bonded or fixed, awaiting the installation of the piezoelectric ceramic power generation unit and the triboelectric nano power generation unit before being secured.

34. The vibration harvesting device used in composite vibration power generator according to claim 31, wherein the hose (1902) is made of silicone rubber selected from diamagnetic materials for transmission, and the hose (1902) further including: hose (1902A), hose (1902B), hose (1902C), and hose (1902D).

35. The vibration harvesting device used in composite vibration power generator according to claim 31, wherein the inner ring (1903) is made of a plastic material selected from diamagnetic materials,
the inner ring (1903) is in a circular ring shape, the left end of the inner side of the inner ring (1903) has a connecting frame (19031), and the right end of the inner side of the inner ring (1903) has a connecting frame (19032), the right side of the connecting frame (19031) is parallel to the left side of the connecting frame (19032) along the centerline y,
the right side of the connecting frame (19031) has a counterbore and a through hole, the left side of the connecting frame (19032) has a counterbore and a through hole, the centerline x passes through the center of the through hole and the counterbore of the connecting frame (19031), and the centerline x passes through the center of the through hole and the counterbore of the connecting frame (19032),
the right surface of the plate (19033) is connected above the left side of the connecting frame (19031); the right surface of the plate (19034) is connected below the left side of the connecting frame (19031), the plate (19033) and plate (19034) are symmetrical with respect to the centerline x, the left surface of the plate (19035) is connected above the right side of the connecting frame (19032); the left surface of the plate (19036) is connected below the right side of the connecting frame (19032), the plate (19035) and plate (19036) are symmetrical with respect to the centerline x,
the upper surface of the plate (19037) is connected to the inner side of the inner ring (1903), to the left of the through hole at the upper end of the inner ring (1903), the upper surface of the plate (19038) is connected to the inner side of the inner ring (1903), to the right of the through hole at the upper end of the inner ring (1903), the plate (19037) and plate (19038) are symmetrical with respect to the centerline y,
the lower surface of the plate (19039) is connected to the inner side of the inner ring (1903), to the left of the through hole at the lower end of the inner ring (1903), the lower surface of the plate (190310) is connected to the inner side of the inner ring (1903), to the right of the through hole at the lower end of the inner ring (1903), the plate (19039) and plate (190310) are symmetrical with respect to the centerline y,
around the inner side of the inner ring (1903), in the middle between the two sides of the connecting frame (19031), and in the middle between the two sides of the connecting frame (19032), there is a wire groove (190311),
the inner ring (1903) further including: inner ring (1903A).

36. An electromagnetic vibration power generator (24), comprising: a vibration harvesting device used in electromagnetic vibration power generator (12), windings (25), windings (26), insulated wires (27), an upper hemispherical shell (28), a lower hemispherical shell (29), bolt (30), and nut (31),
the enameled wire is wound clockwise in three slots of the frame (1301) to form three coils, which are connected in series to form the windings (25),
the vibration harvesting component (1) of the vibration harvesting device used in electromagnetic power generator (12) is located inside the frame (1301) of the gimbal (13), and the groove (203) below the base plate (201) of the vibration harvesting component (1) is embedded and aligned with the track (13011) of the frame (1301) and then bonded,
the enameled wire is wound clockwise in three slots on the frame (1302) to form three coils, which are connected in series to form the windings (26), the frame (1301) with the vibration harvesting component (1) is embedded inside the frame (1302), with the slots of the frame (1301) and the slots of the frame (1302) arranged in a 90° staggered manner, the upper part of the end embedded in the frame (1301) abuts against the inner side of the plate (13028) of the frame (1302), and is bonded after alignment, the windings (25) and windings (26) are connected in series, leaving enameled wire end (32A) and enameled wire end (32B),
the enameled wire end (32A) is soldered to the surface of the hexagonal thin nut (1308A), and the enameled wire end (32B) is soldered to the surface of the hexagonal thin nut (1308B),
the insulated wire (27) further including: insulated wires (27A), (27B), (27C), (27D), (27E), and (27F),
one end of the insulated wire (27A) is soldered to the flange surface of the flange bearing (1309A), and the wire body of the insulated wire (27A) is bonded in the left upper wire groove (13113A) to reach the upper end through hole of the inner ring (1311A), the other end of the insulated wire (27A) is soldered to the surface of the circlip for shaft (1310C),
one end of the insulated wire (27B) is soldered to the flange surface of the flange bearing (1309B), and the wire body of the insulated wire (27B) is bonded in the right lower wire groove (13113A) to reach the lower end through hole of the inner ring (1311A), the other end of the insulated wire (27B) is soldered to the surface of the circlip for shaft (1310D),
one end of the insulated wire (27C) is soldered to the surface of the hexagonal thin nut (1308C), and the wire body of the insulated wire (27C) is bonded in the left upper wire groove (13121A) to reach the left end through hole of the outer ring (1312A), the other end of the insulated wire (27C) is soldered to the surface of the hexagonal thin nut (1308E),
one end of the insulated wire (27D) is soldered to the surface of the hexagonal thin nut (1308D), and the wire body of the insulated wire (27D) is bonded in the right lower wire groove (13121A) to reach the right end through hole of the outer ring (1312A), the other end of the insulated wire (27D) is soldered to the surface of the hexagonal thin nut (1308F),
one end of the insulated wire (27E) is soldered to the flange surface of the flange bearing (1309E), and one end of the insulated wire (27F) is soldered to the flange surface of the flange bearing (1309F),
after harvesting, the current flows from the enameled wire end (32A) of the windings through conductive components to the insulated wire (27E), and the other end flows from the enameled wire end (32B) of the windings through conductive components to the insulated wire (27F),
inserted the T-shaped tenon of [symbol] -shaped part (1305A) of the gimbal (13) into the T-shaped groove at the lower end of the T-shaped beam (1304A) and move it left and right, concurrently, insert the T-shaped tenon of [symbol] -shaped part (1305B) of the gimbal (13) into the T-shaped groove at the lower end of the T-shaped beam (1304B) and move it left and right, thereby achieving adjustment of the system's center of gravity along the X-axis for the vibration harvesting component (1), after which the movable components are bonded and fixed,
the T-shaped tenon at the left end of the T-shaped beam (1304A) of the gimbal (13) is inserted into the T-shaped groove (1303A), the T-shaped tenon at the right end of the T-shaped beam (1304A) is inserted into the T-shaped groove (1303B) to move inwards and outwards, meanwhile, the T-shaped tenon at the left end of the T-shaped beam (1304B) of the gimbal (13) is inserted into the T-shaped groove (1303C), and the T-shaped tenon at the right end of the T-shaped beam (1304B) is inserted into the T-shaped groove (1303D) to move inwards and outwards, so that the system's center of gravity of the vibration harvesting component (1) on the Y-axis is adjusted, after which the movable components are bonded and fixed,
the system's center of gravity of the vibration harvesting component (1) is located below the line connecting multi-diameter shaft (1306A) and multi-diameter shaft (1306B) of the gimbal (13) so that the rigid body can be automatically adjusted no matter how the rigid body rotates, the system's center of gravity on the Z-axis can be adjusted,
during harvesting, regardless of the direction of rotation, the frame device formed by the inner ring (1311A) and the outer ring (1312A) of the gimbal (13) adjusts relative to each other, allowing the vibration harvesting component (1) to capture omnidirectional external excitation, resulting in electromagnetic induction in the windings (25) and windings (26),
the diamond-shaped base (1315A) is placed on the plate (2901) and plate (2902) of the lower hemispherical shell (29), and is fastened with bolt (30A), nut (31A), bolt (30B), and nut (31B); the diamond-shaped base (1315B) is placed on the plate (2903) and plate (2904) of the lower hemispherical shell (29), and is fastened with bolt (30C), nut (31C), bolt (30D), and nut (31D); the upper hemispherical shell (28) covers the lower hemispherical shell (29), aligning the through holes with the through holes, and is fastened with bolt (30E), nut (31E), bolt (30F), nut (31F), bolt (30G), nut (31G), bolt (30H), and nut (31H),
the insulated wire (27E) passes through the through hole (2801), with the wire body remaining outside the upper hemispherical shell (28) for connection to an external load, and the gap left by the insulated wire (27E) passing through the through hole (2801) is sealed with industrial adhesive; the insulated wire (27F) passes through the through hole (2802), with the wire body remaining outside the upper hemispherical shell (28) for connection to the external load, and the gap left by the insulated wire (27F) passing through the through hole (2802) is sealed with industrial adhesive.

37. The electromagnetic vibration power generator according to claim 36, wherein the vibration harvesting device used in electromagnetic vibration power generator (12) is the vibration harvesting device used in electromagnetic vibration power generator as recited in claim 13.

38. The electromagnetic vibration power generator according to claim 36, wherein the vibration harvesting component (1) is the vibration harvesting component as recited in claim 1.

39. The electromagnetic vibration power generator according to claim 36, wherein the upper hemispherical shell (28) is made of a plastic material selected from diamagnetic materials, the upper hemispherical shell (28) is hollow inside, and the circular opening is surrounded by a flange, which has four through holes spaced 90° apart,
the surface of the upper hemispherical shell (28) near the flange has a through hole (2801), and the surface of the upper hemispherical shell (28) near the flange has a through hole (2802), with the through hole (2801) and through hole (2802) being symmetrical, and the two through holes are used for the passage of insulated wires.

40. The electromagnetic vibration power generator according to claim 36, wherein the lower hemispherical shell (29) is made of a plastic material selected from diamagnetic materials, the lower hemispherical shell (29) is hollow inside, and a flange surrounds the circular opening, which has four through holes spaced 90° apart from the center of the circular opening,
inside the lower hemispherical shell (29), below the left edge of the circular opening, the left side of the plate (2901) and the left side of the plate (2902) are connected to the inside edge of the circular opening, with through holes on the upper surfaces of the plate (2901) and plate (2902) corresponding in size and position to the two through holes of the diamond-shaped base (1315),
inside the lower hemispherical shell (29), below the right edge of the circular opening, the right side of the plate (2903) and the right side of the plate (2904) are connected to the inside edge of the circular opening, with through holes on the upper surfaces of the plate (2903) and plate (2904) corresponding in size and position to the two through holes of the diamond-shaped base (1315),
the upper surface of the L-shaped foot (2905) is connected with the lower end of the outer side of the lower hemispherical shell (29), the upper surface of the L-shaped foot (2906) is connected with the lower end of the outer side of the lower hemispherical shell (29), the upper surface of the L-shaped foot (2907) is connected with the lower end of the outer side of the lower hemispherical shell (29), the upper surface of the L-shaped foot (2908) is connected with the lower end of the outer side of the lower hemispherical shell (29), the interval between the 4 L-shaped feet is 90 degrees, the connecting surfaces of the 4 L-shaped feet and the outer side of the lower hemispherical shell (29) are on the same plane, the plane is parallel to the plane of the circular opening of the lower hemispherical shell (29), the bottom surfaces of the 4 L-shaped feet are on the same plane,
the center of the bottom surface of the L-shaped foot (2905), L-shaped foot (2906), L-shaped foot (2907), and L-shaped foot (2908) have through holes for the installation of fasteners.

41. The electromagnetic vibration power generator according to claim 36, wherein the bolt (30) is made of a plastic material selected from diamagnetic materials,
bolt (30) further including: bolts (30A), (30B), (30C), (30D), (30E), (30F), (30G), and (30H).

42. The electromagnetic vibration power generator according to claim 36, wherein the nut (31) is made of a plastic material selected from diamagnetic materials,
nut (31) further including: nuts (31A), (31B), (31C), (31D), (31E), (31F), (31G), and (31H).

43. A composite vibration power generator (37), comprising: a vibration harvesting device used in composite vibration power generator (18), windings (38), windings (39), a piezoelectric and triboelectric power generation unit (40), a disc-type triboelectric nano power generation unit (41A), a disc-type triboelectric nano power generation unit (41B), a disc-type triboelectric nano power generation unit (41C), a disc-type triboelectric nano power generation unit (41D), insulated wire (42), an upper hemispherical shell (28C), a lower hemispherical shell (29C), bolt (30), and nut (31),
the enameled wire is wound clockwise in three slots of the frame (1301B) to form three coils, which are connected in series to form the windings (38),
the vibration harvesting component (1) of the vibration harvesting device used in composite vibration power generator (18) is located inside the frame (1301B) of the gimbal (19), and the groove (203) beneath the base plate (201) of the vibration harvesting component (1) is embedded and aligned in the track (13011B) of the frame (1301B) of the gimbal (19) and then bonded,
the enameled wire is wound clockwise in three slots on the frame (1302B) to form three coils, which are connected in series to form the windings (39),
the frame (1301B) with the vibration harvesting component (1) is embedded inside the frame (1302B), with the slots of the frame (1301B) and the slots of the frame (1302B) arranged in a 90° staggered manner, the upper part of the end embedded in the frame (1301B) abuts against the inner side of the plate (13028B) of the frame (1302B), and is bonded after alignment,
the windings (38) are connected in series with the windings (39), leaving enameled wire end (43A) and enameled wire end (43B), the enameled wire end (43A) is soldered to the surface of the hexagonal thin nut (1308M), and the enameled wire end (43B) is soldered to the surface of the hexagonal thin nut (1308N),
the insulated wire (42) further including: insulated wires (42A), (42B), (42C), (42D), (42E), and (42F),
the end of the insulated wire (42A) is soldered to the surface of the flange of the flange bearing (1309M), and the body of the insulated wire (42A) is bonded in the wire groove (190311A) on the upper left side, reaching the upper end through hole of the inner ring (1903A), the other end of the insulated wire (42A) is soldered to the surface of the circlip for shaft (1310P),
the end of the insulated wire (42B) is soldered to the surface of the flange of the flange bearing (1309N), and the body of the insulated wire (42B) is bonded in the wire groove (190311A) on the lower right side, reaching the lower end through hole of the inner ring (1903A), the other end of the insulated wire (42B) is soldered to the surface of the circlip for shaft (1310Q),
the end of the insulated wire (42C) is soldered to the surface of the hexagonal thin nut (1308P), and the body of the insulated wire (42C) is bonded in the wire groove (13121C) on the upper left side, reaching the left end through hole of the outer ring (1312C), the other end of the insulated wire (42C) is soldered to the surface of the hexagonal thin nut (1308R),
the end of the insulated wire (42D) is soldered to the surface of the hexagonal thin nut (1308Q), and the body of the insulated wire (42D) is bonded in the wire groove (13121C) on the lower right side, reaching the right end through hole of the outer ring (1312C), the other end of the insulated wire (42D) is soldered to the surface of the hexagonal thin nut (1308S),
the end of the insulated wire (42E) is soldered to the surface of the flange of the flange bearing (1309R), and the end of the insulated wire (42F) is soldered to the surface of the flange of the flange bearing (1309S),
after harvesting, the current flows from the enameled wire end (43A) of the windings through the conductive components to the insulated wire (42E), while the other end flows from the enameled wire end (43B) of the windings through the conductive components to the insulated wire (42F),
the inner vertical side of the [symbol] -shaped plate (190112) of the frame (19011) of the piezoelectric and triboelectric power generation unit (40) is bonded to the bonding area of the square-shaped thin plate (13021B) of the frame (1302B), and the inner vertical side of the [symbol] -shaped plate (190113) is bonded to the bonding area of the square-shaped thin plate (13024B) of the frame (1302B), the insulated wire (4003A) is soldered to the surface of the hexagonal thin nut (1308M), and the insulated wire (4003B) is soldered to the surface of the hexagonal thin nut (1308N),
the surfaces of the plate (41022A) and the plate (41023A) of the disc-type triboelectric nano power generation unit (41A) is bonded to the surfaces of the plate (19033A) and plate (19034A) of the inner ring (1903A), the hose (1902A) is fitted onto the spindle nose of the multi-diameter shaft (4103A), with the contact portion bonded, one end of the insulated wire (4108AA) is soldered to the surface of the circlip for shaft (1310M), and the body of the insulated wire (4108BA) is bonded in the wire groove (190311A) on the lower left side, reaching the lower end through hole of the inner ring (1903A), the other end of the insulated wire (4108BA) is soldered to the surface of the circlip for shaft (1310Q),
the surfaces of the plate (41022B) and the plate (41023B) of the disc-type triboelectric nano power generation unit (41B) is bonded to the surfaces of the plate (19035A) and plate (19036A) of the inner ring (1903A), the hose (1902B) is fitted onto the spindle nose of the multi-diameter shaft (4103B), with the contact portion bonded, one end of the insulated wire (4108AB) is soldered to the surface of the circlip for shaft (1310N), and the body of the insulated wire (4108BB) is bonded in the wire groove (190311A) on the upper right side, reaching the upper end through hole of the inner ring (1903A), the other end of the insulated wire (4108BB) is soldered to the surface of the circlip for shaft (1310P),
the surfaces of the plate (41022C) and the plate (41023C) of the disc-type triboelectric nano power generation unit (41C) is bonded to the surfaces of the plate (19037A) and plate (19038A) of the inner ring (1903A), the hose (1902C) is fitted onto the spindle nose of the multi-diameter shaft (4103C), with the contact portion bonded, one end of the insulated wire (4108AC) is soldered to the surface of the circlip for shaft (1310P), and the body of the insulated wire (4108BC) is bonded in the wire groove (190311A) on the right side, reaching the lower end through hole of the inner ring (1903A), the other end of the insulated wire (4108BC) is soldered to the surface of the circlip for shaft (1310Q),
the surfaces of the plate (41022D) and the plate (41023D) of the disc-type triboelectric nano power generation unit (41D) is bonded to the surfaces of the plate (19039A) and plate (190310A) of the inner ring (1903A), the hose (1902D) is fitted onto the spindle nose of the multi-diameter shaft (4103D), with the contact portion bonded, one end of the insulated wire (4108AD) is soldered to the surface of the circlip for shaft (1310Q), and the body of the insulated wire (4108BD) is bonded in the wire groove (190311A) on the left side, reaching the upper end through hole of the inner ring (1903A), the other end of the insulated wire (4108BD) is soldered to the surface of the circlip for shaft (1310P),
insert the T-shaped tenon of [symbol] -shaped part (1305C) of the gimbal (19) into the T-shaped groove at the lower end of the T-shaped beam (1304C) and move it left and right, concurrently, insert the T-shaped tenon of [symbol] -shaped part (1305D) of the gimbal (19) into the T-shaped groove at the lower end of the T-shaped beam (1304D) and move it left and right, thereby achieving adjustment of the system's center of gravity along the X-axis for the vibration harvesting component (1), after adjustment, the movable components are bonded and fixed,
the T-shaped tenon at the left end of the T-shaped beam (1304C) of the gimbal (19) is inserted into the T-shaped groove (1303E), the T-shaped tenon at the right end of the T-shaped beam (1304C) is inserted into the T-shaped groove (1303F) to move inwards and outwards, meanwhile, the T-shaped tenon at the left end of the T-shaped beam (1304D) of the gimbal (19) is inserted into the T-shaped groove (1303G), and the T-shaped tenon at the right end of the T-shaped beam (1304D) is inserted into the T-shaped groove (1303H) to move inwards and outwards, so that the system's center of gravity of the vibration harvesting component (1) on the Y-axis is adjusted, after adjustment, the movable components are bonded and fixed,
the system's center of gravity of the vibration harvesting component (1) is located below the line connecting multi-diameter shaft (1306I) and multi-diameter shaft (1306J) of the gimbal (19), so that the rigid body can be automatically adjusted no matter how the rigid body rotates, the system's center of gravity on the Z-axis can be adjusted,
during harvesting, regardless of the direction of rotation, the frame device formed by the inner ring (1903A) and the outer ring (1312C) of the gimbal (19) adjusts relative to each other, allowing the vibration harvesting component (1) to capture omnidirectional external excitation, resulting in electromagnetic induction in the windings (38) and windings (39),
the diamond-shaped base (1315E) is placed on the plate (2901C) and plate (2902C) of the lower hemispherical shell (29C), and is fastened using bolt (30R), nut (31R), bolt (30S), and nut (31S); the diamond-shaped base (1315F) is placed on the plate (2903C) and plate (2904C) of the lower hemispherical shell (29C), and is fastened using bolt (30T), nut (31T), bolt (30U), and nut (31U),
the upper hemispherical shell (28C) covers the lower hemispherical shell (29C), with the through holes aligned with each other, bolt (30V), nut (31V), bolt (30W), nut (31W), bolt (30X), nut (31X), bolt (30Y), and nut (31Y) are used for fastening,
the insulated wire (42E) passes through the through hole (2801C), with the wire body remaining outside the upper hemispherical shell (28C) for connection to an external load, the insulated wire (42E) is sealed with industrial adhesive at the gap left by the through hole (2801C); the insulated wire (42F) passes through the through hole (2802C), with the wire body remaining outside the upper hemispherical shell (28C) for connection to the external load, the insulated wire (42F) is sealed with industrial adhesive at the gap left by the through hole (2802C).

44. The composite vibration power generator according to 43, wherein the vibration harvesting device used in composite vibration power generator (18) is the vibration harvesting device used in composite vibration power generator as recited in claim 29.

45. The composite vibration power generator according to 43, wherein the vibration harvesting component (1) is the vibration harvesting component as recited in claim 1.

46. The composite vibration power generator according to 43, wherein the piezoelectric and triboelectric power generation unit (40) consisting essentially of a piezoelectric and friction power generation subassembly (1901), a piezoelectric ceramic sheet (4001A), a piezoelectric ceramic sheet (4001B), a piezoelectric ceramic sheet (4001C), a piezoelectric ceramic sheet (4001D), a freestanding triboelectric layer based nano generation unit (4002A), a freestanding triboelectric layer based nano generation unit (4002B), insulated wire (4003),
the piezoelectric ceramic sheet (4001) is rectangular thin plate made of PZT5, with a copper substrate, having positive and negative electrodes on the same side, each connected to wires,
the piezoelectric ceramic sheet (4001) further including: piezoelectric ceramic sheets (4001A), (4001B), (4001C), and (4001D),
the insulated wire (4003) further including: insulated wires (4003A) and (4003B),
the bottom surface of the piezoelectric ceramic sheet (4001A) is bonded to the left vertical side of the square opening on the inner side of the frame (19011), the bottom surface of the piezoelectric ceramic sheet (4001B) is bonded to the upper vertical side of the square opening on the inner side of the frame (19011), the bottom surface of the piezoelectric ceramic sheet (4001C) is bonded to the right vertical side of the square opening on the inner side of the frame (19011), and the bottom surface of the piezoelectric ceramic sheet (4001D) is bonded to the lower vertical side of the square opening on the inner side of the frame (19011), the four pairs of wires from the four piezoelectric ceramic sheets are connected in parallel, with one end connected to the insulated wire (4003A) and the other end connected to the insulated wire (4003B),
the freestanding triboelectric layer based nano generation unit (4002) consisting essentially of an aluminum foil (40021), a double-sided adhesive (40022), and an insulated wire (40023), the aluminum foil (40021) is rectangular and features micro-scale cubic structures fabricated on its upper surface using a selective deposition method, the double-sided adhesive (40022) is also rectangular and has the same dimensions as the aluminum foil (40021), the upper surface of double-sided adhesive (40022) is bonded to the lower surface of the aluminum foil (40021), one end of the insulated wire (40023) is bonded to the upper surface of the double-sided adhesive (40022), and the conductor of the insulated wire (40023) must be in contact with the aluminum foil (40021), the freestanding triboelectric layer based nano generation unit (4002) further including: freestanding triboelectric layer based nano generation units (4002A) and (4002B),
the bottom surface of freestanding triboelectric layer based nano generation unit (4002A) is bonded to the upper surface of the rectangular base plate on the inner side of the hull-shaped base (190111), the bottom surface of freestanding triboelectric layer based nano generation unit (4002B) is bonded to the upper surface of the other rectangular base plate on the inner side of the hull-shaped base (190111), the insulated wire (40023A) of freestanding triboelectric layer based nano generation unit (4002A) is connected to the insulated wire (4003A), and the insulated wire (40023B) of freestanding triboelectric layer based nano generation unit (4002B) is connected to the insulated wire (4003B),
the ball (19012) is placed inside the hull-shaped base (190111),
the top cover (19013) is bonded to the upper end of the frame (19011), with wires passing through the square holes of the top cover (19013), a [symbol] -shaped groove in the center of the upper surface of the top cover (19013) is used to accommodate the wires, and the insulated wire (4003A) and insulated wire (4003B) pass through the [symbol] -shaped groove.

47. The composite vibration power generator according to 43, wherein the disc-type triboelectric nano power generation unit (41) consisting essentially of a upper outer shell (4101), a lower outer shell (4102), a multi-diameter shaft (4103), an intermediate disc (4104), silver-plated electrically conductive fiber clusters (4105), a polytetrafluoroethylene film (4106A), a polytetrafluoroethylene film (4106B), a double-sided adhesive copper foil (4107A), a double-sided adhesive copper foil (4107B), an insulated wire (4108A), and an insulated wire (4108B),
the disc-type triboelectric nano power generation unit (41) further including: disc-type triboelectric nano power generation units (41A), (41B), (41C), and (41D),
the upper outer shell (4101) is made of a plastic material selected from diamagnetic materials, and has the appearance of a hollow cylinder, with one open end and one closed end, the circular opening facing downward, there is a through hole (41011) at the center of the top surface of the upper outer shell (4101), with a through hole (41012) on the left side of through hole (41011) and a through hole (41013) on the right side of through hole (41011), the diameter line of the top surface passes through the centers of through hole (41011), through hole (41012), and through hole (41013),
the lower outer shell (4102) is made of a plastic material selected from diamagnetic materials and has the appearance of a circular disc, with a through hole (41021) at its center, the upper surface of the plate (41022) is connected to the left side of the diameter line on the lower surface of the lower outer shell (4102), while the upper surface of the plate (41023) is connected to the right side of the diameter line on the lower surface of the lower outer shell (4102), the plate (41022) and plate (41023) are symmetrical,
the polytetrafluoroethylene film (4106) is in a sector ring shape, the upper surface is etched by plasma in a dry etching method to obtain a uniform nanowire structure, the polytetrafluoroethylene film (4106) further including: the polytetrafluoroethylene films (4106A) and (4106B),
the double-sided adhesive copper foil (4107) is in a sector ring shape and has the same dimensions as the polytetrafluoroethylene film (4106), the double-sided adhesive copper foil (4107) further including: the double-sided adhesive copper foils (4107A) and (4107B),
the insulated wire (4108) further including: the insulated wires (4108A) and (4108B),
one side of the double-sided adhesive copper foil (4107A) is bonded to the lower surface of the polytetrafluoroethylene film (4106A), while one end of the insulated wire (4108A) is bonded to the other side of the double-sided adhesive copper foil (4107A), the conductor of the insulated wire (4108A) must be in contact with the copper foil of the double-sided adhesive copper foil (4107A),
one side of the double-sided adhesive copper foil (4107B) is bonded to the lower surface of the polytetrafluoroethylene film (4106B), while one end of the insulated wire (4108B) is bonded to the other side of the double-sided adhesive copper foil (4107B), the conductor of the insulated wire (4108B) must be in contact with the copper foil of the double-sided adhesive copper foil (4107B),
the bottom surface of the double-sided adhesive copper foil (4107A) is bonded to the bottom of the inner side of the upper shell (4101), and the bottom surface of the double-sided adhesive copper foil (4107B) is also bonded to the bottom of the inner side of the upper shell (4101), with the bonding positions of the two not overlapping, the insulated wire (4108A) passes through the through hole (41012), and the insulated wire (4108B) passes through the through hole (41013),
the intermediate disc (4104) is made of a plastic material selected from diamagnetic materials and has the appearance of a circular disc, there is a double flat keyway at the center of the intermediate disc (4104),
silver-plated electrically conductive fiber clusters (4105) consisting essentially of 40 groups of silver-plated conductive fiber strands,
the silver-plated electrically conductive fiber is specified as 140 D, made of nylon fibers, with a diameter of 0.089 to 0.1 mm and a resistance of 4 to 6.5 Ω/cm,
multiple equal-length silver-plated electrically conductive fiber strands are processed into a bundle, forming 40 groups of silver-plated electrically conductive fiber bundles, one end of the 40 groups of silver-plated electrically conductive fiber bundles is bonded to the upper surface of the intermediate disc (4104),
the multi-diameter shaft (4103) is made of a plastic material selected from diamagnetic materials and consisting essentially of the following parts from top to bottom: a shaft journal, a shaft shoulder, and a spindle nose, the shaft shoulder has a double flat key,
the multi-diameter shaft (4103) passes through the intermediate disc (4104), with the double flat key of the multi-diameter shaft (4103) bonded in the double flat keyway of the intermediate disc (4104), the spindle nose of the multi-diameter shaft (4103) penetrates the through hole (41021) of the lower outer shell (4102), with the silver-plated electrically conductive fiber clusters (4105) facing upward, during rotation, the silver-plated electrically conductive fiber clusters (4105) come into contact with the polytetrafluoroethylene film (4106A) and polytetrafluoroethylene film (4106B), and the rotational damping is appropriate,
the shaft journal of the multi-diameter shaft (4103) passes through the through hole (41011) of the upper outer shell (4101), and the upper surface of the lower outer shell (4102) is bonded to the opening of the upper outer shell (4101).
